(19) United States
(12) Patent Application Publication
(10) Pub. No.: US 2015/0335934 A1
(43) Pub. Date: Nov. 26, 2015

(54) SYSTEMS AND METHODS OF A PORTABLE, MULTI-PURPOSE, SINGLE-UNIT APPARATUS FOR PHYSICAL EXERCISE, AND/OR ASSEMBLY-DISASSEMBLY PROCESSES, AND/OR INTELLECTUAL ACTIVITIES, AND/OR AMUSEMENT

(71) Applicant: Michael TJ Flynn, Woodinville, WA (US)

(72) Inventor: Michael TJ Flynn, Woodinville, WA (US)

(21) Appl. No.: 14/282,775

(22) Filed: May 20, 2014

(51) Int. Cl. A63B 17/04; A63B 21/00; A63H 33/04; A63B 23/00; A63B 22/00; G09B 19/00; A63B 21/002; A63B 21/015

(52) U.S. Cl. CPC A63B 17/04; A63B 21/0023; A63B 21/00189; A63B 21/015; A63B 21/1453; A63B 23/00; A63B 22/0002; G09B 19/00; A63H 33/04; A63B 2021/0026; A63B 2023/006

(57) ABSTRACT

Invention is a portable-lightweight, single-unit-easily transportable, compact-durable, readily available-inexpensive, multi-purpose apparatus; inherently capable of multiple-embodiments for, at least, activities involving amusement, and/or exercise of the body, effecting nearly all joints, muscles groups, associated tissue, and/or activities related to the intellect, at least, to support external devices/objects(s) that may increase a use of intellectual function(s), including but not limited to sight, hearing, cognitive-skills; inherently comprising a physical-exercise in conjunction with an intellectual-activity during embodiment-assembly, augmenting the conscious-subconscious relationship; having multiple embodiments-exercises via repetitive assembly by twist-push locking-process and disassembly by pull-twist unlocking-process; performed in a standing, seated, supine, walking position(s); capable of exercise methods ranging from stretching, rotating, cardio, isometric, isotonic, to isokinetic; providing increased heart rates and respiration while strengthening, toning, rehabilitating, maintaining, improving physical/intellectual fitness; applicable to neck/shoulder, abdominal/back, pectoral/torso, arm/leg, wrist/ankle, foot/hand muscle and/or tissue; simulating bicycling, swimming, rowing, boxing, curling, pumping, or other modalities; facilitating un-wanted-fat waistline(s).

### CROSS REFERENCE To RELATED APPLICATIONS

Not Applicable.

### STATEMENT REGARDING FEDERALLY SPONSORED RESEARCH OF DEVELOPMENT

Not Applicable.

### THE NAMES OR PARTIES TO A JOINT RESEARCH AGREEMENT

Not Applicable.

### INCORPORATION-BY-REFERENCE OF MATERIAL SUBMITTED ON A COMPACT DISC

Not Applicable.

### SEQUENCE LISTING

Not Applicable.

### FIELD OF THE INVENTION

This invention relates to system(s) and method(s) for embodiment(s), individually and/or collectively, that generally relate to an apparatus, and more particularly, for use in physical exercise, and/or in the assembly and/or disassembly of an apparatus, and/or intellectual activities, and/or amusement by humans.

### BACKGROUND OF THE INVENTION

This invention relates to system(s) and method(s) of embodiment(s), individually and/or collectively, and/or reusable, that generally relate to an apparatus, at least in a single apparatus, and more particularly, for use in physical exercise, and/or in the assembly and/or disassembly of an apparatus, and/or intellectual activities, and/or amusement by humans.

Within the field there exist problems that may be ripe for solutions. A first problem is associated with systems of embodiments that often have an inherent challenge that minimally may limit the environmental setting where a user is able to utilize an apparatus, from which an embodiment is formed; e.g. indoor versus outdoor. Use of an apparatus embodiment is often dependant upon its portability from one room to another room, or from inside a structure to an outdoor setting. The market offers users numerous machine/devices/apparatuses that are often located inside a building structure; e.g. a device being large, heavy, bulky and awkward to move, such as a weight-resistant styled machine commonly known as a universal set, or a treadmill, or a swimming pool. Thus when a user engages such a machine on a pleasant weather day, the user is limited, if not prevented, from easily moving such an apparatus from its indoor setting to the outdoors, thus causing a user to sacrifice either the enjoyment of the outdoors or the continuation of use of the apparatus. Conversely if an apparatus is set in an outdoor environment and is bulky, secured in place, or otherwise unable to be moved indoors then a user compromises or even looses the indoor setting benefits of such a device, particularly if inclement weather is present. Persons with allergies to pollens, or sensitivity to sunlight, or fear of bird droppings overhead, or fear of potential bee-stings, or other challenges to nature's outdoor environment, e.g. freezing or sizzling temperatures, high humidity or rainstorms may alter or cease an outdoor regimen for a user; negatively impacting the user's health fitness routine, particularly when the user may desire use of an outdoor apparatus to become an indoor apparatus but is unable to make it so. The weight of an apparatus is a primary challenge to the world of users of embodiments that are limited to a particular indoor or outdoor setting. The heavier an apparatus is the greater limitations are placed upon a single user efficiently moving the apparatus. Thus there exist challenges of an embodiment being portable and weighty regarding an apparatus.

Furthermore, systems of embodiments have a physical setting issue that may impose limitations upon a user. In the busy schedule of many societies there is a challenge of time efficiency for people. While a person may be determined to use time wisely, performing tasks in a timely manner, or when a person simply desires to spend minimal time in pursuit of a given action, e.g. a physical exercise routine, the element of time becomes a quickly evaporative commodity. Thus when a person uses two or more physical locations of existence/operations, e.g. at the residence and/or at the workplace, it is obvious that it is impossible to be at both places simultaneously. Subsequently, there is a challenge to bring those items, among which an apparatus embodiment may by included, to fulfill the person's routine with that person as often as possible; reducing the need to travel back and forth between the residence and the workplace. Time consciousness is benefited when there is a reduction in the number of items a person needs to bring with themselves. If a person desires to maintain a routine that involves an embodiment of an apparatus, but fails to bring that apparatus with them to their current physical setting then that person would lack the benefit of having the apparatus with themselves and by default would also lack the benefit of using such apparatus. Object efficiency occurs when there is a reduction in the number of objects to fulfill a spectrum of tasks. If for example, a person carries a dozen books, or carries a single electronic device with the same dozen books, there results a practice of object efficiency by carrying the electronic device. Similarly, and illustratively, if a person carries a dozen apparatuses to deal with a dozen tasks, or, conversely a person carries a single-unit apparatus that deals with the same dozen tasks, then object efficiency occurs with the single-unit apparatus. Unfortunately, often apparatuses are specialized and thus require multiple devices to cover a multiple of purposes for which apparatuses would serve. Additionally, when an apparatus embodiment is not portable it certainly would not be more easily trans-portable between two physical locations, such as between a residence and a workplace. The challenge of an apparatus that is difficult to move from one room to another, or from an indoor setting to an outdoor setting would create an even greater challenge to be moved from a residence to the workplace, and back again; certainly on a regular basis. Thus there exist challenges of embodiments being a single-unit and easily transportable regarding an apparatus.

Moreover, systems of embodiments have a geographical location that may be limited upon a user. While many persons may either establish a location within their own residence, or may purchase a membership to access a building wherein, either location, there may exist an apparatus embodiment(s) for their personal use, these locations often may be the exclusive places for the specific embodiment(s). Thus when a person travels to a vacation site, e.g. climbing a mountain, or travels on business, e.g. to an oceanfront conference center, the said embodiment(s) are often left behind either at the residence, or at the membership building. This absence places a hardship upon a user of the embodiment because, lacking the ability of bilocation, the user and the user's embodiments often remain geographically distant from each other; denying the user any practical benefit thereto. This geographical location limitation is dependant upon the user's ability to easily re-locate the apparatus, especially when an apparatus would be used on a regular, weekly, if not daily, basis. Often the apparatuses involved in the fields of physical exercise, or intellectual activity, or amusement fields fail to be compactly designed for storage and/or transportation; thus compounding the location limitation challenges. Moreover, if compactness does exist there may also be the issue of durability of the embodiment. Devices that often are associated with the fields, supra, are by design, or by default, fragile, breakable, sensitive to moisture, temperature and otherwise; creating in apparatuses a wear and tear or decay lifespan; lacking durability. Thus there exist challenges of compactness and durability regarding an apparatus.

Moreover, systems of embodiments may have a financial restriction that may be limiting upon a user. Generally, the members of contemporary society operate on limited funds and income sources. Generally, the members of such society desire good health and fitness; often pursued via the engagement of a variety of apparatuses associated with that pursuit. In response, in part, to these factors of society, there are industries that cater to such members via creating private clubs that provide equipment, commonly known as gyms, and/or manufacture apparatuses for private ownership and use. While cities expand and residences continue to spiral away from city centers there often become an increasing distance between members in a society and a gym; making access to the gyms not readily available. Furthermore, while the actual distance to a gym may be decreased by a growing number of gyms, there is also a growing number of traffic issues that delay arrival/departure times to access the gym. While a person may choose to attain their own gym-styled apparatus for private use, often times this may become cost prohibitive and thus again separates a user from an apparatus availability. Either method, i.e. gyms, or private ownership, requires an outlay of financial resources from the members of society; ultimately reducing an individual's financial positive balance sheet. Often, the market will adjust the price of gym fees and/or cost of goods for private ownership, however, there will always remain an ever growing sector of society that is either financially disadvantaged from having the financial resources to maintain monthly gym fees and/or place an outlay of cash for private apparatus purchases. Even those members who may afford such expenses, often and wisely, make choices to reduce such expenditures. Furthermore, gym locations require time and more financial resources to travel to/from. After calculating the money factor of gym fees, and the time-travel expenses these members may likely reassess expenditure versus gain to obtain actual benefits of the use of an apparatus. Thus there exist challenges of an embodiment being readily available, and expensive regarding an apparatus.

A second problem is associated with methods of use of embodiments that often arise from the wide array of purposes for which an apparatus is made. With an ever increasing specialized world, the details of nearly any given field, e.g. physical exercise, assembly/disassembly of an apparatus processes, intellectual activity and/or support objects thereto, and/or amusement, have an ever growing need to accumulate additional apparatuses and methods to use a given embodiment. However, in part, due to the increased specialization, there results multiple devices to cover a multitude of applications. For example an adjustable wrench formerly sufficed to cover a range of bolt heads from small, 5/16 inch, to large, 15/16 inch. Modernization in a specialized world now optionally presents the world with a set of nearly ten separate wrenches covering the same dimensions, 5/16 through 15/16; effectively increasing a user's total object from one to ten wrenches. Similarly, e.g. if a person desires to efficiently pursue physical fitness for multiple muscle groups there should optimally be a single-unit apparatus with multiple embodiments and associated methods thereto. However, as with the wrench example, a specialized contemporary society has easily increased the number of apparatuses whereby each method has its own specific apparatus embodiment, e.g. in the field of physical exercise. What at one time served to provide exercise of the upper body, a free weight set of barbells and dumbbells, eventually was surpassed by a universal set, among numerous other apparatuses; bringing with them multiple methods of use. Further advancement of being physically fit developed into new methods of physical exercise, e.g. stretching, rotating, aerobic, isokinetic, isometric and isotonic. These rather stationary actions lacked mobility and even more methods of exercise were developed, e.g. cycling, running, swimming, rowing, boxing, jumping, skiing, snowboarding, whereby each modality captured a series of unique methods. These multiple methods, becoming further specialized for training, developed apparatuses that focused on specific body areas or muscle groups aimed at improving a specific discipline. Eventually, a special method was proposed for each specialized apparatus, thus, if a person wished to cover all the methods proposed, it was necessary to have the multitude of apparatuses that accompanied each method. Too often an apparatus and its method was made for a single purpose and failed to cross over into other uses within the same field, and/or alternative fields. Thus there exist challenges of methods of use of embodiments that are separate from the vast array of apparatuses available to a consumer.

A third problem is associated with systems and methods in a single-unit apparatus that often arise from a lack of creating efficiency among objects and methods thereof. A significant sector of society who may desire, at least, to increase and/or maintain physical and intellectual fitness may be challenged to find articles of invention that serve such noble purpose. While a weight set to serve physical fitness, and a book support device to serve intellectual activity are readily available, there is very little, if any, apparatus system, and/or method thereof, whereby these two disciplines, i.e. exercise and study, are united within one and the same apparatus. Further, the same person may chose to have a breather from exercise and study by entertaining themselves with an amusement device as well, e.g. an apparatus whereby musical tones may be practiced, or massaging the difficult to reach itch on the middle of ones back, or lazily reach a light switch while reclining in a chair. Thus there exist challenges with systems and methods in a single apparatus available to a consumer.

A fourth problem is associated with physical exercise that often arise from a lack of a unique apparatus, and/or method thereof, that is capable of uniquely dealing with the multiple disciplines and modalities in the physical fitness field. A primary function of physical exercise is to preserve the integrity of a given muscle; avoiding hyperextension, torn muscles, or contrarily, atrophied, unexercised muscles. The basic function to condition a muscle is to extend and relax by motion caused by a direction of the user's intellect upon said muscle. Often this is a subconscious connection between a person's intellect and their physical body, however, in the learning process of a new routine, or multiple routines, there is required an initial conscious effort by the user of an apparatus to perform a given exercise in a specified manner. Many physical injuries result from improper warm up, stretching. While recovery and rehabilitation from an injury, or simple toning, even muscle building may be a goals of a person, too often there lacks discipline for the user to have a single-unit apparatus, or embodiment thereof, whereby a user is provided not only a system but also a method thereto. Often a person may desire to tone muscles via high repetition of a given exercise, or may desire to build body strength from within via isometric, or build bulk via isotonic exercise, or increase the benefits of an aerobic exercise via isokinetic exercise, yet such person is left void of an apparatus that encapsulates each of these disciplines, i.e. stretching, rotation, isokinetic, isometric and isotonic. Thus there exist challenges within the field of physical exercise to meet the needs of the population in an efficient manner.

A fifth problem is associated with the assembly processes for an embodiment of an apparatus. Often there is a plurality of pieces that accompany an apparatus. During the assembly process of an apparatus there may be a method of reusable attaching-pieces that are used with a sole function to make the pieces of the apparatus contiguous with each other in the formation of an embodiment(s), e.g. bolts, nuts, screws, pegs; affording a potential reusable lifespan. Other methods of contiguity may have a one-time use and may include press-fittings, seams, welds, compression fittings, rivets, nails, glues; limiting, even eliminating any reusability feature. The former method, even if engineered for a long lifespan of use/reuse, may have risk factors that exist outside of the piece itself, yet potentially imposing a failure status to the embodiment during the assembly process. These risks include premature failure, excessive wear and tear, loss, altered surfaces making the attaching-piece incompatible, e.g. stripped or crossed threads, misaligned contact points. A third method of assembly exists via the employment of attachable components, e.g. button-snaps, or similar fastener options. While this third method shares some of the same risks as the method of reusable attaching-pieces they at least would not suffer potential loss because they are attached to an actual piece of the apparatus. Thus there exist challenges associated with the assembly processes for an embodiment of an apparatus.

A sixth problem is associated with the disassembly processes for an embodiment of an apparatus. During the assembly process, of an embodiment, there may exists a method for a one-time use of attaching-pieces, supra; eliminating any reusability of those attaching-pieces, thus making the assembly process irreversible. Thus disassembly becomes impossible, at least, for any reusability purpose. Alternatively when a reusable attaching-pieces method, supra, is used for assembly which should also provide the ability of disassembly, there requires time, effort, potential expense of replacement for compromised, or lost attaching-pieces, as well as other potential associated risks, supra; making disassembly arduous upon the user; limiting or even eliminating the potential for re-assembly of the embodiment. Thus there exist challenges associated with the disassembly processes for an embodiment of an apparatus.

A seventh problem is associated with intellectual activities associated with an embodiment of an apparatus. Mostly apparatuses are engineered for a specialized use and fail to have a carry-over to other fields of endeavor. For example, when a person pursues physical fitness via employment of an apparatus, generally, if not always, the apparatus was engineered for use under the confines of physical exercise. Now while a free-weight is manufactured for use in a physical fitness regimen, it might also be used as a paper weight, or to keep a book opened for a studious person learning a new academic discipline. However, these latter methods of use were not intrinsically, nor intentionally, engineered into the system or method of the free-weight manufacturing. Alternatively when the same person may use a book to increase intellectual activity resulting in knowledge, it was not an intrinsic element of the engineering of the book to have it be used as a means to increase the physical fitness of the user; even though the book, or a plurality of books, may be large, heavy and when placed inside a book bag create the potential to be used as a mean to circularly be swung thus increasing the heart rate and respiration of a user; two key results for a person who pursues a cardio exercise routine. Generally speaking, an apparatus for physical exercise stays within the methods of physical exercise; conversely an apparatus for intellectual activity stays within the methods of academia. Furthermore, most apparatuses are engineered and intended to be assembled once, or at least minimally disassembled repeatedly. Thus there exist challenges with intellectual activities associated with an embodiment of an apparatus; minimally having an intended cross-over purpose, and/or dual purpose capability within the assembly/disassembly process, and/or a limited reusability feature.

An eighth problem is associated with amusement with an embodiment of an apparatus. Amusement can be somewhat comparable with the notion of leisure, the latter being a freedom from time-consuming duties, responsibilities, or activities. While the former may be described as a state of being amused, i.e. occupying in an agreeable, pleasing, efficient, or entertaining fashion; it does not isolate a person from approaching leisure. In an ever increasing hectic global and time-zone-less era, peoples' many-times chaotic schedules result in high stress, and strenuous exertion, taxing nearly every fiber in the human physiological makeup; resulting in health challenges that range from strokes, cardiac arrest, nutrition disorders, to psychological challenges, substance abuse and a plethora of societal mishaps effecting nearly all sectors and age groups in society. The concept to stop and smell the roses appears to be lost; along with the absence of wild roses in a cement landscaped terrain of growing metropolises. The electronic age has replaced natures' seasonal schedule of pacing the human rhythm of life, calmness, efficiency and patience to be in sync with the rising and setting of the sun. Immediate action or reaction, nearly instantaneous communications, showering newly set deadlines, financial indebtedness, and more, has built highways of ever widening and increasing personal boundaries; litigious circuses of human actors; injurious intersections of human thoroughfares, and disengaged interpersonal relationships. While advantageous potentials are forthcoming from the electronic lightning speed connection of stellar bound interconnectedness, the electronic age left behind carrying for that smallest point of an electronic stimulant, the human cell. While billions of neutrinos race though the thumb of a person every second, the constant demand placed upon the intellect of that same person seems to hardly ever rest, and more certainly, hardly engage in an amusement activity, no less embrace true leisure. The simply act of engaging a hula-hoop would never make the light of day in a corporate environment, no less a bored meeting. Yet the overstressed seasons pass by like ticks on the world clock. Here again, the hula hoop while being a source of amusement, might also be a structure upon which fabric may be laid over to provide shade for a person studying how to physically exercise. But, this was not engineered into the hula hoop, or its methods of use. Thus, although the hula hoop may arbitrarily include multiple purposes, enhancing physical exercise, support to an intellectual activity and amusement, it, like many other amusement apparatuses, was not so engineered or methodized. Most embodiments for amusement rarely have multiple purposes beyond amusement. This factor makes amusement embodiments less desirable, certainly for frequent accompaniment between a residence and workplace. Thus there exist challenges associated with amusement with an embodiment of an apparatus.

### SUMMARY OF THE INVENTION

Disclosed herein are systems and/or methods related to an apparatus with a potentiality of multiple embodiments. In view of the foregoing, it is an objective of the present invention to provide solutions to the challenges and/or problems discovered in the field of the invention and subsequently the background of the invention.

As noted in the background of the invention, there exist multiple challenges regarding embodiments of an apparatus and methods thereto. Disclosed herein, this patent writing, are teachable matters that enable persons having ordinary skill in the art to replicate the present invention.

In the world there exists a growing number of persons who are entering into their elderly years ranging in their 50's, 60's and 70's; along with an existing population sector beyond such years; in the wisdom years of life. There also exists that sector of the population entering into their 20's, 30's and 40's, who may appear to be in the prime of their life. Finally, there exists a fourth sector of the population that is in their childhood, and adolescent years. Within all four of these sectors there exists percentages of individuals who uniquely suffer a challenge that may disadvantage them from the population at large, albeit physical and/or intellectual challenges, injuries, recoveries or permanent disabilities. The instant invention is novel to the world of users and unique to the field of inventions because it is a solution to problems and it also applies to nearly all age groups, physiological conditions, and financial status, as it enhances a user to increase a physical, and/or intellectual, and/or amusement pursuit of existence; while providing a system and a method that conjoin a physical action with an intellectual activity, minimally during the assembly process, and/or disassembly process, and/or reuse of the multiple embodiments and potential uses, comprised within a single-unit apparatus.

The ripening and harvesting of solutions, to the challenges and/or problems recited in the background of the invention, may be found within the instant invention. Specifically addressing a first problem for systems of embodiments that are challenged by environmental settings. Because the instant invention is engineered to be portable and light-weight it provides a user the option to choose an environmental setting of choice, e.g. indoors or outdoors. An object of the invention is to allow a user to not be restricted by nature and weather conditions, nor to be confined inside improved structures. The restrictions placed upon a user of a non-portable and/or heavy apparatus are thus removed, consequently a user may benefit from an outdoor use in the sunshine, as well as optionally benefit from an indoor use during severe lightening storms. The user may utilize the single-unit apparatus in an environment free of pollen, insects, and/or bird-droppings while profiting from the features and benefits of the invention. Therefore, the suffering for portability and weight issues are resolved because the invention is portable and lightweight.

Another object of the invention addresses the systems of embodiments challenged by physical settings. With the user's efficiency in mind, the invention was, in part, engineered so that the user could minimize a multitude of objects in the pursuit of a given task, e.g. a physical exercise routine. The single-unit system of the invention eliminates a need for multiple objects that would otherwise cover a multitude of methods of use that the other objects would provide. Because the single-unit system, the invention in part, is self-contained and storable for transportation, it also provides the objective to be easily transportable; e.g. inside a gym-styled bag, in a briefcase, in a suitcase during travel. This objective of the invention allows the user uninterruptible use whether spending long hours at the workplace or short stays at the residence. Therefore, the sufferings caused by a necessity or inconvenience of multiple embodiments as well as not being easily transportable are resolved because the invention is a single-unit and easily transportable between two locations; allowing a user to utilize the invention at home or at the workplace, or interchangeably both.

Another objective of the invention addresses systems of embodiments challenged by geographical location. Recognizing that persons are generally not restricted to a single geographical location, although even if they were so restricted the present invention could continue to accompany the user, and persons actually often travel beyond the local municipality of a residence. Challenged by a limitation in the quantity of items encumbering a traveler compactness of an object and durability of an object become paramount in determining if an object will be left behind, and thus unusable to a person. Because the invention has as an objective regular, even daily, use the invention was engineered to not be left behind during travels, thus maximizing the user's opportunity to employ the benefits of the invention. Thus it is engineered to be compact. Also during travel, items endure conditions not otherwise usually experienced; risking damage or premature failure. Because of these potential conditions the invention is made in a durable manner with materials that are rigid and capable of a rough packing during travel. Therefore, because the invention is compact and durable it resolves the issues concerned with travel to a variety of geographical locations.

Another objective of the present invention is aimed at systems of embodiments challenged by financial restrictions. A great percentage of members in society have limited resources to expend upon objects that may assist in the improvement and/or maintenance of their physical/intellectual wellbeing. Because the present invention is, in part, aimed at such improvement/maintenance it was engineered to be widely available to nearly all members in society. The benefits and features of the invention appear to facially outweigh the expense. However, because the fields that encompass a person's wellbeing are often tagged with a price point that re-occurs, e.g. a membership in a gym, or a price point of purchase plan payments over a monthly period; e.g. an outright purchase, it became a goal to produce and provide the present invention to the public at a cost comparable to a median hourly wage. This would afford every person the opportunity to avail themselves of the features and benefits of the present invention. Additionally, although the expenditure for private ownership, or minimally use in a public offered forum such as a public school, membership club, or otherwise, of the present invention is made possible that would be determinable, in part, upon the availability of access to the present invention. Thus to satisfy this challenging problem, the present invention is engineered via methods and materials that appear to be available worldwide; making the invention readily available. Therefore, because the invention is inexpensive and readily available it resolves the issues concerned with financial restrictions imposed upon potential users.

Thus regarding the challenges and/or problems facing a first problem of systems of embodiments that often have an inherent challenge that minimally may limit the environmental setting, a physical setting issue, geographical location, and/or financial restriction is resolved because the present invention cures such by providing the solutions, namely, the present invention is portable, and lightweight, and a single-unit, and easily transportable, and compact, and durable, and readily available, and inexpensive, as a multi-purpose apparatus; inherently capable of multiple-embodiments for, at least, human activities.

A continuation to a second ripening and harvesting of solutions, to the challenges and/or problems recited in the background of the invention, may further be found within the instant invention; addressing a second problem dealing with methods of embodiments. As determinable from addressing a first problem, supra, the invention inherently enjoys the solutions thereof, namely, the present invention is portable, lightweight, a single-unit, easily transportable, compact, durable, readily available, and inexpensive. Building upon these eight attributes, the present invention provides as a solution to compile multiple methods of use into a single-unit apparatus, effectively reducing, even eliminating, the need for a user to accumulate multiple apparatuses to cover a wider variety of tasks. Thus another objective of the present invention is to coalesce as many methods into a single-unit apparatus as possible; covering multiple purposes, e.g. physical exercise, assembly/disassembly of an apparatus, intellectual activity and/or amusement. Thus instead of a user accumulating four separate apparatuses for the four cited fields, there would be a single-unit apparatus to perform nearly the same result, or, instead of having multiple apparatuses to cover several methods of physical exercise, the same single-unit apparatus would be capable of providing several methods. Illustratively, this is possible because the present invention is created as a multi-purpose apparatus system and/or method(s); inherently capable of multiple-embodiments for, at least, human activities; performed in a standing, seated, supine, walking position(s); capable of exercise methods ranging from stretching, rotating, cardio, isometric, isotonic, to isokinetic; providing increased heart rates and respiration while strengthening, toning, rehabilitating, maintaining, improving physical/intellectual fitness; applicable to neck/shoulder, abdominal/back, pectoral/torso, arm/leg, wrist/ankle, foot/hand muscle and/or tissue; simulating bicycling, swimming, rowing, boxing, curling, pumping, or other modalities; facilitating un-wanted-fat waistline(s). Simultaneously, the present invention crosses over to provide also for methods of use within the intellectual activity and amusement fields. Therefore, the second problem as associated with methods of use of embodiments that often arise from the wide array of purposes for which an apparatus is made is resolved because it inherently provides for a multitude of methods of uses within a single-unit apparatus.

Furthermore, a third ripening and harvesting of solutions, to the challenges and/or problems recited in the background of the invention, may further be found within the instant invention; addressing a third problem associated with systems and methods in a single apparatus. While this has cross over elements to the other challenges/problems present in the background of the invention, it is important to note that there is a unique and separate reality of the importance to this solution, i.e. having a single-unit apparatus to create efficiency of objects and methods thereof. Illustratively, physical exercise is important to the wellbeing and overall health of humans. Numerous options have been presented to people throughout the ages as a means to stay fit. Often times a person needs multiple devices to cover a wide range of exercise types, e.g. stretching, rotating, cardio, isokinetic, isometric and/or isotonic, or, simulation of a multitude of modalities, e.g. bicycling, swimming, rowing, boxing, curling, pumping. The goals of a person who engages in physical exercise varies, however, often times because a height/weight ratio is suggested, many persons aim to attain a specific ratio. The goal to reach a specific weight often involves dealing with a un-wanted-fat waistline. In order to cover the wide range of exercise types and modalities recited, many of these means involve large, bulky, awkward, single-purpose machines, ranging from disc-type weights to treadmills, or even a wider array of specific equipment; usually aimed at specific muscle groups or exercises. These burden a person to cover the wide array of exercises and accumulation of multiple associated apparatuses. An objective of the present invention is to reduce the number of apparatuses without limiting the methods and uses provided by a multiple number of apparatuses; thus the invention has collapsed the need for multiple apparatuses by combining the benefits and features of several apparatuses into a single-unit apparatus. Therefore, a third problem associated with systems and methods in a single apparatus is resolved as the present invention is a single-unit apparatus.

Additionally a fourth, a ripening and harvesting of solutions, to the challenges and/or problems recited in the background of the invention, may further be found within the instant invention regarding exercise of the body. Nearly all joints, muscles groups, associated tissue need to be focused upon for a more complete physical fitness regimen. Often schedules and workouts may lack a balance between the different physical exercise methods; stretching may be overlooked, isometric may be replacement of isotonic, isokinetic may be replaced for another aerobics exercise. Because there is very little, if any, apparatuses in the market that covers nearly all types of physical exercise. Thus an objective of the present invention, at least, is to engineer and make available a system and methods thereof whereby a user may employ a single-unit apparatus, capable of multiple embodiments that first provide for stretching, followed by an embodiment that provides for rotating joints and related muscles/tissues, followed by an embodiment that provides for isokinetic and aerobic exercises, followed by an embodiment that provides for isometric exercises, followed by an embodiment that provides for isotonic exercises. Having thus engineered into a single-unit apparatus all such embodiments that accompany methods just cited, as a novel presentation to the world, and enabling persons having ordinary skill in the art; the present invention comprises of these modalities and more.

Specifically, the present invention provides for physical exercise methods recited as applied, in part, to increase heart rates and respiration while strengthening, toning, rehabilitating, maintaining, improving physical fitness; applicable to neck/shoulder, abdominal/back, pectoral/torso, arm/leg, wrist/ankle, foot/hand muscle and/or tissue; simulating bicycling, swimming, rowing, boxing, curling, pumping, or other modalities; and facilitating un-wanted-fat waistline(s). Therefore the fourth problem as associated with physical exercise that often arise from a lack of a unique apparatus, and/or method thereof, that is capable of uniquely dealing with the multiple disciplines and modalities in the physical fitness field is resolved.

Further a fifth, a ripening and harvesting of solutions, to the challenges and/or problems recited in the background of the invention, may further be found within the instant invention regarding the assembly of an apparatus. The background of the invention recites the challenges found in the assembly process of an apparatus. It thus is another objective of the present invention to reduce and or eliminate theses challenges. This is accomplished in the present invention by entirely eliminating reusable attaching-pieces from the apparatus; no less eliminating other methods of contiguity that may have a one-time use, e.g. seams, welds, compression fittings, rivets, and the like. Intentionally, the present invention is engineered so that the pieces comprised in the apparatus are integral to the embodiments forthcoming from the apparatus. This is accomplished by a unique method of assembly to be known as the twist-push locking-process method; locking contiguous pieces and resulting in a completed embodiment of a useable apparatus. Therefore, the fifth problem as associated with the assembly processes for an embodiment of an apparatus is resolved because each piece of the apparatus is self locking upon assembly.

Further a sixth, a ripening and harvesting of solutions, to the challenges and/or problems recited in the background of the invention, may further be found within the instant invention regarding the disassembly of an apparatus. Having thus benefitted from an assembled embodiment there often may arise the desire by a user to disassemble and/or reuse the pieces of an apparatus. Looking to the challenges recited in the background of the invention, it is understood that the aforementioned assembly process not only eliminates cited risks, but also it also makes potential a disassembly process whereby said embodiment pieces are made reusable. Another objective of the present invention is to incorporate a disassembly process this is accomplished by a unique method of disassembly to be known as the pull-twist unlocking-process method. Because this process occurs by the intrinsic pieces of an apparatus and unlocks contiguous pieces without causing damage and/or premature wear and tear it is novel to the world and unique to persons having ordinary skill in the art. Therefore, the sixth problem as associated with the disassembly processes for an embodiment of an apparatus is resolved because each piece of the apparatus is self un-locking upon disassembly.

Further a seventh, a ripening and harvesting of solutions, to the challenges and/or problems recited in the background of the invention, may further be found within the instant invention regarding intellectual activities at least, to support external devices/objects(s) that may increase a use of intellectual function(s). While facially a person may relate a known rubrics cube to an intellectual activity, it more properly might be classified under an amusement apparatus. Thus as an objective of the present invention, there was a look to the actual employment of the intellect as related to an increase in the use of intellectual function(s). This included but was not limited to sight, hearing, cognitive-skills; inherently comprising a physical-exercise in conjunction with an intellectual-activity during embodiment-assembly, thus augmenting the conscious-subconscious relationship, or at least, to support external devices/objects(s) that may increase a use of intellectual function(s). This is accomplished in the present invention by providing systems and methods that provide a means to enhance engagement of the senses via a support of foreign objects, that include, at least, hearing, sight, and touch. When a foreign object, e.g. an electronic book is supported within the present invention, it may produce audible presentations of an academic nature, or visual images that increase the knowledge base of a user. Additionally, via a touching of the pieces, of the present invention, by a user requires the user to become skilled in application of the proper amount of force and/or accurate direction of force during the assembly/disassembly processes. Furthermore, because there exists a plethora of assembly steps as well as a vast amount of exercise options related to a multitude of embodiments, all bound in a single-unit apparatus, enhancing a user to engage the intellectual activities related to the Dorsolateral Prefrontal Cortex (DLPFC). Therefore, the seventh problem as associated with intellectual activities for an embodiment of an apparatus is resolved because the use of the present invention inherently requires the user to engage the intellect, via the senses, during the assembly process, use, the disassembly process, uses, and/or reuse as methodized.

Further an eighth, a ripening and harvesting of solutions, to the challenges and/or problems recited in the background of the invention, may further be found within the instant invention regarding amusement with an embodiment of an apparatus. Another objective of the present invention is to provide a means as a solution to the often lacking pursuit of leisure via amusement in daily routine. Because the present invention already inherently provides multiple purposes within a single-unit apparatus, a user need not procure yet another apparatus for the engagement of an amusement activity. Therefore, making practical use of an already existing object, the present invention, the user is able to approach that realm of enjoyment in leisure; being free from time-consuming duties, responsibilities, or activities by utilizing the intrinsic amusement embodiments provided in the present invention apparatus. A light musical note may be exerted through a form of the apparatus that is selectable under the rigid tubular material used in the formation of the apparatus. This option to the user may be employed between a physical exercise, supra, or an intellectual activity, surpa, or purely on its own account. Therefore, the eighth problem as associated with amusement of an embodiment of an apparatus is resolved because it provides a means for a user to occupy oneself in an agreeable, pleasing, efficient, or entertaining fashion.

As provided under, and adherence to law, vocabulary is here noted, and may be defined within this document under these definition(s):
1. Active exercise: motion imparted to a part by voluntary contraction and relaxation of its controlling muscles.
2. Activities: plural form of activity: the state of being active; active: to include at least one or more state of function or capable of function. Function: the physiological property or the special action of an organ or body part; consistent with the normal functioning of an organism.
3. Actual: existing in reality or as a matter of fact, no longer potential yet having the capacity to be potential.
4. Actuality: the state of actually objectively existing; inherent capacity for potentiality.
5. Aerobic exercise: behavior designed to increase oxygen consumption and improve functioning of the cardiovascular and respiratory systems.
6. Amuse: to occupy in an agreeable, pleasing, efficient, or entertaining fashion.
7. Amusement: the state of being amused, entertained, or pleased.
8. Apparatus: an integrated group of materials or devices used for a particular purpose.
9. Assembly: the putting together of manufactured parts to make a completed product.
10. Augmenting: to make (something already developed or well under way) greater, as increasing size, extent, quantity, or quality.
11. Body: the entire material or physical structure of an organism, especially of a human or animal.
12. Cardio: aerobic exercise (also known as cardio) is physical exercise of relatively low intensity that depends primarily on the aerobic energy-generating process.
13. Cognitive skills: intellectual skills, the set of trainable intellectual abilities and methods that are held to underpin learning and performance.
14. Comprised: parts of a whole; part(s) used in the process to make a whole.
15. Contiguously: adverb of contiguous. Contiguous: sharing an edge, or boundary; touching, in physical contact.
16. Conjunction: the act of joining and/or the state of being joined.
17. Device: a contrivance or an invention serving a particular purpose, especially a machine used to perform one or more relatively simple tasks.
18. Dorsolateral Prefrontal Cortex (DLPFC): an area within the human brain that promotes long-term memory formation, comprising, though not exclusively, an executive function, e.g. working memory.
19. Elements: a fundamental, essential, or irreducible constituent of a composite entity.
20. Elongated: having more length than width; slender in physical form.
21. Embodiment: the act of embodying or the state of being embodied.
22. Embody: to represent in bodily or material form.
23. Exercise: activity that requires physical and/or intellectual exertion; especially when performed to develop or maintain fitness or to increase a skill.
24. Exercises: plural of exercise.
25. Exertion: the act or an instance of exerting, especially a more strenuous effort.
26. Exert: to put to use or effect; put forth effort.
27. External: relating to, existing on, or connected with the outside or an outer part; exterior.
28. Fitness: good health of physical and/or intellectual condition, especially as the result of exercise.
29. Force: the capacity to do work or cause physical change; any application of energy, either internal or external to a structure; that which initiates, changes, or arrests motion.
30. Function: the action for which a person or thing is particularly fitted or employed.
31. Incontiguous: not contiguous; not adjoining or in contact; not touching.
32. Inherently: existing as an essential constituent or characteristic; intrinsic.
33. Intellectual: of or relating to the intellect.
34. Intellect: the ability to learn and reason; the capacity for knowledge and understanding.
35. Isokinetic exercise: dynamic muscle activity performed at a constant angular velocity; torque and tension remain constant while muscles shorten or lengthen.
36. Isometric exercise: active exercise performed against stable resistance, without change in the length of the muscle.
37. Isotonic exercise: active exercise without appreciable change in the force of muscular contraction, with shortening of the muscle.
38. Locking-process: Locking: physical obstruction within a plurality of points in a joint that results in the near prohibition of movement of the joint; any device or part for temporarily stopping the motion of a mechanism; mechanism: any structure or arrangement of parts of a machine or device. Process: a series of operations, events, or steps leading to achievement of a specific result; exerted by human intellectual and/or physical power(s).
39. Machine: a device consisting of fixed and/or moving parts that modifies mechanical energy and transmits such energy into a more useful form; an intricate natural system or organism, such as the human body.
40. Material: the substance(s) of which a thing is made or composed; a group of ideas, facts, data, etc., that may provide the basis for or to be incorporated into some integrated work; an object producing an observation potential by a human being, e.g. be it images, printed and/or digital matter; piece(s) of printed matter, paper(s), a book, an electronic device/book; individually and/or collectively supported solely or with aid of yet another object, e.g. a clip board or similar device holding a plurality of paper(s).
41. Intellectual-exercise: intellectual: of or relating to the mind; intellect. Exercise: activity that requires physical and/or intellectual exertion; especially when performed to develop or maintain fitness or to increase a skill. Appealing to or requiring the use of the intellect via employment of the brain.
42. Mind: human consciousness that originates in the brain and is manifested especially in thought, perception, emotion, will, memory, and/or imagination; that faculty by which a person experiences and/or develops thoughts, feelings, emotions, and/or desires, capable to attend, remember, learn, reason and/or make decisions.
43. Modality: the fact, state, or quality of being modal. Modal: of, relating to, or characteristic of a mode. Mode: a manner, way, or method of doing or acting.
44. Multi-purpose: Multi: more than one. Purpose: a result or effect that is intended and/or desirable.
45. Named: to give a name to a thing. Name: a word, or words, by which an entity is designated and distinguished from other entity(ies).
46. Object: an entity that has a fixed shape or form that can be grasped by the senses, e.g. sight, hearing, touch.
47. Plurality: a state or fact of being more than one.
48. Potential: capable of being actual but not yet necessarily in existence; a thing possessing the capacity to be actualized; not existing in reality or as a matter of fact, no longer actual yet having the capacity to be actual.
49. Potentiality: the state or quality of being potential; inherent capacity for actuality.
50. Proportionally: forming a relationship with other parts or quantities; being in proportion. Proportion: a relationship between dimensions, or quantities, such that if a first “thing” varies then a second or another “thing” varies in a manner dependent on the first “thing”.
51. Pull-twist: Pull: to apply force to so as to cause or tend to cause motion toward the source of the force. Twist: to apply force in a spiraling, turning, or coiling direction upon an object; as by turning the end(s) in an opposite direction, or a curve on a plane that winds around a fixed center point at a continuously increasing or decreasing distance from that point.
52. Purposes: plural of purpose. Purpose: the reason for which a thing exists or is made.
53. Range of motion exercise: the putting of a joint through its full range of normal movements, either actively or passively.
54. Relationship: the condition or fact of being related; connection, a particular type of connection existing between two realities.
55. Repetitive: pertaining to or characterized by repetition (repetition: the act of repeating; repeated action, performance, act(s)).
56. Rotating: revolving around a central axis, line, or point.
57. Stretching: increasing something in one of its dimensions; to lengthen, to extend to a greater distance.
58. Subconscious: partially or imperfectly conscious; not wholly conscious; that part of the mind below the level of conscious perception; existing or operating in the mind beneath the conscious.
59. Support: to hold a thing in position so as to keep from falling, slipping, moving (thing: a material, inanimate object).
60. System: a group of interacting, interrelated, or interdependent elements forming a complex whole.
61. Tissue: an aggregation of morphologically similar cells and associated intercellular matter acting together to perform one or more specific functions in the body; four basic types of tissue: muscle, nerve, epidermal and connective.
62. Tolerances: plural of tolerance.
63. Tolerance: a permissible range of variation in a dimension of an object; a permissible variation of an object in some characteristic such as dimension, hardness, weight, or quantity.
64. Twist-push: Twist: to apply force in a spiraling, turning, or coiling direction upon an object; as by turning the end(s) in an opposite direction, or a curve on a plane that winds around a fixed center point at a continuously increasing or decreasing distance from that point. Push: to apply force to a thing in an attempt to move the thing in a specified direction.
65. Unlocking-process: the undoing process/procedure of the locking-process, supra.
66. Via: by way of, by means of, by agency or instrumentality.

### BRIEF DESCRIPTION OF THE DRAWINGS

Preferred and alternative embodiments of the present invention are described in detail below with reference to the following drawings:

FIG. 1 is an exploded view illustrating pieces to a multi-purpose apparatus, at least for use in a potentiality of embodiments of the instant invention;

FIG. 2 is a perspective frontal view illustrating an embodiment of a multi-purpose apparatus according to an embodiment of the present invention;

FIG. 3 is a perspective frontal view illustrating an embodiment of a multi-purpose apparatus according to an embodiment of the present invention;

FIG. 4 is a perspective frontal view illustrating an embodiment of a multi-purpose apparatus according to an embodiment of the present invention;

FIG. 5 is a perspective frontal view illustrating an embodiment of a multi-purpose apparatus according to an embodiment of the present invention;

FIG. 6 is a perspective frontal view illustrating an embodiment of a multi-purpose apparatus according to an embodiment of the present invention;

FIG. 6A is a perspective frontal view illustrating an embodiment of a multi-purpose apparatus according to an embodiment of the present invention;

FIG. 6B is a perspective frontal view illustrating an embodiment of a multi-purpose apparatus according to an embodiment of the present invention;

FIG. 7 is a perspective frontal view illustrating an embodiment of a multi-purpose apparatus according to an embodiment of the present invention;

FIG. 8 is a perspective frontal view illustrating an embodiment of a multi-purpose apparatus according to an embodiment of the present invention;

FIG. 9 is a perspective frontal view illustrating an embodiment of a multi-purpose apparatus according to an embodiment of the present invention;

FIG. 10 is a perspective frontal view illustrating an embodiment of a multi-purpose apparatus according to an embodiment of the present invention;

FIG. 10A is a perspective frontal view illustrating an embodiment of a multi-purpose apparatus, further assembled as illustrated and described in FIG. 10, according to an embodiment of the present invention;

FIG. 10B is a perspective frontal view illustrating an embodiment of a multi-purpose apparatus, further assembled as illustrated and described in FIG. 10, and further assembled as illustrated and described in FIG. 10A, according to an embodiment of the present invention;

FIG. 11 is a perspective frontal view illustrating an embodiment of a multi-purpose apparatus according to an embodiment of the present invention;

FIG. 11A is a perspective frontal view, with a foreign object E101, obtained from E100, obtained from M100, illustrated and described as M100 in FIG. 11, illustrating an embodiment of a multi-purpose apparatus according to an embodiment of the present invention;

FIG. 11B is a perspective rearward view, with a foreign object E101, obtained from E100, obtained from M100, illustrated and described as M100 in FIG. 11, illustrating an embodiment of a multi-purpose apparatus according to an embodiment of the present invention;

FIG. 12 is a perspective frontal view illustrating an embodiment of a multi-purpose apparatus according to an embodiment of the present invention;

FIG. 13 is a perspective frontal view illustrating an embodiment of a multi-purpose apparatus according to an embodiment of the present invention;

FIG. 14 is a perspective frontal view illustrating an embodiment of a multi-purpose apparatus according to an embodiment of the present invention;

FIG. 15 is a perspective right-side view illustrating an embodiment of a multi-purpose apparatus according to an embodiment of the present invention;

FIG. 15A is a perspective right-side view with a foreign object E201, obtained from E200, obtained from M100, illustrated and described as M100 in FIG. 11, illustrating an embodiment of a multi-purpose apparatus according to an embodiment of the present invention;

FIG. 15B is a perspective right-side view with a foreign object E201, obtained from E200, obtained from M100, illustrated and described as M100 in FIG. 11, illustrating an embodiment of a multi-purpose apparatus according to an embodiment of the present invention;

FIG. 15C is a perspective right-side-adjusted view with a foreign object E201, obtained from E200, obtained from M100, illustrated and described as M100 in FIG. 11, illustrating an embodiment of a multi-purpose apparatus according to an embodiment of the present invention;

FIG. 15D is a perspective left-side view with a foreign object E201, obtained from E200, obtained from M100, illustrated and described as M100 in FIG. 11, illustrating an embodiment of a multi-purpose apparatus according to an embodiment of the present invention;

FIG. 15E is a perspective left-side-adjusted view with a foreign object E201, obtained from E200, obtained from M100, illustrated and described as M100 in FIG. 10, illustrating an embodiment of a multi-purpose apparatus according to an embodiment of the present invention;

FIG. 16 is a perspective frontal view illustrating an embodiment of a multi-purpose apparatus according to an embodiment of the present invention;

FIG. 16A is a perspective frontal view with a foreign objects E102, E301, E302, E303, and/or E304 obtained from E100 and E300 respectively, being obtained from M100, illustrated and described as M100 in FIG. 11, illustrating an embodiment of a multi-purpose apparatus according to an embodiment of the present invention;

FIG. 16B is a perspective frontal view with a foreign objects E202, E301, E302, E303, E304, and/or E401 obtained from E200, E300, E400 respectively, being obtained from M100, illustrated and described as M100 in FIG. 11, illustrating an embodiment of a multi-purpose apparatus according to an embodiment of the present invention;

FIG. 17 is an exploded view illustrating pieces to a multi-purpose apparatus, at least for use in a potentiality of embodiments of the instant invention;

Like reference symbols in the various drawings indicate like elements.

### DETAILED DESCRIPTION OF THE PREFERRED EMBODIMENTS

This document describes and includes, in part, the contents of the abstract of this document.

As required under, and adherence to MPEP 608.01(w) referenced to 37 C.F.R. §1.84(s) and §1.71(e) “Authorization” here stated: “A portion of the disclosure of this patent document contains material which is subject to (copyright or mask work) protection. The (copyright or mask work) owner has no objection to the facsimile reproduction by anyone of the patent document or the patent disclosure, as it appears in the Patent and Trademark Office patent file or records, but otherwise reserves all (copyright or mask work) rights whatsoever.”

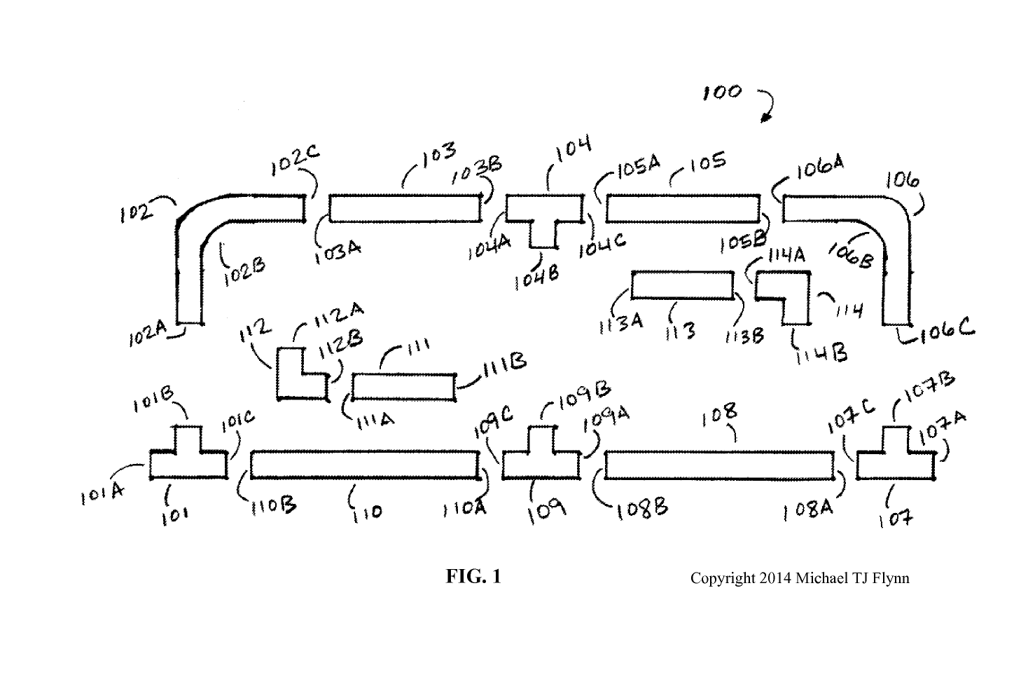

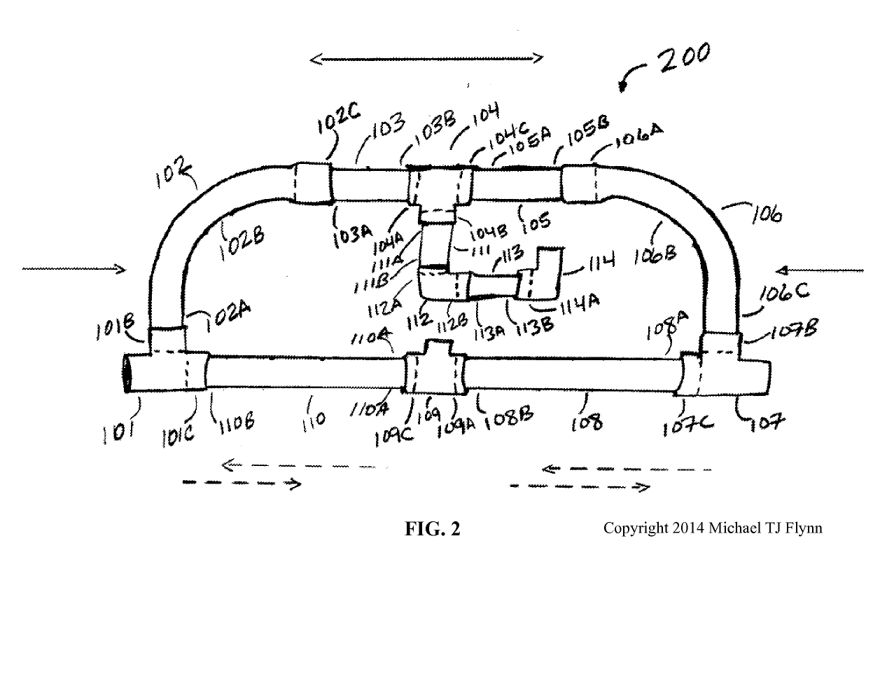

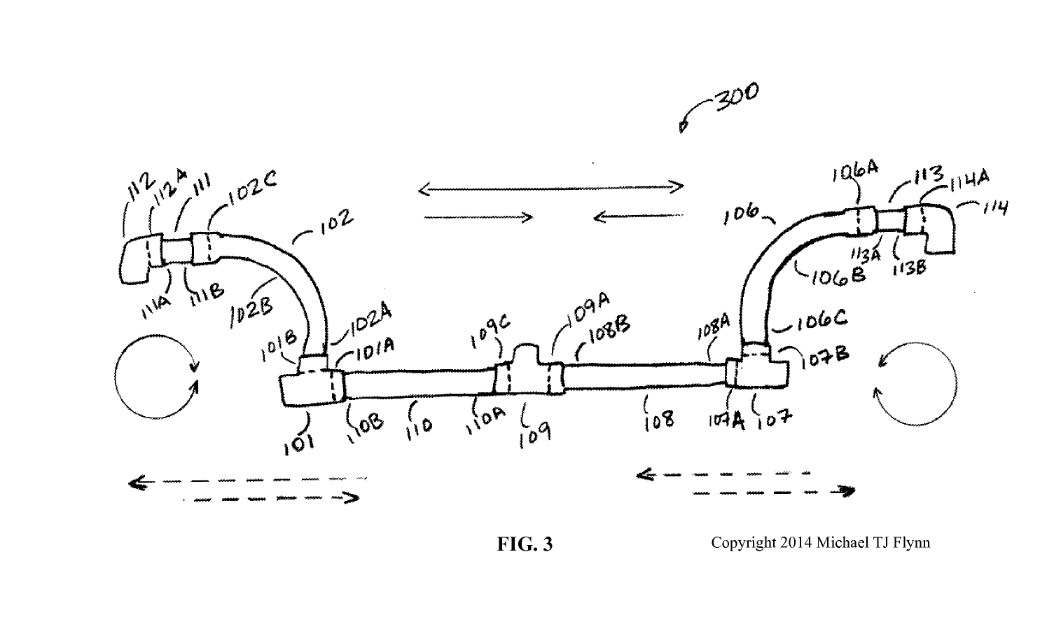

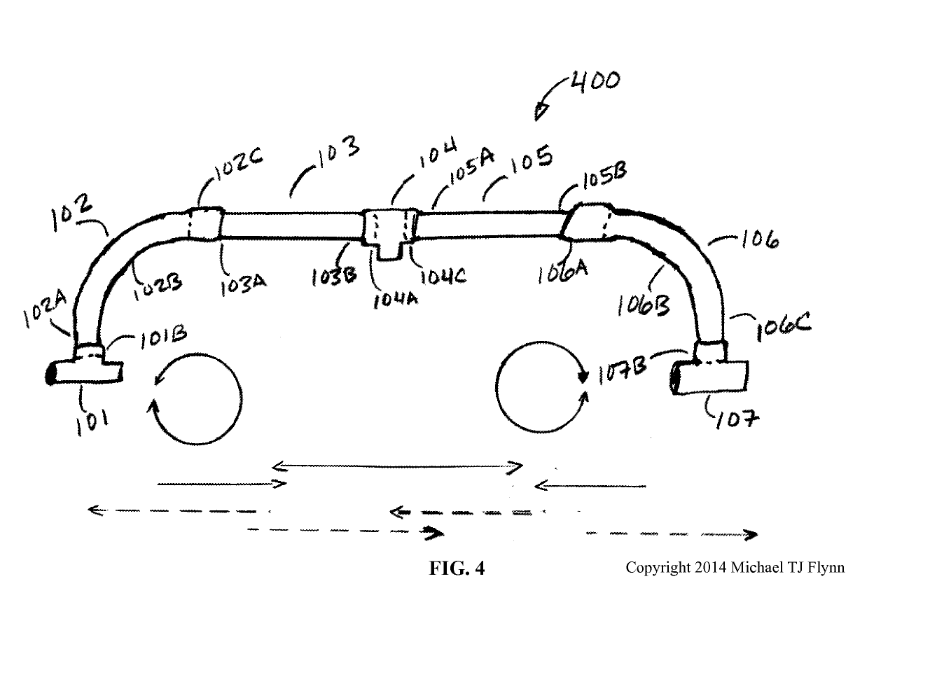

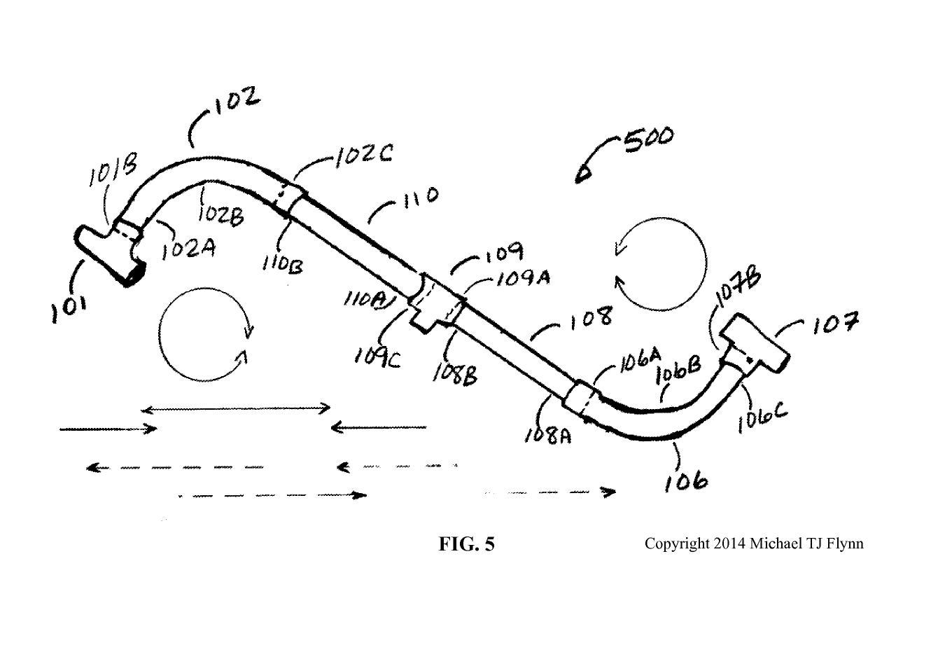

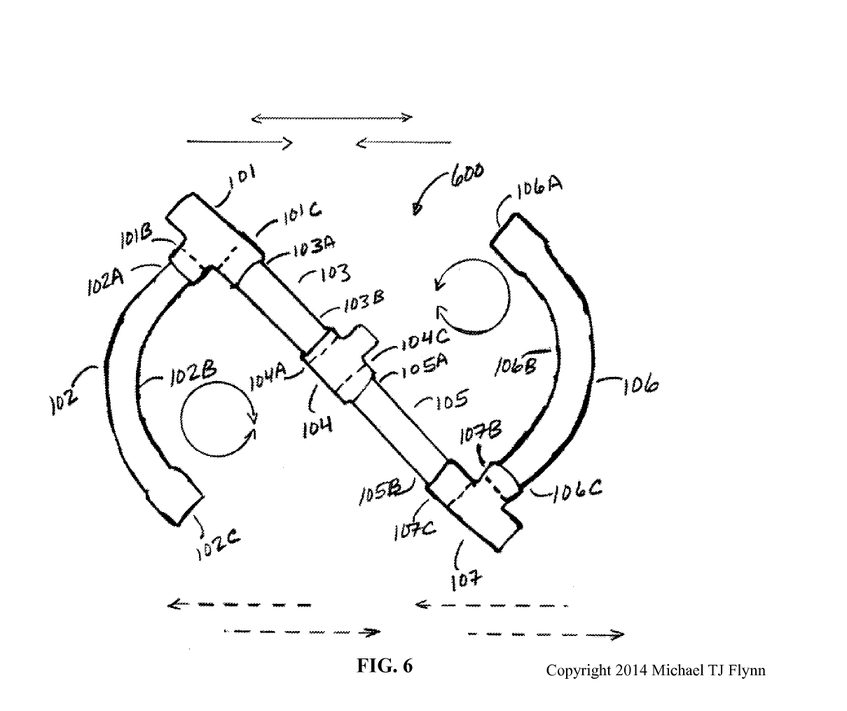

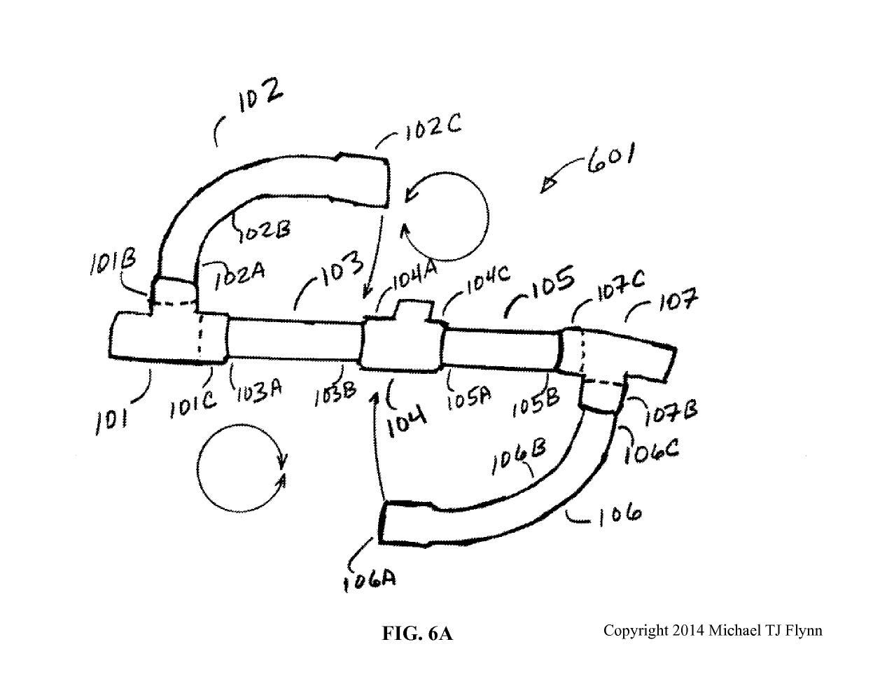

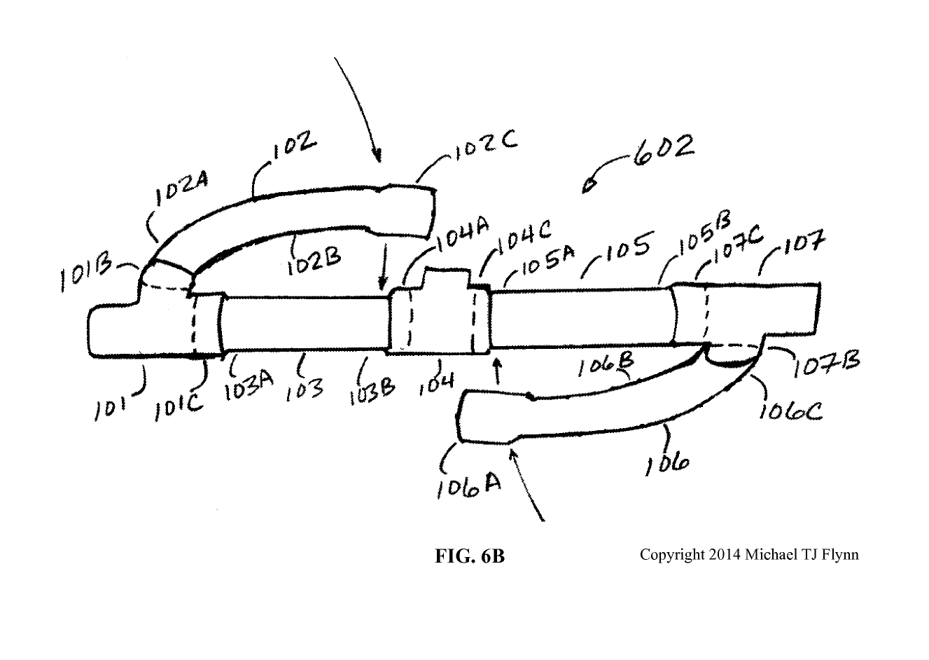

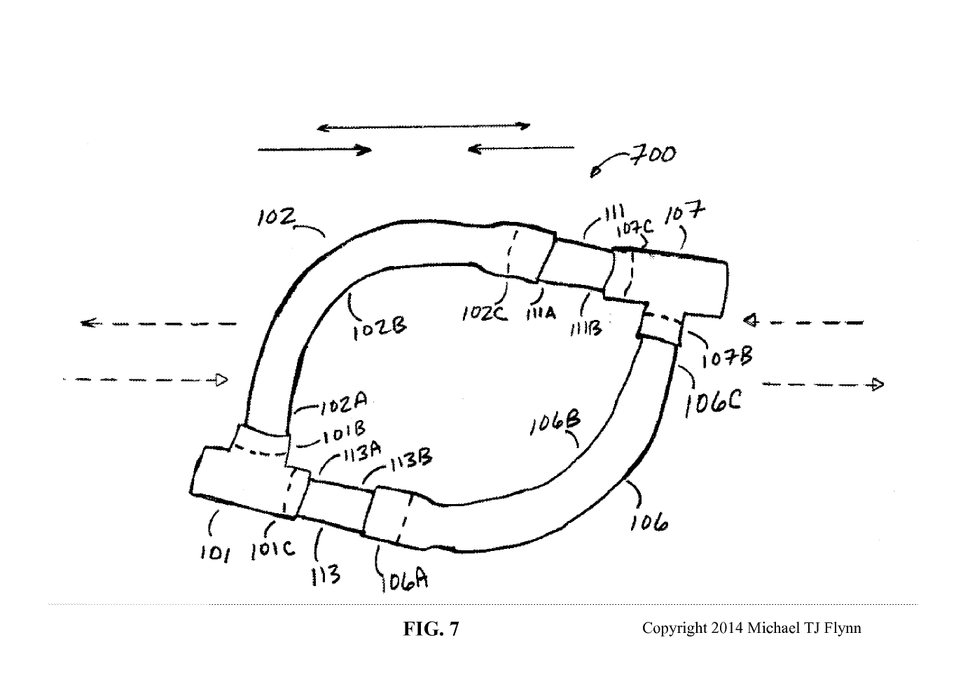

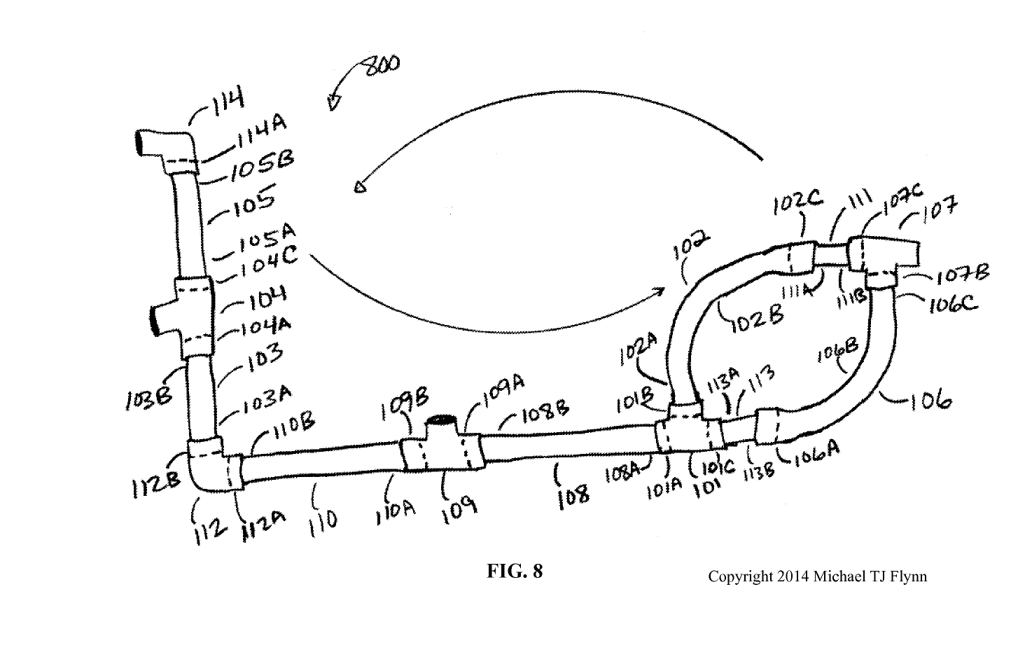

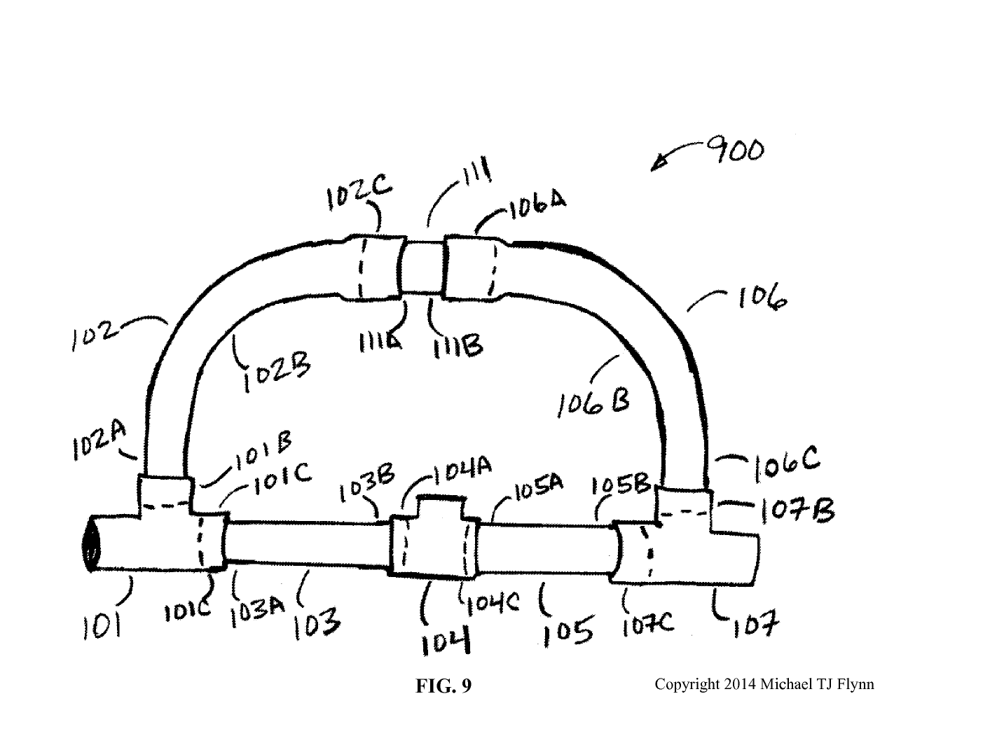

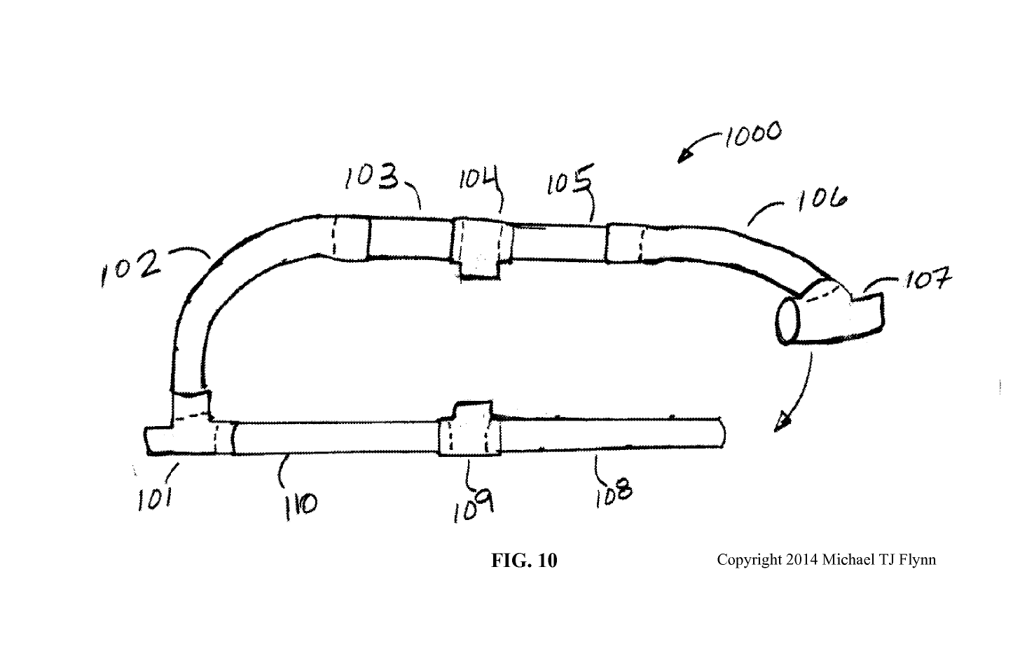

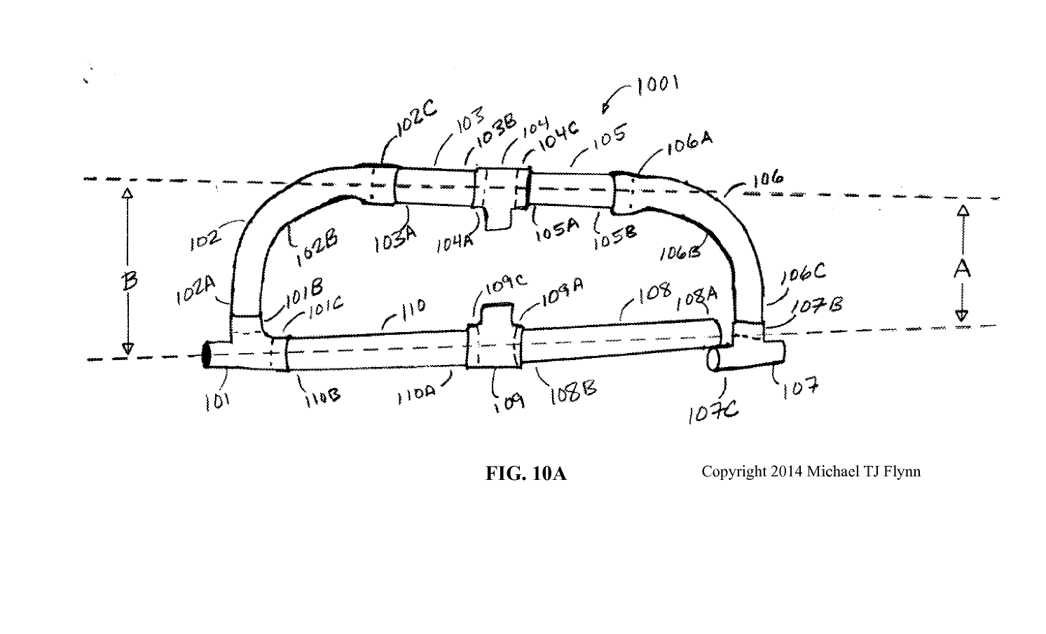

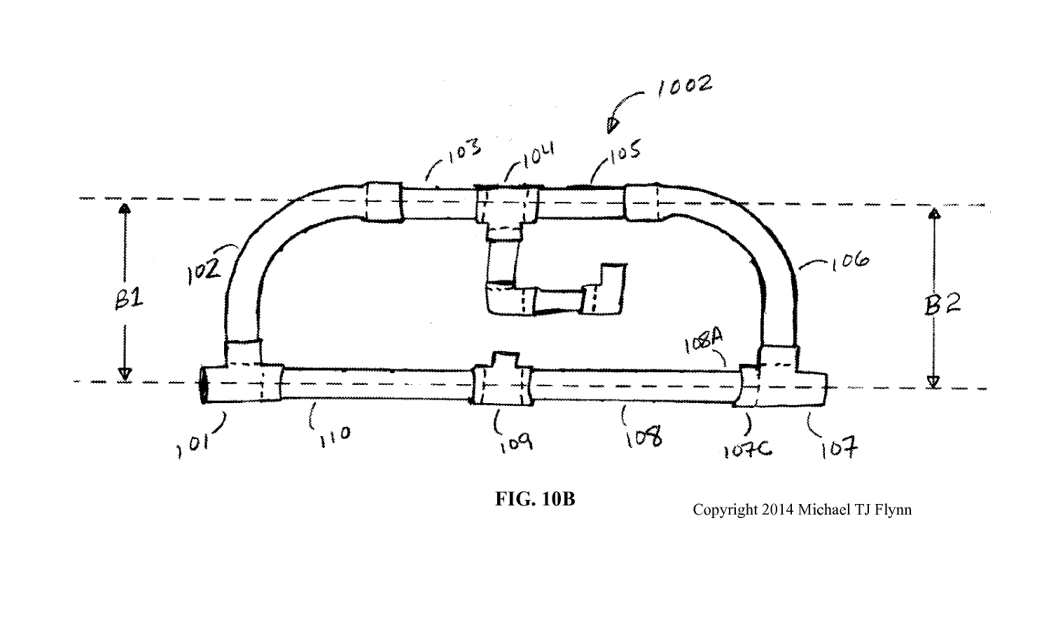

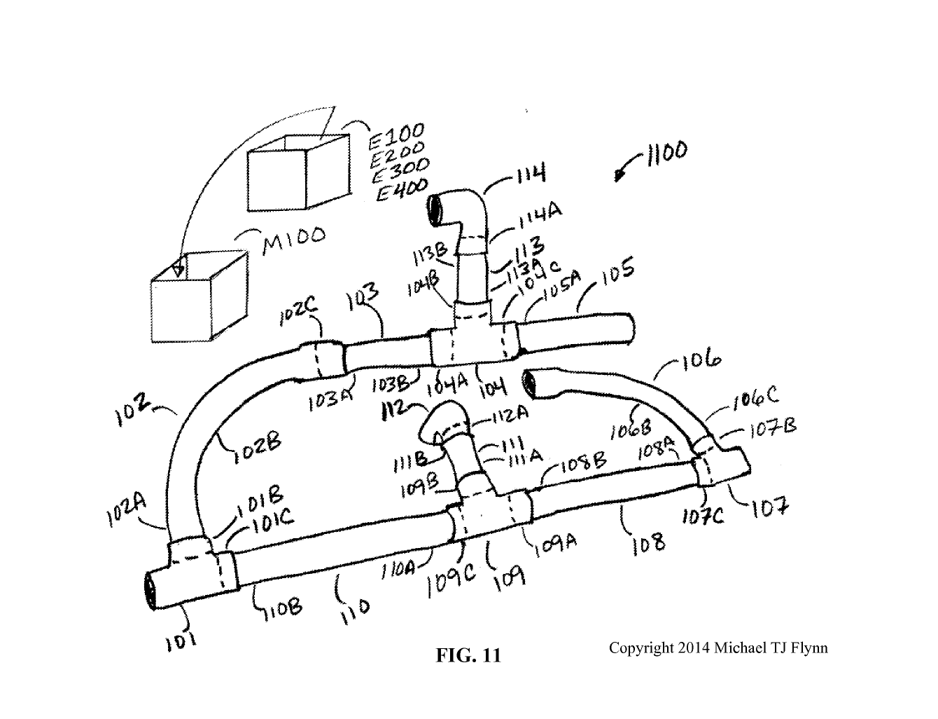

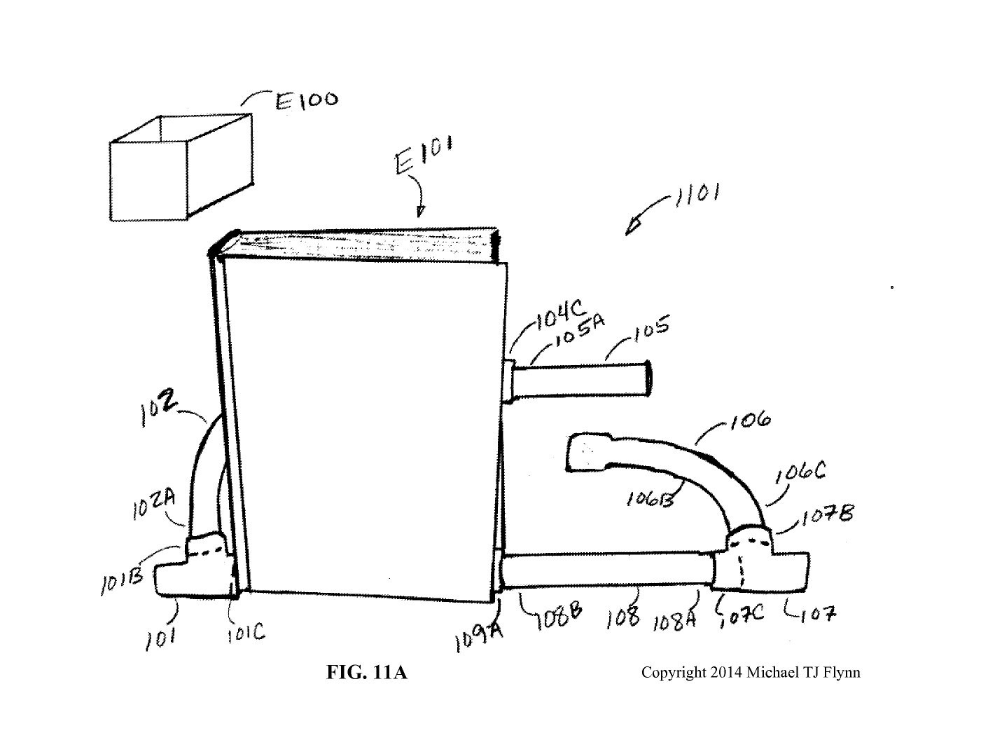

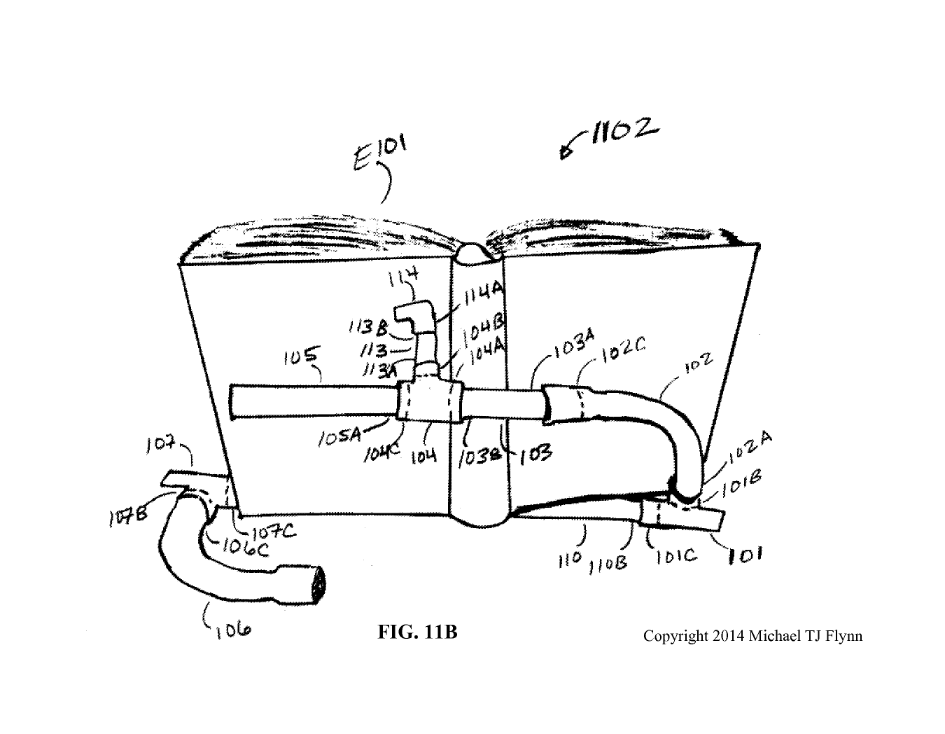

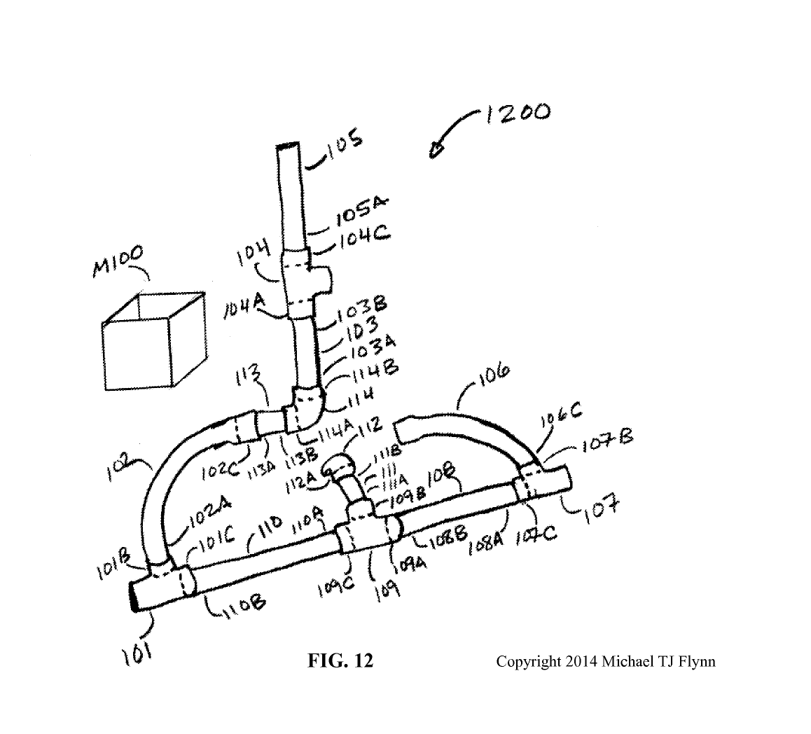

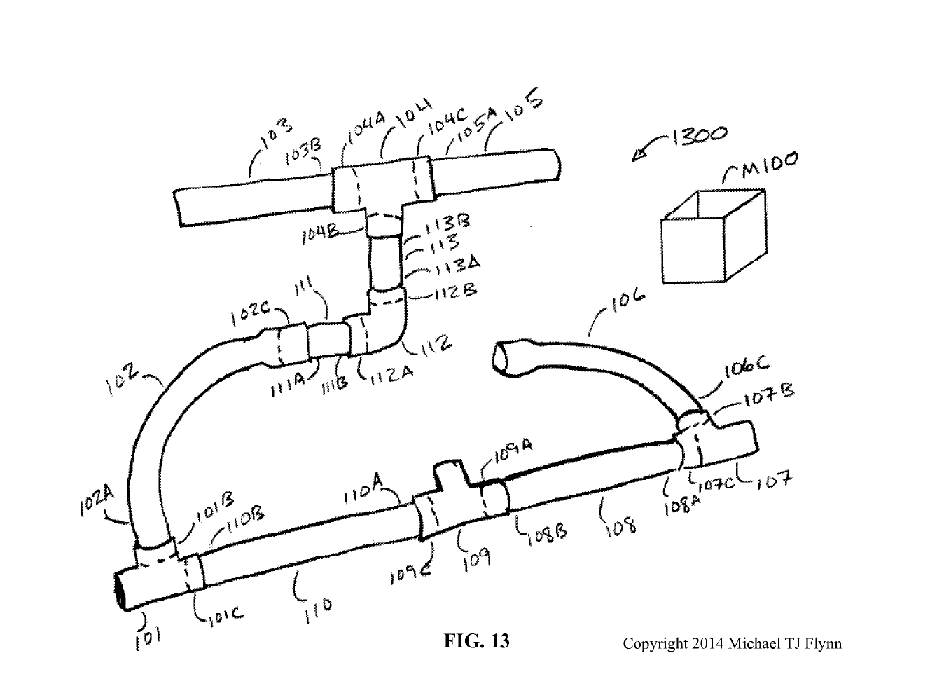

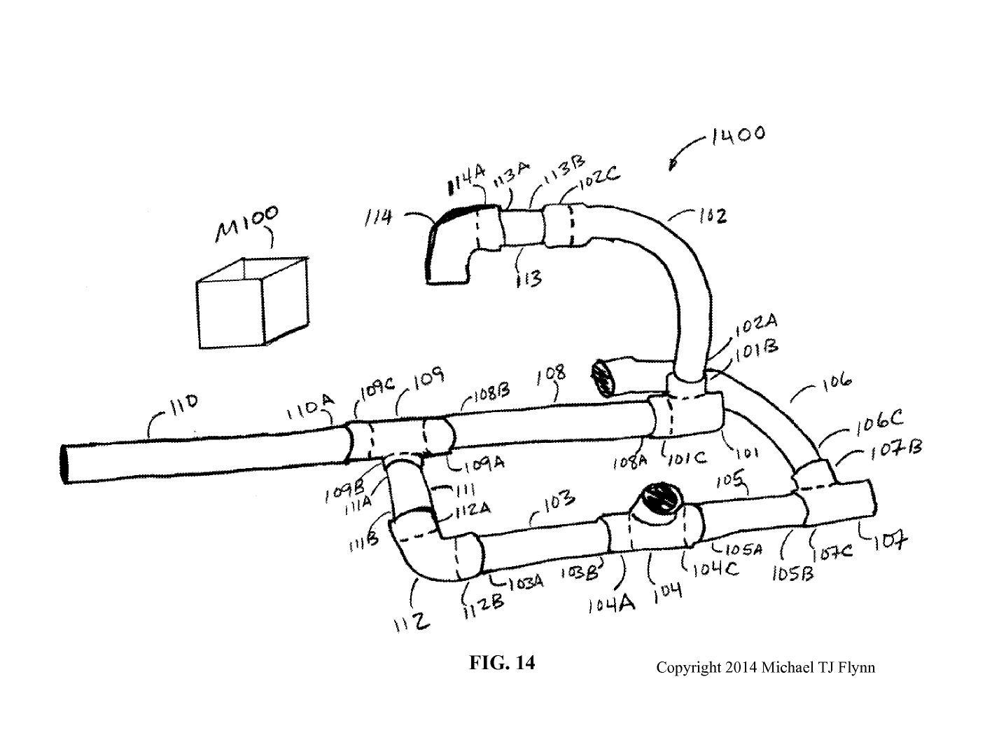

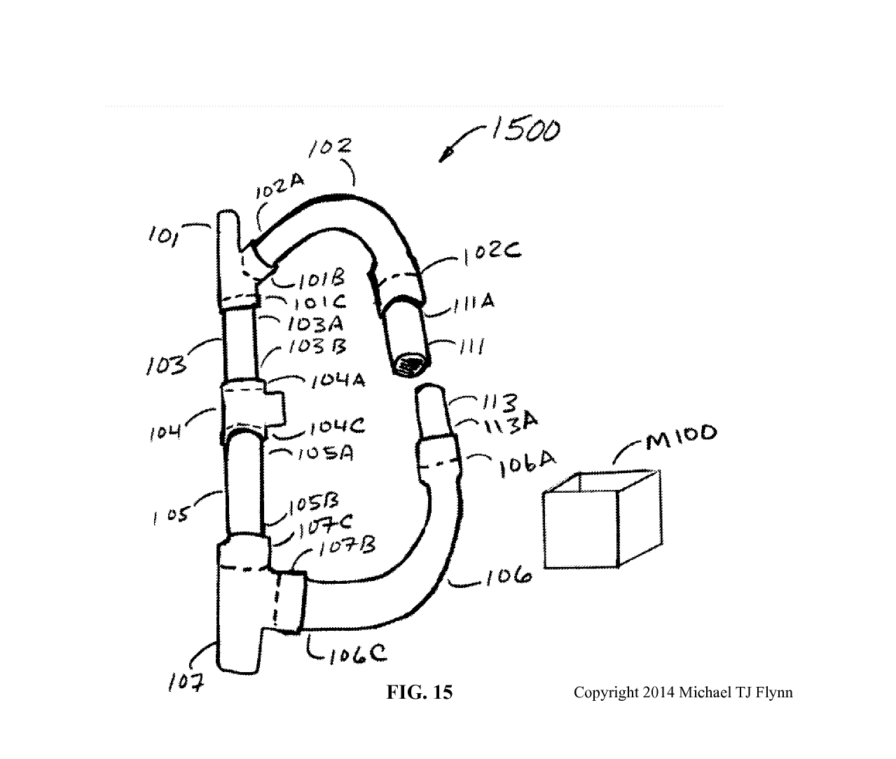

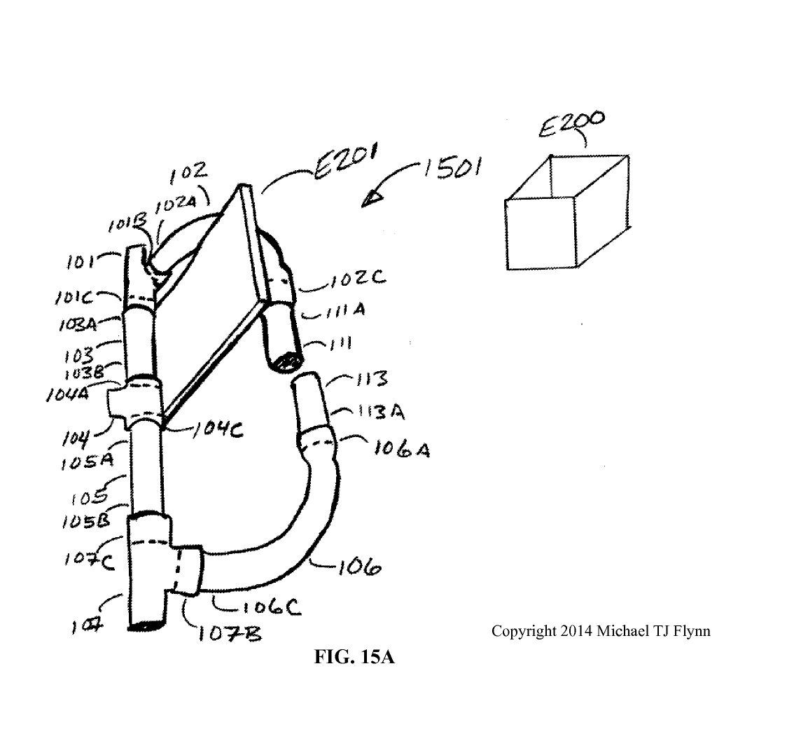

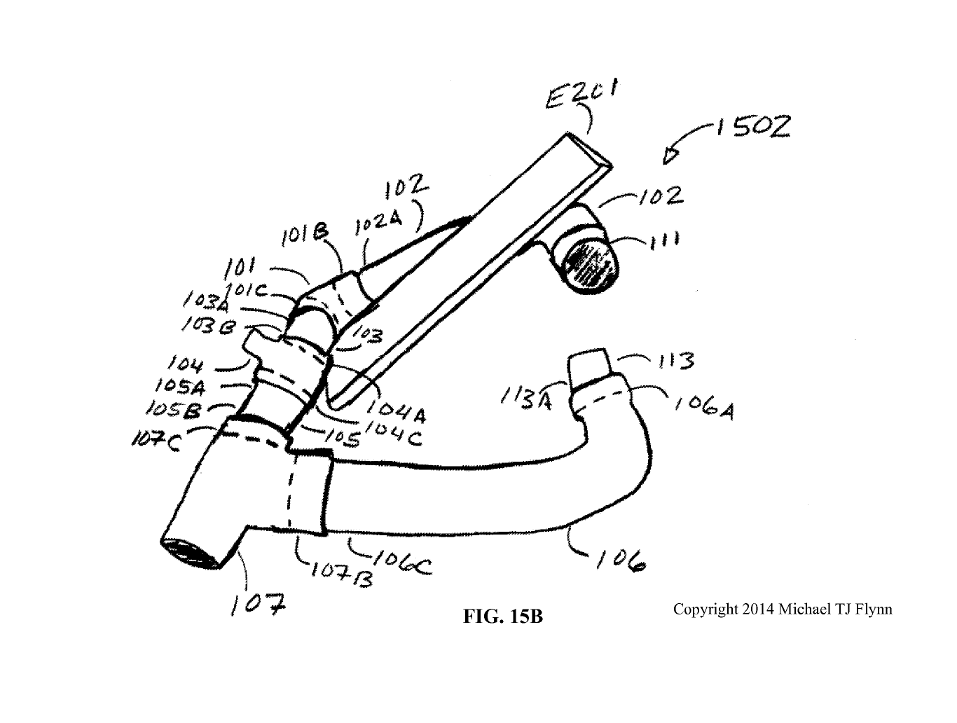

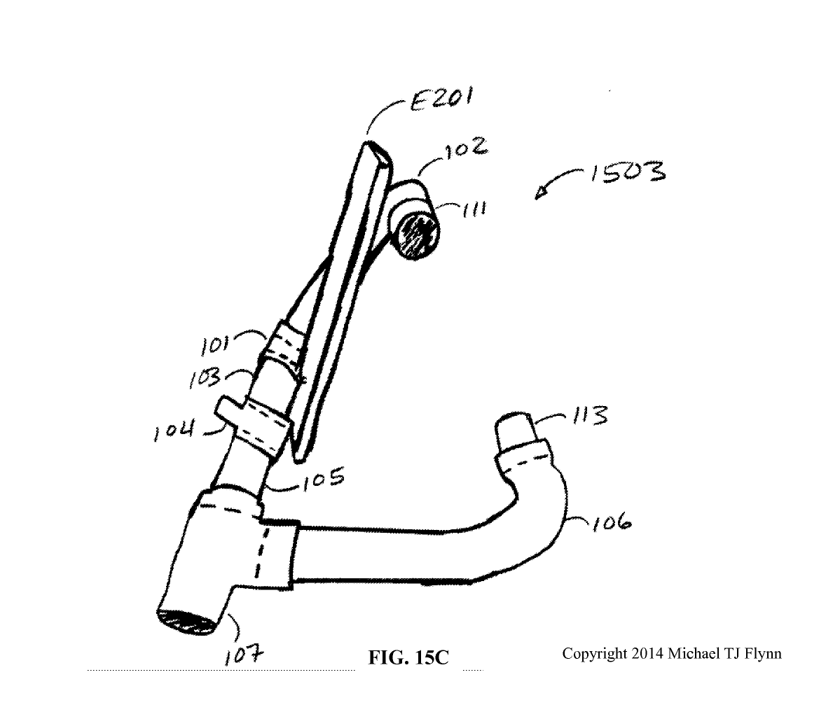

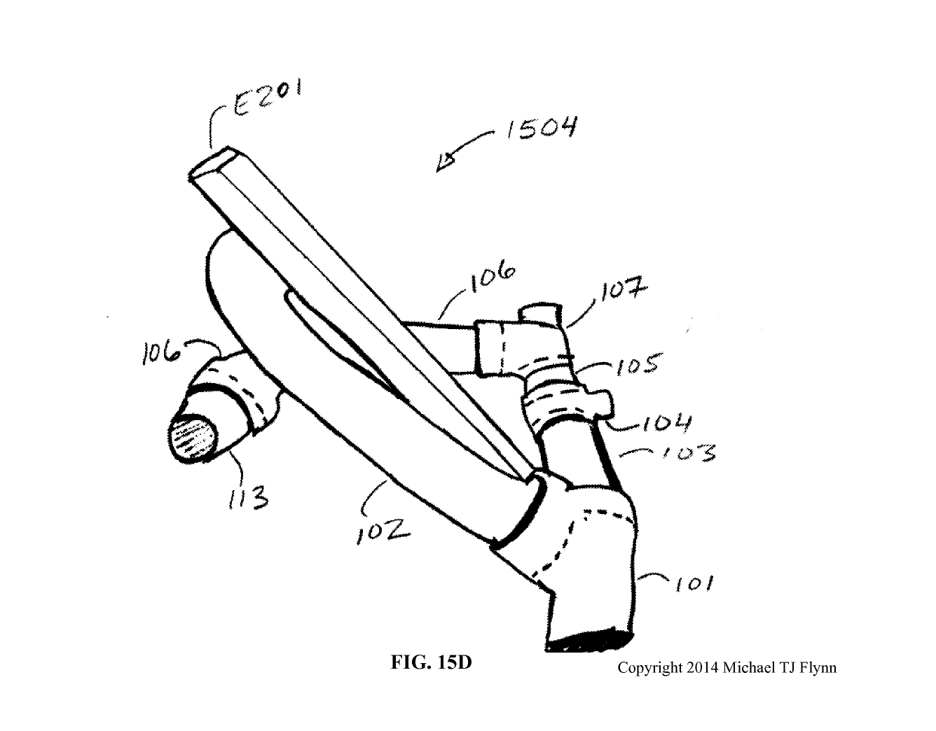

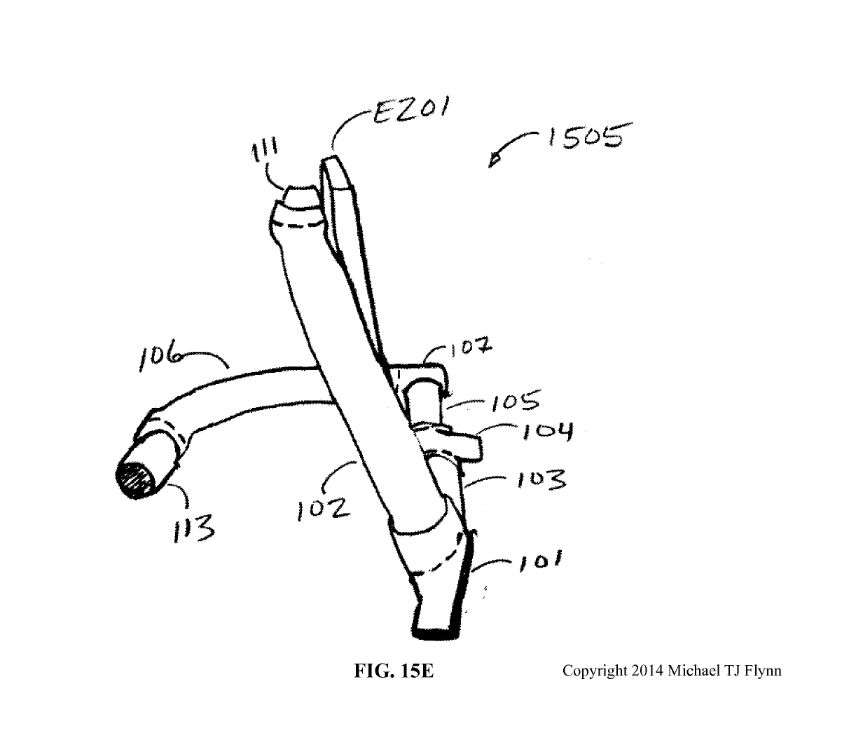

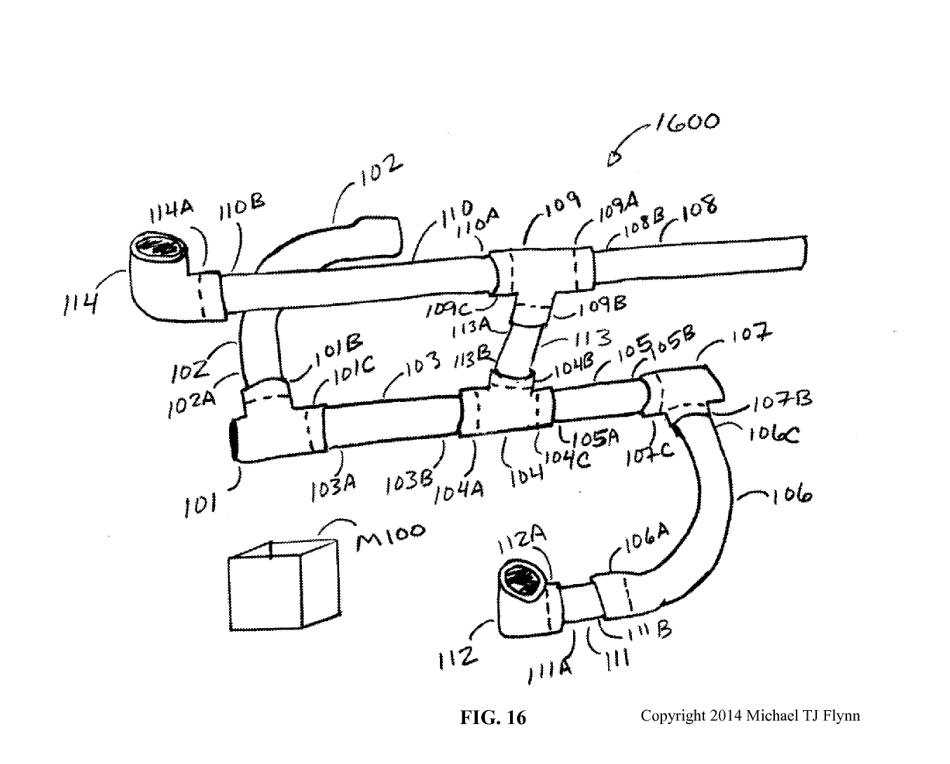

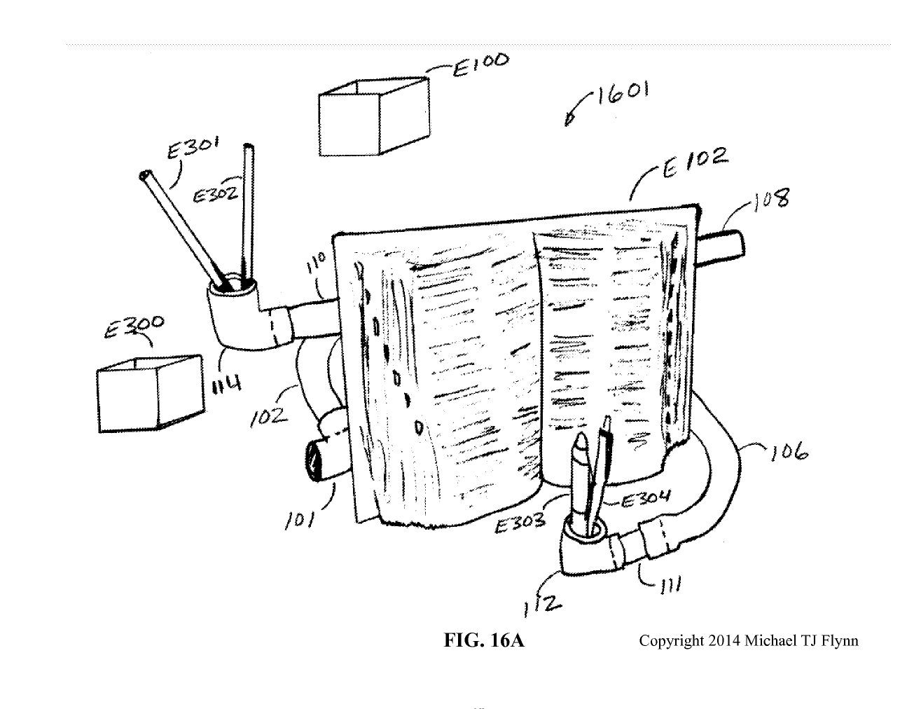

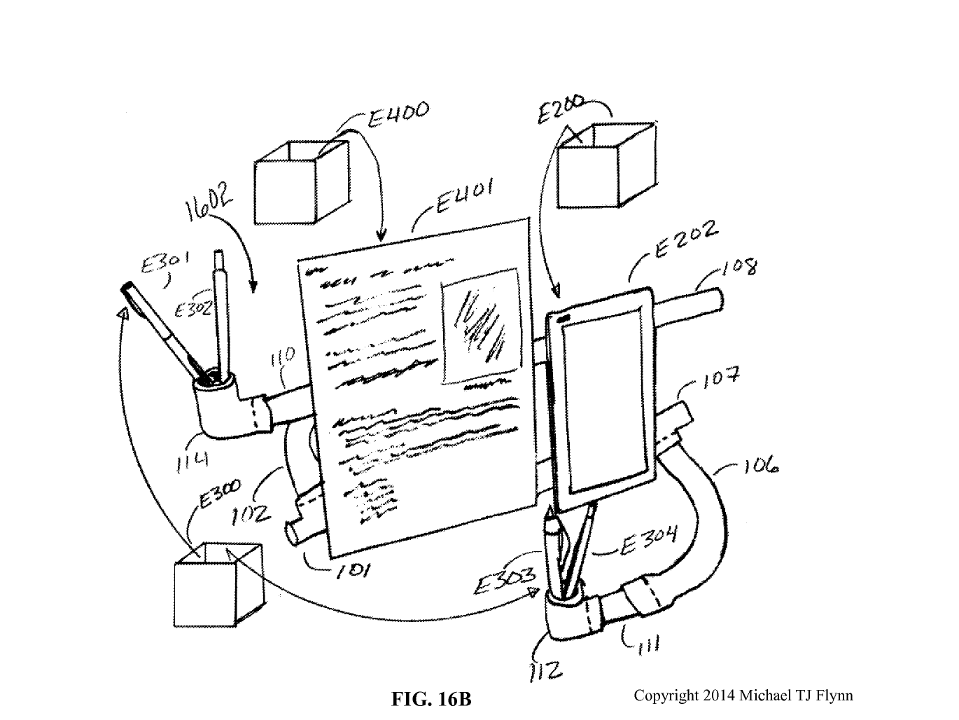

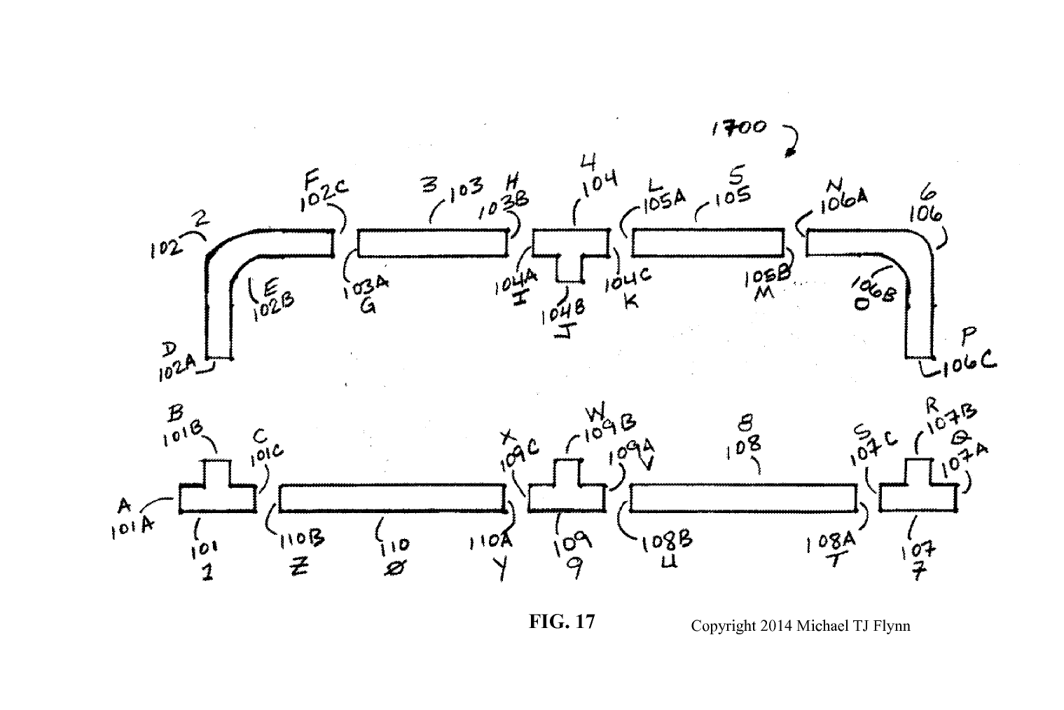

The present invention relates to a multi-purpose apparatus embodiments and methods for use thereof. The system and method embodiments for the instant invention are described with regard, at least, and, in part, to the following thirty (30) figures: FIG. 1, FIG. 2, FIG. 3, FIG. 4, FIG. 5, FIG. 6, FIG. 6A, FIG. 6B, FIG. 7, FIG. 8, FIG. 9, FIG. 10, FIG. 10A, FIG. 10B, FIG. 11, FIG. 11A, FIG. 11B, FIG. 12, FIG. 13, FIG. 14, FIG. 15, FIG. 15A, FIG. 15B, FIG. 15C, FIG. 15D, FIG. 15E, FIG. 16, FIG. 16A, FIG. 16B, FIG. 17.

The invention relates to a multi-purpose apparatus with a potential use in a variety of human activities. More specifically, the instant invention relates, at least, to activities in the field of physical exercise, and/or assembly/disassembly processes for an apparatus, and/or intellectual activity, and/or amusement. Furthermore, the instant invention allows a user to utilize said apparatus, as a single unit, to cover a multitude of activities; making efficient the quantity of objects otherwise required to perform such activities. A user is not necessarily restricted by environmental setting, e.g. indoor versus outdoor, because the instant invention is portable and lightweight. Further a user is not necessarily restricted by physical setting, e.g. at home versus at work, because the instant invention is a single-unit and easily transportable. Moreover, a user is not necessarily restricted, be geographical location, e.g. travel to a shoreline or to a mountain top because the instant invention is compact and durable. Finally a user is not necessarily financially restricted accessing said apparatus and benefits thereof because the instant invention is readily available and inexpensive apparatus.

These inherent eight, 8, attributes, i.e. portable and lightweight; single-unit and easily transportable; compact and durable; readily available and inexpensive, combined in a multi-purpose apparatus, at least, make the instant invention novel to the world, and particularly unobvious as accompanied by the benefits said instant invention provides to a user as a single source apparatus; augmenting, separately and/or jointly, a user's physical exercise fitness routine, along with a potential for said user's intellectual activity fitness, whereby the overall wellbeing of said user's body-mind health can be jointly pursued.

The multi-purpose apparatus of the instant invention further provides a user a wide spectrum of physical exercise options, ranging from and including stretching and rotating, to and including aerobic and isokinetic, to and including isometric and isotonic disciplines; all within the potential variety of embodiments that avail nearly each embodiment to the cited disciplines; inherent in a single apparatus.

Further the instant invention provides to a user a system and a method to more easily maintain a routine associated with said invention because said invention is capable of being utilized during travel, easily stored and/or carried in a gym-sized carrying device, along other paraphernalia that might, at least accompany such a routine; including but not limited to a book (printed/e-book), a notepad, writing instruments, clothing. The multi-purpose apparatus of the instant invention further provides a user a way to benefit from the instant invention while said user may be positioned in nearly any of a varied of bodily positions during use of the apparatus, e.g. at least standing, walking, seated, supine, or kneeling. This benefit enlarges the potential group of users to include those users who may be physically compromised due to physical status, e.g. a wheelchair bound, or even a bed bound user may benefit from the overall provisions of the instant invention.

Hereinafter, exemplary embodiments for the instant invention shall be described with references to the illustrations within the accompanying drawings.

FIG. 1 is an exploded view illustrating pieces to a multi-purpose apparatus, at least for use in a potentiality of embodiments of the present invention. The multi-purpose apparatus is inherently comprised of a plurality of pieces that are at least useable, and reusable in providing a potentiality of embodiments that may be used in various fields; at least, but not limited to: 1) physical exercise, 2) assembly and/or disassembly process(es), 3) intellectual activities, and/or 4) amusement Inherent to a useable, and a reusable, system and method(s) are uses for each of the potential embodiments based within a single apparatus.

The pieces illustrated and described in FIG. 1 include: a.) a main body as an apparatus, hereinafter named 100, comprised of: b.) a first tee fitting rigid piece, hereinafter named 101, having a first end, hereinafter named 101A, and having a mid-section, hereinafter named 101B, and having a second end, hereinafter named 101C; c.) a first arced rigid piece, hereinafter named 102, having a first end, hereinafter named 102A, having a mid-section maintaining an arc, hereinafter named 102B, and having a second end, hereinafter named 102C; collectively forming an arc wherein said arc includes an angular range of degrees within which approximation to ninety-degree, 90°, and including ninety-degree, 90°, is included, said angular range commencing at the first end at 102A, traversing through the mid-section at 102B and terminating at the second end at 102C; d.) a first relatively straight elongated rigid piece, hereinafter named 103, having a first end, hereinafter named 103A, and having a second end, hereinafter named 103B; e.) a second tee fitting rigid piece, or, alternatively an elongated rigid coupler, hereinafter named 104, having a first end, hereinafter named 104A, and having a mid-section, hereinafter named 104B, and having a second end, hereinafter named 104C; f.) a second relatively straight elongated rigid piece, hereinafter named 105, having a first end, hereinafter named 105A, and having a second end, hereinafter named 105B; g.) a second arced rigid piece, hereinafter named 106, having a first end, hereinafter named 106A, having a mid-section maintaining an arc, hereinafter named 106B, and having a second end, hereinafter named 106C; collectively forming an arc wherein said arc includes an angular range of degrees within which approximation to ninety-degree, 90°, and including ninety-degree, 90°, is included, said angular range commencing at the first end at 106A, traversing through the mid-section at 106B and terminating at the second end at 106C; h.) a third tee fitting rigid piece, hereinafter named 107, having a first end, hereinafter named 107A, and having a mid-section, hereinafter named 107B, and having a second end, hereinafter named 107C; i.) a third relatively straight elongated rigid piece, hereinafter named 108, having a first end, hereinafter named 108A, and having a second end, hereinafter named 108B; j.) a fourth tee fitting rigid piece, hereinafter named 109, having a first end, hereinafter named 109A, and having a mid-section, hereinafter named 109B, and having a second end, hereinafter named 109C; k.) a fourth relatively straight elongated rigid piece, hereinafter named 110, having a first end, hereinafter named 110A and having a second end, hereinafter named 110B; whereat said 110 is proportionally fixed in length, within a range of tolerances, relationally predetermined by a relative overall combined, contiguous, length of the first relatively straight elongated rigid piece 103, with the second tee fitting rigid piece 104, and with the second relatively straight elongated rigid piece 105 respectively, maintaining contiguous functionality thus enabling formation of a variety of embodiments of the apparatus; l.) a fifth relatively straight elongated rigid piece, hereinafter named 111, having a first end, hereinafter named 111A, and having a second end, hereinafter named 111B; m.) a first approximately ninety-degree, 90°, rigid piece, hereinafter named 112, having a first end, hereinafter named 112A, and having a second end, hereinafter named 112B; n.) a sixth relatively straight elongated rigid piece, hereinafter named 113, having a first end, hereinafter named 113A, and having a second end, hereinafter named 113B; o.) a second approximately ninety-degree, 90°, rigid piece, hereinafter named 114, having a first end, hereinafter named 114A, and having a second end, hereinafter named 114B; and p.) said 100 being comprised of the set of pieces so named: 101, and/or 102, and/or 103, and/or 104, and/or 105, and/or 106, and/or 107, and/or 108, and/or 109, and/or 110, and/or 111, and/or 112, and/or 113, and/or 114, whereby the forming of a main body is inherently comprised in a single apparatus, whereby the set of said pieces, individually and/or collectively, are selected by a user, in a process to form a particular embodiment desired by a user.

Predetermindedly, 101, 102C, 104, 106A, 107, 109, 112, and 114 provide a hollow and comprise such hollow with an inside diameter that at least share a range that includes an exact dimension with the outside diameter of 102A, 103, 105, 106C, 108, 110, 111, and 113 respectively. The pieces of 100, at least, individually and/or collectively provide a user to assemble and/or disassemble a given embodiment for use in a multiple of human activities. Optimally, at least, said hollow(s) are positioned in such a manner that contiguity may exist between said pieces.

Predetermindedly, the said pieces within 100 inherently possess, at least, a potentiality for a multitude of embodiments with a practical useable, and/or reusable, methods for human beings. The pieces at least are comprised of rigid materials that are related to fiber, wood, plastic, glass, fiberglass, metal, resins, or materials of similar rigid properties; currently known or yet to be known. Furthermore, the structural shape of the said pieces within 100, at least, can be in the shape of: oval, rectangular, round, square, triangular, or tubular, or similarly rigidly shaped so as to accommodate contiguity between said pieces.

FIG. 2 is a perspective frontal view illustrating an embodiment of a multi-purpose apparatus according to an embodiment of the present invention. A user chooses a set of pieces from 100, as illustrated and described in FIG. 1, to form an embodiment that at least results in a main body as a single apparatus, hereinafter named 200.

As a means to perform a physical exercise in conjunction with an intellectual activity, and/or separately to solely engage said embodiment of 200 as means to perform a physical exercise, and/or separately as a means to solely utilize said embodiment of 200 for use in an intellectual activity, a user employs said user's fingers along with associated bodily tissues and/or organs required for said user to assemble selected pieces from 100, as illustrated and described in FIG. 1, namely 101, 102, 103, 104, 105, 106, 107, 108, 109, 110, 111, 112, 113, and 114 that result in the formation of 200. This process requires a joint effort between said user's intellectual functions to consciously assemble, and/or alternatively to disassemble, said pieces in an orderly fashion and said user's physical body parts to carryout such assembly/disassembly; particularly said user's fingers are employed to accomplish a task with a specific purpose i.e. to form a useable, and/or reusable embodiment 200.

Said user performs the task to assemble 200, optionally, and at least, in the following steps: exerting force upon the pieces in a manner to make contiguous 101B with 102A, and 102C with 103A, and 103B with 104A, and 104C with 105A, and 105B with 106A, and 106C with 107B, and 107C with 108A, and 108B with 109A, and 109C with 110A, and 110B with 101C, and 111A with 104B, and 111B with 112A, and 112B with 113A, and 113B with 114A, whereby said assembly, at least, now exists in an embodiment for storage and/or transportation, and/or physical exercise, and/or uses for intellectual activities, and/or amusement. The assembly process, and/or any subsequent disassembly process, by its very nature, is consistent with an engineered purpose to be in and of itself, an intrinsic physical exercise, and/or intellectual activity as associated to 200.

Having thus embodied said pieces, a user is able to places said user's fingers upon 200, in particularly at 106 as well as simultaneously at 102, or alternatively at any point between 107 through 101 as well as simultaneously at any point between 102 through 106, having made 108, 109, 110, and 103, 104, 105 contiguous, respectively as illustrated and described, or alternatively substitute any point of 111, 112, 113, 114, for any of the previous said pieces, and apply human force upon these said pieces in a static position providing a manner consistent with the performance of isometric exercises. Similarly a user may utilize 200 in such a manner of embodiment that said user is able to place said user's fingers in positions as recited above and further applying human force in a directional movement, allowing said user to perform isotonic exercises. The utility of 200 is decidedly engineered to allow a user to optionally choose a specific position of relationship between said user's fingers proximity to said user's other body parts; effectively allowing a user to perform a wide multitude of exercises, albeit isometric and/or isotonic. This freedom of position of relative body parts with each other provides a user, at least to optionally focus physical exercise(s) upon the individual fingers, singly and/or collectively, the wrists, the forearms, the upper arms, the shoulders, the neck, the back, the torso, and/or the abdomen. Further, if a user places 102 and 106 in between said user's thighs and/or knees and/or calves, or alternatively places said user's feet, and/or ankles within or without said pieces, and applies force upon 200 the user would then benefit from physical exercises involving these bodily parts and associated tissues thereto. Effectively, 200 provides an opportunity for nearly every muscle system within the entire human body. These detailed engagements of a user's body parts upon 200 in the performance of physical exercises are descriptive, but do not exhaust every conceivable potential that may exist for the embodiment 200.

Furthermore, a user may, at least, grasp 106B and 102B separately with each set of said user's fingers and apply force upon 200 in such manner whereby a user brings 200 horizontally towards said user's chest followed by said user pushing 200 away from said user's chest; providing a variation of range within which physical exercise may be performed.

An engineered purpose of 200 allows a user to perform an exercise with 200 by placing 200 at, in front of, above, behind, and/or below said user's abdominal region of said user's body. Alternatively a user may combine any of these relational positions between 200 with said user's body regions; providing a, more and/or less, full range of extension as related to bodily extremities.

The engineering of 200 is calculated to allow a user to perform physical exercises in nearly any bodily position and/or bodily motion; ranging from standing or walking, to and including sitting or supine. Further, 200 is engineered to be minimally invasive to over taxing a user's muscle systems by providing said user a length of time of exercise as determined by said user. Further, the amount of force exerted by a user upon 200 is gauged by said user's own determination; providing said user the flexibility to increase and/or decrease said force as desired by user.

Additionally, a user may utilize 200 as a source of amusement, whereby, said user, having assembled 200 may then, at least choose to cause airflow into 101 and thereby throughout the entire interior borders of 200 while said user simultaneously then places an obstruction, at least partially, over 109 and/or 107 thereby allowing said airflow to exhaust 200 at an outlet 114. This action, according to the skill of the user, may result in the emission of a noise that may, or may not, approach or equal a frequency within a range of a musical tone. This is an exemplary sample for an application for use of 200, and in no way limits other potential types of amusement related to 200.

Additionally, a user may utilize 200 as a source of amusement, whereby, said user, having assembled 200 may then, at least, choose to adjust the position of 111, 112, 113, and 114 as a single set of pieces by a rotation of 103, 104, and 105, specifically where: 102C is joined with 103A and/or 103B is joined with 104A, and/or 104C is joined with 105A, and/or 105B is joined with 106A. Effectively said adjustment would provide 200 as a type of hanger whereby a user is able to mount pieces 114, 113, 112, and 111 upon a surface to support a suspended 200 and subsequently place an object to be placed over the portion of 200 at 108, 109, and/or 110, as supported by 101 and 102, 107 and 106 respectively.

FIG. 3 is a perspective frontal view illustrating an embodiment of a multi-purpose apparatus according to an embodiment of the present invention. A user chooses a set of pieces from 100, as illustrated and described in FIG. 1, to form an embodiment that at least results in a main body as a single apparatus, hereinafter named 300.

As a means to perform a physical exercise in conjunction with an intellectual activity, and/or separately to solely engage said embodiment of 300 as means to perform a physical exercise, and/or separately as a means to solely utilize said embodiment of 300 for use in an intellectual activity, a user employs said user's fingers along with associated bodily tissues and/or organs required for said user to assemble selected pieces from 100, as illustrated and described in FIG. 1, namely 112, 111, 102, 101, 110, 109, 108, 107, 106, 113, and 114 that result in the formation of 300. This process requires a joint effort between said user's intellectual functions to consciously assemble, and/or alternatively to disassemble, said pieces in an orderly fashion and said user's physical body parts to carryout such assembly/disassembly; particularly said user's fingers are employed to accomplish a task with a specific purpose i.e. to form a useable, and/or reusable embodiment 300.

Said user performs the task to assemble 300, optionally, and at least, in the following steps: exerting force upon the pieces in a manner to make contiguous 112A with 111A, and 111B with 102C, and 102A with 101B, and 101A with 110B, and 110A with 109C, and 109A with 108B, and 108A with 107A, and 107B with 106C, and 106A with 113A, and 113B with 114A, thereby forming a single contiguous apparatus, whereat 102 and 106 are within an alignment range that minimally does not include an exact rotational counterbalance alignment to each other, being offset from a perfect counterbalance, whereby said assembly, at least, now exists in an embodiment conducive for physical exercise, named 300.

A user is able to alter the overall dimension of 300 by simply substituting 103, and 104, and 105 in place of 108, and 109, and 110 respectively; continuing to make available 300 for use with physical exercises. This alteration provides a, more and/or less, variation of a range of motion during the performance of exercise. A user is thus able to simultaneously place said user's finger(s) upon 300 in a variety of locations, e.g. at 101A through 107A, and apply force to 300 in a directional manner by utilizing the mass of 300 as a means to initiate, and/or maintain rotation of 300 as a performance of isokinetic exercise. Moreover, 300 provides to a user the ability to increase and/or decrease the rate of revolutions of the directional motion of 300 in the performance of physical exercises. When said user increases, or even maintains, the amount of exertion placed upon 300, it correspondingly affects the user's heart rate, and/or respiration, as a performance of an aerobic exercise.

A user is able to isolate a single finger, or may alternatively select a plurality of fingers from either hand placed upon 300 and cause a movement of 300 in the performance of an exercise. This can be accomplished for the aerobic exercise supra, and/or the isometric, and/or the isotonic exercises infra. A user may thus place said user's fingers upon 106 and upon 102 further applying force upon said pieces in a static position; allowing said user to perform isometric exercises in a variety of relational positions of 300 with said user's body.

A user may also thus place said user's fingers upon 106 and upon 102 further applying force upon these pieces in a single, and/or, multiple directional position(s); allowing said user to perform isotonic exercises in a variety of relational positions of 300 with said user's body.

Furthermore, a user may grasp 106B and 102B separately with each set of said user's fingers and apply force upon 300 in such manner whereby said user brings 300 horizontally towards said user's chest followed by said user pushing 300 away from said user's chest; rotating said user's shoulders, elbows, wrists and associated bodily tissues in a stretching performance of exercise.

An engineered purpose of 300 allows a user to perform an exercise with 300 by placing 300 at, in front of, above, behind, and/or below said user's abdominal region of said user's body. Alternatively a user may combine any of these relational positions between 300 with said user's body regions; providing a, more and/or less, full range of extension as related to bodily extremities.

The engineering of 300 is calculated to allow a user to perform physical exercises in nearly any bodily position and/or bodily motion; ranging from standing or walking, to and including sitting or supine. Further, 300 is engineered to be minimally invasive to over taxing a user's muscle systems by providing said user a length of time of exercise as determined by said user. Further, the amount of force exerted by a user upon 300 is gauged by said user's own determination; providing said user the flexibility to increase and/or decrease said force as desired by said user.

FIG. 4 is a perspective frontal view illustrating an embodiment of a multi-purpose apparatus according to an embodiment of the present invention. A user chooses a set of pieces from 100, as illustrated and described in FIG. 1, to form an embodiment that at least results in a main body as a single apparatus, hereinafter named 400.

As a means to perform a physical exercise in conjunction with an intellectual activity, and/or separately to solely engage said embodiment of 400 as means to perform a physical exercise, and/or separately as a means to solely utilize said embodiment of 400 for use in an intellectual activity, a user employs said user's fingers along with associated bodily tissues and/or organs required for said user to assemble selected pieces from 100, as illustrated and described in FIG. 1, namely 101, 102, 103, 104, 105, 106 and 107 that result in the formation of 400. This process requires a joint effort between said user's intellectual functions to consciously assemble, and/or alternatively to disassemble, said pieces in an orderly fashion and said user's physical body parts to carryout such assembly/disassembly; particularly said user's fingers are employed to accomplish a task with a specific purpose i.e. to form a useable, and/or reusable embodiment 400.

Said user performs the task to assemble 400, optionally, and at least, in the following steps: exerting force upon the pieces in a manner to make contiguous 101B with 102A, and 102C with 103A, and 103B with 104A, and 104C with 105A, and 105B with 106A, and 106C with 107B, thereby forming a single contiguous apparatus, whereat 102 and 106 are within an alignment range that minimally does not include an exact rotational counterbalance alignment to each other, being offset from a perfect counterbalance, whereby 400, at least, now exists in an embodiment for physical exercise.

The overall dimensions of 400 may be altered by substituting 108, and 109, and 110 in place of 103, and 104, and 105 respectively; providing a variation of a range of motion during the performance of exercise. A user is able to grasp 400 in a variety of locations and apply force to 400 in a directional manner by utilizing the mass of 400 as a means to initiate, and/or maintain rotation of 400 as a performance of isokinetic exercise. Moreover, 400 provides to a user the ability to increase and/or decrease the rate of revolutions of the directional motion of 400 in the performance of physical exercises. When said user increases, or even maintains the amount of exertion placed upon 400 correspondingly affects the said user's heart rate, and/or respiration, as a performance of an aerobic exercise.

A user is able to isolate a single finger, or may alternatively select a plurality of fingers from either hand placed upon 400 and cause a movement of 400 in the performance of an exercise. This can be accomplished for the aerobic exercise supra, and/or the isometric, and/or the isotonic exercises infra. A user may thus place said user's fingers upon 106 and upon 102 further applying force upon said pieces in a static position; allowing said user to perform isometric exercises in a variety of relational positions of 400 with said user's body.

A user may also thus place said user's fingers upon 106 and upon 102 further applying force upon these pieces in a single, and/or, multiple directional position(s); allowing said user to perform isotonic exercises in a variety of relational positions of 400 with said user's body.

Additionally, at least alternatively, a user may utilize 400 and grasp 102, or 106, with one and/or both set(s) of said user's fingers and then simultaneously place either foot of said user upon the opposite piece not grasped by said user's fingers making both the hand(s) and a foot of the user to be contiguous with 102 and 106 with a purpose of potential exercise performance; exerting force upon 400 at 102 and 106 respectively, said user may commence motion upon 400 whereby there is a simulation of multiple bodily exercise movements as determined by the user, e.g. a cycling simulation, or a swimming simulation.

Furthermore, a user may grasp 106B and 102B separately with each set of said user's fingers and apply force upon 400 in such manner whereby said user brings 400 horizontally towards said user's chest followed by said user pushing 400 away from said user's chest; rotating said user's shoulders, elbows, wrists and associated bodily tissues in a stretching performance of exercise.

An engineered purpose of 400 allows a user to perform an exercise with 400 by placing 400 at, in front of, above, behind, and/or below said user's abdominal region of said user's body. Alternatively a user may combine any of these relational positions between 400 with said user's body regions; providing a, more and/or less, full range of extension as related to bodily extremities.

The engineering of 400 is calculated to allow a user to perform physical exercises in nearly any bodily position and/or bodily motion; ranging from standing or walking, to and including sitting or supine. Further, 400 is engineered to be minimally invasive to over taxing a user's muscle systems by providing said user a length of time of exercise as determined by said user. Further, the amount of force exerted by a user upon 400 is gauged by said user's own determination; providing said user the flexibility to increase and/or decrease said force as desired by said user.

FIG. 5 is a perspective frontal view illustrating an embodiment of a multi-purpose apparatus according to an embodiment of the present invention. A user chooses a set of pieces from 100, as illustrated and described in FIG. 1, to form an embodiment that at least results in a main body as a single apparatus, hereinafter named 500.

As a means to perform a physical exercise in conjunction with an intellectual activity, and/or separately to solely engage said embodiment of 500 as means to perform a physical exercise, and/or separately as a means to solely utilize said embodiment of 500 for use in an intellectual activity, a user employs said user's fingers along with associated bodily tissues and/or organs required for said user to assemble selected pieces from 100, as illustrated and described in FIG. 1, namely 101, 102, 108, 109, 110, 106 and 107 that result in the formation of 500. This process requires a joint effort between said user's intellectual functions to consciously assemble, and/or alternatively to disassemble, said pieces in an orderly fashion and said user's physical body parts to carryout such assembly/disassembly; particularly said user's fingers are employed to accomplish a task with a specific purpose i.e. to form a useable, and/or reusable embodiment 500.

Said user performs the task to assemble 500, optionally, and at least, in the following steps: exerting force upon the pieces in a manner to make contiguous 101B with 102A, and 102C with 110B, and 110A with 109C, and 109A with 108B, and 108A with 106A, and 106C with 107B, whereby said assembly, at least, now exists in an embodiment, thereby forming a single contiguous apparatus, whereat 102 and 106 are contiguous within an alignment range that minimally includes a rotational counterbalance alignment between 102 and 106, whereby 500, at least, now exists in an embodiment for physical exercise.

The overall dimensions of 500 may be altered by substituting 103, and 104, and 105 in place of 108, and 109, and 110 respectively; providing a variation of a range of motion during the performance of exercise. Moreover, 500 provides to a user the ability to increase and/or decrease the rate of revolutions of the directional motion of 500 in the performance of physical exercises. When said user increases, or even maintains the amount of exertion placed upon 500 correspondingly affects the user's heart rate, and/or respiration, as a performance of an aerobic exercise.

A user is able to isolate a single finger, or may alternatively select a plurality of fingers from either hand placed upon 500 and cause a movement of 500 in the performance of an exercise. This can be accomplished for the isometric, and/or the isotonic exercises infra. A user may thus place said user's fingers upon 106 and upon 102 further applying force upon said pieces in a static position; allowing said user to perform isometric exercises in a variety of relational positions of 500 with said user's body.

A user may also thus place said user's fingers upon 106 and upon 102 further applying force upon these pieces in a single, and/or, multiple directional position(s); allowing said user to perform isotonic exercises in a variety of relational positions of 500 with said user's body.

Additionally, at least alternatively, a user may utilize 500 and grasp 102, or 106, with one and/or both set(s) of said user's fingers and then simultaneously place either foot of said user upon the opposite piece not grasped by said user's fingers making both the hand(s) and a foot of the user to be contiguous with 102 and 106 with a purpose of potential exercise performance; exerting force upon 500 at 102 and 106 respectively, said user may commence motion upon 500 whereby there is a simulation of multiple bodily exercise movements as determined by the user, e.g. a cycling simulation, or a swimming simulation.

Furthermore, a user may grasp 106B and 102B separately with each set of said user's fingers and apply force upon 500 in such manner whereby said user brings 500 horizontally towards said user's chest followed by said user pushing 500 away from said user's chest; rotating said user's shoulders, elbows, wrists and associated bodily tissues in a stretching performance of exercise.

An engineered purpose of 500 allows a user to perform an exercise with 500 by placing 500 at, in front of, above, behind, and/or below said user's abdominal region of said user's body. Alternatively a user may combine any of these relational positions between 500 with said user's body regions; providing a, more and/or less, full range of extension as related to bodily extremities.

The engineering of 500 is calculated to allow a user to perform physical exercises in nearly any bodily position and/or bodily motion; ranging from standing or walking, to and including sitting or supine. Further, 500 is engineered to be minimally invasive to over taxing a user's muscle systems by providing said user a length of time of exercise as determined by said user. Further, the amount of force exerted by a user upon 500 is gauged by said user's own determination; providing said user the flexibility to increase and/or decrease said force as desired by said user.

Additionally, a user may utilize 500 as a source of amusement, whereby, said user, having assembled 500 may then, at least, choose to cause a portion of 500, for example 101 and/or 107 to be used as an extension of said user's hands, at least, in an action that allows said user to make contact with any of a variety of said user's body parts, at least optionally as a means to relieve said user from an irritation of a given body part, e.g. a mid-back irritating skin sensation, more commonly known as an itch, experienced by said user may thereby be relieved by said user grasping 500 and reaching rearward with 500 to make contiguous 500 with said location of said user's itch, thus enabling said user to relieve the user of said itch.

Additionally, a user may utilize 500 as a source of amusement, whereby, said user, having assembled 500 may then, at least, choose to cause a portion of 500, for example 101 and/or 107 to be used as an extension of said user's hands, at least, in an action that allows said user to reach an object that is beyond the normal range of attainability for said user without the assistance of an outside source, such as 500. This benefit enlarges the potential group of said users to include those users who may be physically compromised, e.g. a wheelchair bound, or even a bed bound user may benefit from the overall provisions of the instant invention.

Additionally, a user may utilize 500 as a source of amusement, whereby, said user, having assembled 500 may then, at least, choose to cause 500 to be used in the process for breathing. A user could, at least, place one hand over 109 and grasp 107 with said user's other hand then place said user's mouth around an open hollow in 107 and commence an intake of air by inhaling through 500; having first assured that 101 is free of any obstruction to the flow of air into 500. The action of this use of 500 may be performed by a user when said user is in a restricted airflow environment, e.g. under water, effectively allowing said user to breathe through 500 while swimming, and/or submersed in water. Similarly if a user has a breathing difficulty and/or abnormality, said user may utilize 500 to assist in remedy of said challenge.

These are exemplary samples of applications for use of 500, and in no way limits other potential types of amusement, and/or uses related to 500.

FIG. 6 is a perspective frontal view illustrating an embodiment of a multi-purpose apparatus according to an embodiment of the present invention. A user chooses a set of pieces from 100, as illustrated and described in FIG. 1, to form an embodiment that at least results in a main body as a single apparatus, hereinafter named 600.

As a means to perform a physical exercise in conjunction with an intellectual activity, and/or separately to solely engage said embodiment of 600 as means to perform a physical exercise, and/or separately as a means to solely utilize said embodiment of 600 for use in an intellectual activity, a user employs said user's fingers along with associated bodily tissues and/or organs required for said user to assemble selected pieces from 100, as illustrated and described in FIG. 1, namely 101, 102, 103, 104, 105, 106 and 107 that result in the formation of 600. This process requires a joint effort between said user's intellectual functions to consciously assemble, and/or alternatively to disassemble, said pieces in an orderly fashion and said user's physical body parts to carryout such assembly/disassembly; particularly said user's fingers are employed to accomplish a task with a specific purpose i.e. to form a useable, and/or reusable embodiment 600.

Said user performs the task to assemble 600, optionally, and at least, in the following steps: exerting force upon the pieces in a manner to make contiguous 102A with 101B, and 101C with 103A, and 103B with 104A, and 104C with 105A, and 105B with 107C, and 107B with 106C, whereby said assembly, at least, now exists in an embodiment, thereby forming a single contiguous apparatus, whereat 102 and 106 are capable of being positioned at any point in a three hundred sixty-degree, 360°, range whereby 600, at least, now exists in an embodiment for physical exercise.

The overall dimensions of 600 may be altered by substituting 103, and 104, and 105, with 110, and 109, and 108, respectively; providing a variation of a range of motion during the performance of exercise. A user is able to grasp 600 in a variety of locations and apply force to 600 in a directional manner. Moreover, 600 provides to a user the ability to increase and/or decrease the rate of revolutions of the directional motion of 600 in the performance of physical exercises. When said user increases, or even maintains the amount of exertion placed upon 600 correspondingly affects the user's heart rate, and/or respiration, as a performance of an aerobic exercise.

A user is able to grasp 101, 102, 106 and/or 107 to manipulate the degree of angle between 102 and 106 to a preferred angle by the user in the performance of physical exercise; commencing a directional motion conducive to a multitude of physical exercises to be performed by said user. At least, said user is thus able to rotate said user's body parts, shoulders, arms, forearms, wrists, and hands, and tissues associated thereto, via means of said user's said sets of fingers placed upon 101 or 102, and 107 or 106, moving 600 in a directional motion in the performance of a multitude of physical exercises.

A user is able to isolate a single finger, or may alternatively select a plurality of fingers from both hands placed upon 600 and cause a movement of 600 in the performance of an exercise. This can be accomplished for the aerobic exercise supra, and/or the isometric, and/or the isotonic exercises infra A user may thus place said user's fingers upon 106 and upon 102 further applying force upon said pieces in a static position; allowing said user to perform isometric exercises in a variety of relational positions of 600 with said user's body.

A user may also thus place said user's fingers upon 106 and upon 102 further applying force upon these pieces in a single, and/or, multiple directional position(s); allowing said user to perform isotonic exercises in a variety of relational positions of 600 with said user's body.

Additionally, at least alternatively, a user may utilize 600 and grasp 102, or 106, with one and/or both set(s) of said user's fingers and then simultaneously place either foot of said user upon the opposite piece not grasped by said user's fingers making both the hand(s) and a foot of the user to be contiguous with 102 and 106 with a purpose of potential exercise performance; exerting force upon 600 at 102 and 106 respectively, said user may commence motion upon 600 whereby there is a simulation of multiple bodily exercise movements as determined by the user, e.g. a cycling simulation, or a swimming simulation.

Additionally, at least alternatively, a user may utilize 600 and grasp 102 with one hand and simultaneously grasp 106 with said user's second hand to cause a directional movement upon 600 either by causing 102, and/or 106 to move in a rotational motion, a circular type manner, allowing either 102 to rotate around a stationary position of 106, or visa versa, or alternatively, allowing 102 and 106 to jointly rotate around each other within any given three-hundred-sixty degree, 360°, angle as determined by said user. In this manner 600 provides said user an ability to exert force upon 600 thus being contiguous to said user's body parts, whereby said user may commence motion upon 600, at least, as a simulation of multiple bodily exercise as determined by said user, e.g. boxing simulation.

Furthermore, a user may grasp 106B and 102B separately with each set of said user's fingers and apply force upon 600 in such manner whereby said user brings 600 horizontally towards said user's chest followed by said user pushing 600 away from said user's chest; rotating said user's shoulders, elbows, wrists and associated bodily tissues in a stretching performance of exercise.

An engineered purpose of 600 allows a user to perform an exercise with 600 by placing 600 at, in front of, above, behind, and/or below said user's abdominal region of said user's body. Alternatively a user may combine any of these relational positions between 600 with said user's body regions; providing a, more and/or less, full range of extension as related to bodily extremities.

The engineering of 600 is calculated to allow a user to perform physical exercises in nearly any bodily position and/or bodily motion; ranging from standing or walking, to and including sitting or supine. Further, 600 is engineered to be minimally invasive to over taxing a user's muscle systems by providing said user a length of time of exercise as determined by said user. Further, the amount of force exerted by a user upon 600 is gauged by said user's own determination; providing said user the flexibility to increase and/or decrease said force as desired by said user.

FIG. 6A is a perspective frontal view illustrating an embodiment of a multi-purpose apparatus according to an embodiment of the present invention. A user chooses a set of pieces from 100, as illustrated and described in FIG. 1, to form an embodiment 600 as illustrated and described in FIG. 6. A user then causes a manipulation upon 600, thus altering the embodiment 600 that, at least, results in a main body as a single apparatus, hereinafter named 601.

As described in FIG. 6, as illustrated and described in 600, the embodiment of 600 has an inherent structure and/or method, whereby it is provided to a user the ability to grasp 101, 102, 106 and/or 107 to manipulate the degree of angle between 102 and 106 to a preferred angle by the user in the performance of physical exercise.

The manipulation of 600, by said user, is in itself a form of a physical exercise that occurs when a user grasps 600 either at 101 and/or 102, and simultaneously said user grasps 600 either at 107 and/or 106, then altering the dimension between 102C with 104A, and/or, 106A with 104C by a directional movement of 101, 102, 106 and/or 107.

FIG. 6B is a perspective frontal view illustrating an embodiment of a multi-purpose apparatus according to an embodiment of the present invention. In the stages of existence and manipulation of 600, as illustrated and described in FIG. 1, and FIG. 6, and FIG. 6A, respectively, a user is able to cause such a manipulation upon 600 whereby, the dimension between 102C with 104A, and/or, 106A with 104C, is so narrowed, by a directional movement of 101, 102, 106 and/or 107, so as to nearly have 102 and 106 in the same plane to each other, thus altering the embodiment 600 and/or 601 that, at least, results in a main body as a single apparatus, hereinafter named 602.

Effectively, this narrowed dimension between 102C with 104A, and/or, 106A with 104C, as illustrated and described by 602 results potentially, in a smaller diameter of circular motion, measured at the tips of 102C and 106A, capable of being produced during the potential exercises as expressed in FIG. 6.

Under a controlled rate of a measurable displacement of the tips of 102C and 106A, during a directional movement performed by a user, e.g. in a circular-rotational motion, is exerted upon 600, as illustrated and described in FIG. 6, or alternatively exerted upon 601, as illustrated and described in FIG. 6A, is then compared to an equally controlled rate of a measurable displacement of the said tips, when the same motion is exerted upon 602, there results a variation of speed in said displacement of the tips. This variation of speed potential is effectively engineered into 600 with the potential, at least, to allow formation of 601, and/or 602, to vary the rapidity of movement with which a user performs exercises thereupon. Under the simulation of boxing, as described in FIG. 6, this said engineered potential of variation of speed, based upon manipulation of the embodiment of the apparatus, at least, more properly reflects an actual simulation to a boxer's routine of an exercise.

FIG. 7 is a perspective frontal view illustrating an embodiment of a multi-purpose apparatus according to an embodiment of the present invention. A user chooses a set of pieces from 100, as illustrated and described in FIG. 1, to form an embodiment that at least results in a main body as a single apparatus, hereinafter named 700.

As a means to perform a physical exercise in conjunction with an intellectual activity, and/or separately to solely engage said embodiment of 700 as means to perform a physical exercise, and/or separately as a means to solely utilize said embodiment of 700 for use in an intellectual activity, a user employs said user's fingers along with associated bodily tissues and/or organs required for said user to assemble selected pieces from 100, as illustrated and described in FIG. 1, namely 101, 102, 111, 113, 107, and 106 that result in the formation of 700. This process requires a joint effort between said user's intellectual functions to consciously assemble, and/or alternatively to disassemble, said pieces in an orderly fashion and said user's physical body parts to carryout such assembly/disassembly; particularly said user's fingers are employed to accomplish a task with a specific purpose i.e. to form a useable, and/or reusable embodiment 700.

Said user performs the task to assemble 700, optionally, and at least, in the following steps: exerting force upon the pieces in a manner to make contiguous 101B with 102A, and 102C with 111A, and 111B with 107C, and 107B with 106C, and 106A with 113B, and 113A with 101C, whereby said assembly, at least, now exists in an embodiment, thereby forming a single contiguous apparatus, whereat 102 and 106 are part of a contiguously enclosed rigid formation, whereby 700, at least, now exists in an embodiment for physical exercise.

A user is able to isolate a single finger, or may alternatively select a plurality of fingers from either hand placed upon 700 and cause a movement of 700 in the performance of an exercise. This can be accomplished for the isometric, and/or the isotonic exercises infra. A user may thus place said user's fingers upon 106 and upon 102 further applying force upon said pieces in a static position; allowing said user to perform isometric exercises in a variety of relational positions of 700 with said user's body.

A user may also thus place said user's fingers upon 106 and upon 102 further applying force upon these pieces in a single, and/or, multiple directional position(s); allowing said user to perform isotonic exercises in a variety of relational positions of 700 with said user's body.

Furthermore, a user may grasp 106B and 102B separately with each set of said user's fingers and apply force upon 700 in such manner whereby said user brings 700 horizontally towards said user's chest followed by said user pushing 700 away from said user's chest; rotating said user's shoulders, elbows, wrists and associated bodily tissues in a stretching performance of exercise.

An engineered purpose of 700 allows a user to perform an exercise with 700 by placing 700 at, in front of, above, behind, and/or below said user's abdominal region of said user's body. Alternatively a user may combine any of these relational positions between 700 with said user's body regions; providing a, more and/or less, full range of extension as related to bodily extremities.

The engineering of 700 is calculated to allow a user to perform physical exercises in nearly any bodily position and/or bodily motion; ranging from standing or walking, to and including sitting or supine. Further, 700 is engineered to be minimally invasive to over taxing a user's muscle systems by providing said user a length of time of exercise as determined by said user. Further, the amount of force exerted by a user upon 700 is gauged by said user's own determination; providing said user the flexibility to increase and/or decrease said force as desired by said user.

FIG. 8 is a perspective frontal view illustrating an embodiment of a multi-purpose apparatus according to an embodiment of the present invention. A user chooses a set of pieces from 100, as illustrated and described in FIG. 1, to form an embodiment that at least results in a main body as a single apparatus, hereinafter named 800.

As a means to perform a physical exercise in conjunction with an intellectual activity, and/or separately to solely engage said embodiment of 800 as means to perform a physical exercise, and/or separately as a means to solely utilize said embodiment of 800 for use in an intellectual activity, a user employs said user's fingers along with associated bodily tissues and/or organs required for said user to assemble selected pieces from 100, as illustrated and described in FIG. 1, namely 101, 102, 111, 113, 107, and 106, as illustrated and described in FIG. 7, embodiment known as 700; further adding pieces from 100, specifically, 108, 109, 110, 112, 103, 104, 105 and 114 that results in the formation of 800. This process requires a joint effort between said user's intellectual functions to consciously assemble, and/or alternatively to disassemble, said pieces in an orderly fashion and said user's physical body parts to carryout such assembly/disassembly; particularly said user's fingers are employed to accomplish a task with a specific purpose i.e. to form a useable, and/or reusable embodiment 800.

Said user performs the task to assemble 800, optionally, and at least, in the following steps: exerting force upon the pieces in a manner to make contiguous 101B with 102A, and 102C with 111A, and 111B with 107C, and 107B with 106C, and 106A with 113B, and 113A with 101C, whereby said assembly, at least, now exists in an embodiment, thereby forming a single contiguous apparatus, whereat 102 and 106 are part of a contiguous rigid formation, subsequently, the user exerts force and makes contiguous: 101A with 108A, and 108B with 109A, and 109B with 110A, and 110B with 112A, and 112B with 103A, and 103B with 104A, and 104C with 105A, and 105B with 114A, whereby 800, at least, now exists in an embodiment for physical exercise.

Additionally, at least alternatively, a user may utilize 800 and grasp 112, 103, 104, 105 and/or 114 with said user's fingers and simultaneously place either foot of said user upon 102, or 106 with a purpose of potential exercise performance; exerting force upon 800 as recited. Said user may commence motion upon 800 whereby there is a simulation of multiple bodily exercise movements as determined by the user, e.g. a cycling simulation, or a swimming simulation.

A user may place fingers upon 106, and simultaneously place a different finger(s), upon 102, or alternatively said user's fingers upon 101, and 107, and apply force upon 106 and 102, placing 800 in a static position that allows said user to perform isometric exercises. Additionally, at least a user may utilize 800 by placing said user's finger(s) 106, and simultaneously different finger(s) upon 102, or alternatively, said user's fingers upon 101, and upon 107, further applying force to 106 and 102, or upon 101 and 107, respectively, thus commencing movement upon 800 in a directional manner that allows said user to perform isotonic exercises.

A user may also utilize 800 and place a user's foot upon or within either 102, and/or 106, and simultaneously placing said user's fingers at any point upon and/or around contiguous pieces: 108, 109, 110, 112, 103, 104, 105, 114, effectively grasping contiguous pieces said user is able to perform physical exercises engaging bodily systems from said user's foot up through and including said user's fingers in a rotational, and/or aerobic, and/or isometric, and/or isotonic manner. This would, at least, include a user being able to exert force upon 800 thus contiguous to the described said user's body parts, commencing motion upon 800 whereby said user may cause a stretching of said user's muscles and/or associated bodily tissues.

The engineering of 800 is calculated to allow a user to perform physical exercises in nearly any bodily position and/or bodily motion; ranging from standing or walking, to and including sitting or supine. Further, 800 is engineered to be minimally invasive to over taxing a user's muscle systems by providing said user a length of time of exercise as determined by said user. Further, the amount of force exerted by a user upon 800 is gauged by said user's own determination; providing said user the flexibility to increase and/or decrease said force as desired by said user.

FIG. 9 is a perspective frontal view illustrating an embodiment of a multi-purpose apparatus according to an embodiment of the present invention. A user chooses a set of pieces from 100, as illustrated and described in FIG. 1, to form an embodiment that at least results in a main body as a single apparatus, hereinafter named 900.

As a means to perform a physical exercise in conjunction with an intellectual activity, and/or separately to solely engage said embodiment of 900 as means to perform a physical exercise, and/or separately as a means to solely utilize said embodiment of 900 for use in an intellectual activity, a user employs said user's fingers along with associated bodily tissues and/or organs required for said user to assemble selected pieces from 100, as illustrated and described in FIG. 1, namely 101, 102, 111, 106, 107, 105, 104, and 103, that result in the formation of 900. This process requires a joint effort between said user's intellectual functions to consciously assemble, and/or alternatively to disassemble, said pieces in an orderly fashion and said user's physical body parts to carryout such assembly/disassembly; particularly said user's fingers are employed to accomplish a task with a specific purpose i.e. to form a useable, and/or reusable embodiment 900.

Said user performs the task to assemble 900, optionally, and at least, in the following steps: exerting force upon the pieces in a manner to make contiguous 101B with 102A, and 102C with 111A, and 111B with 106A, and 106C with 107B, and 107C with 105B, and 105A with 104C, and 104A with 103B, and 103A with 101C, whereby said assembly, at least, now exists in an embodiment, thereby forming a single contiguous apparatus, whereby 900, at least, now exists in an embodiment for physical exercise.

A user may utilize 900 by placing said user's fingers(s) upon 106, and 102 simultaneously applying force to 106 and 102 in a static position, or alternatively placing said user's finger(s) at any point between 107 through 101, thus including 103, 104, and 105, and simultaneously placing different said user's fingers upon 106, and/or 111, and/or 102, further applying human force in a static position, allowing said user to perform isometric exercises.

A user may utilize 900 by placing said user's fingers(s) upon 106, and 102 simultaneously applying force to 106 and 102 in a directional movement, or alternatively placing said user's finger(s) at any point between 107 through 101, thus including 103, 104, and 105, and simultaneously placing different said user's fingers upon 106, and/or 111, and/or 102, further applying human force in a directional movement, allowing said user to perform isotonic exercises.

The utility of 900 is engineered to allow a user to optionally choose a specific position of relationship between said user's fingers proximity to said user's other body parts; effectively allowing a user to perform a wide multitude of exercises, albeit isometric and/or isotonic. This freedom of position of relative body parts with each other provides a user, at least to optionally focus physical exercise(s) upon the individual fingers, singly and/or collectively, the wrists, the forearms, the upper arms, the shoulders, the neck, the back, the torso, and/or the abdomen. Further, if a user places 102 and 106 in between said user's thighs and/or knees and/or calves, or alternatively places said user's feet, and/or ankles within or without said pieces, and applies force upon 900 the user would then benefit from physical exercises involving these bodily parts and associated tissues thereto. Effectively, 900 provides an opportunity for nearly every muscle system within the entire human body. These detailed engagements of a user's body parts upon 900 in the performance of physical exercises are descriptive, but do not exhaust every conceivable potential that may exist for the embodiment 900.

An engineered purpose of 900 allows a user to perform an exercise with 900 by placing 900 at, in front of, above, behind, and/or below said user's abdominal region of said user's body. Alternatively a user may combine any of these relational positions between 900 with said user's body regions; providing a, more and/or less, full range of extension as related to bodily extremities.

The engineering of 900 is calculated to allow a user to perform physical exercises in nearly any bodily position and/or bodily motion; ranging from standing or walking, to and including sitting or supine. Further, 900 is engineered to be minimally invasive to over taxing a user's muscle systems by providing said user a length of time of exercise as determined by said user. Further, the amount of force exerted by a user upon 900 is gauged by said user's own determination; providing said user the flexibility to increase and/or decrease said force as desired by said user.

FIG. 10 is a perspective frontal view illustrating an embodiment of a multi-purpose apparatus according to an embodiment of the present invention. A user chooses a set of pieces from 100, as illustrated and described in FIG. 1, to form an embodiment that at least results in a main body as a single apparatus, hereinafter named 1000.

As a means to perform a method of assembly and/or disassembly process, at least of an apparatus, a user may select and make a plurality of pieces contiguous by applying a force to a first piece upon a second piece, e.g. 108 with 109 with 110 with 101 with 102 with 103 with 104 with 105 with 106 with 107, as illustrated and described by 1000 in FIG. 10, by applying said first force in one direction on the first piece with the second piece, followed by simultaneously applying a second force in another direction upon either the first, and/or the second piece; continuing such process with each successive piece until formation of an embodiment exists, e.g. 1000. The combination of, at least, the dual action of at least two forces exerted upon said piece in varying directions, whereby a straight withdrawal force, to separate two contiguous pieces, placed upon any of the two contiguous pieces becomes virtually impossible, at least under normal conditions; thus creating a locking-process between said pieces.

FIG. 10A is a perspective frontal view illustrating an embodiment of a multi-purpose apparatus, further assembled as illustrated and described in FIG. 10, according to an embodiment of the present invention. A user chooses a set of pieces from 100, as illustrated and described in FIG. 1, to form an embodiment that at least results in a main body as a single apparatus, hereinafter named 1001.

Providing as a means for enablement of the present invention, 1001, which is a duplicate of 1000 as illustrated and described in FIG. 10, here in 1001, a user performs the task to assemble 1001, optionally, and at least, in the following steps: making contiguous 108B with 109A, and 109C with 110A, and 110B with 101C, and 101B with 102A, and 102C with 103A, and 103B with 104A, and 104C with 105A, and 105B with 106A, and 106C with 107B, and thus making 107C, at least proximately attachable to 108A, whereby said assembly, at least, now exists in an embodiment, thereby forming a single contiguous apparatus, further capable of adjustment by a user, so as to be a single, contiguous, rigid embodiment between all pieces of the embodiment.

After making said pieces contiguous as described, the user, at least, can then additionally make an angular adjustment at 110B with 101C so that 108, 109, 110, and 101 are located within a plane that at least includes an exact plane with 102, 103, 104, 105, 106, and 107.

However because the arc of 102, having commenced at 102A and terminated at 102C, and/or because the arc of 106, having commenced at 106C and terminated at 106A, may include degrees known to not be exactly ninety-degrees, 90°, there may exist, within at least an exact plane of 107C with 108A, a potential misalignment of an exact centerline common to 107 and 108. Such a potential misalignment may be measured within 1001 as illustrated and described by the differential distance between B and A; B being a distance-measurement located at a first end of 1001 located near or at the outer side of 102, and A being a distance-measurement located at a second end of 1001 located near or at the outer side of 106; whereby such distance-measurements are comprised of a first axial centerline through 101, 110, 109, and 108, and a second axial centerline through 102C, 103, 104, 105, and 106A. A measureable difference in distance can result whereat A measures less than B. This variance of measureable distance, at least potentially creates a near impossible union of 108A with 107C. Lacking such union renders 1001, and thus also 1000, incapable of its complete and ultimate embodiment structure and methods thereof.

FIG. 10B is a perspective frontal view illustrating an embodiment of a multi-purpose apparatus, further assembled as illustrated and described in FIG. 10, and further assembled as illustrated and described in FIG. 10A, according to an embodiment of the present invention. A user chooses a set of pieces from 100, as illustrated and described in FIG. 1, to form an embodiment that at least results in a main body as a single apparatus, hereinafter named 1002.

Providing as a means for enablement of the present invention, 1002, which is a duplicate of 1000, and also a duplicate of 1002, as illustrated and described in FIG. 10, and also as illustrated and described in FIG. 10A respectively, here in 1002, a user performs the task to resolve the near impossible union of 108A with 107C by applying force upon either 108A and/or 107C whereby an inherent binding effect is imposed upon 107 with 108 so that 108A and 107C are made contiguous.

The result of application of said force is measureable in the same manner as B and also A were measured as described and illustrated and described in FIG. 10A. The result of such post contiguous union between 107 with 108 via making contiguous 108A with 107C is a result whereby B remains the same measurement as B was in FIG. 10A, hereinafter named B1, and where by a new distance-measurement for A, as described and illustrated and described in FIG. 10A, is superseded by a new distance-measurement hereinafter named B2.

Effectively having thus completed the formation of 1002, there now exists at least two axial centerlines within 1002; a first centerline located between 102 with 103 with 104 with 105 with 106, and a second centerline located between 101 with 110 with 109 with 108 with 107. The said two centerlines are within a range of distances that at least include a parallel distance between each other; allowing a user to utilize said embodiment of an apparatus in a manner more fully consistent with the purpose of the apparatus.

Elsewhere, FIG. 10B is a perspective frontal view illustrating an embodiment of a multi-purpose apparatus, further assembled as illustrated and described in FIG. 10, and further assembled as illustrated and described in FIG. 10A, according to an embodiment of the present invention. Here at FIG. 10B may, at least, be a commencing point in a disassembly process of an apparatus that results in an unlocking-process, whereby a user may, at least, make said pieces comprised in 1002, and/or 1001, and/or 1000, as described and illustrated in FIG. 10, FIG. 10A and FIG. 10B, respectively, incontiguous, and thus, at least, allowing said pieces potentially to be reusable in other embodiments. The user may cause a force upon at least two contiguous pieces that may, at least, be contiguous via a binding contiguous union of axial centerlines inherent in said pieces.

A user may select and make a plurality of pieces incontiguous by applying a force to a first piece to cause separation with a second piece, e.g. 108 from 109 from 110 from 101 from 102 from 103 from 104 from 105 from 106 from 107, at least, by applying said first force in one direction on the first piece with the second piece, followed by simultaneously applying a second force in another direction upon either the first, and/or the second piece; continuing such process with each successive piece until formation of an embodiment is disassembled. The combination of, at least, the dual action of at least two forces exerted upon said piece in varying directions, make possible a straight withdrawal force to separate two contiguous pieces; creating an unlocking-process between said pieces. The user may, optionally, reuse said pieces in another embodiment.

FIG. 11 is a perspective frontal view illustrating an embodiment of a multi-purpose apparatus according to an embodiment of the present invention. A user chooses a set of pieces from 100, as illustrated and described in FIG. 1, to form an embodiment that at least results in a main body as a single apparatus, hereinafter named 1100.

As a means to perform a physical exercise in conjunction with an intellectual activity, and/or separately to solely engage said embodiment of 1100 as means to perform a physical exercise, and/or separately as a means to solely utilize said embodiment of 1100 for use in an intellectual activity, a user employs said user's fingers along with associated bodily tissues and/or organs required for said user to assemble selected pieces from 100, as illustrated and described in FIG. 1, namely 106, 107, 108, 109, 111, 112, 110, 101, 102, 103, 104, 105, 113, and 114 that result in the formation of 1100. This process requires a joint effort between said user's intellectual functions to consciously assemble, and/or alternatively to disassemble, said pieces in an orderly fashion and said user's physical body parts to carryout such assembly/disassembly; particularly said user's fingers are employed to accomplish a task with a specific purpose i.e. to form a useable, and/or reusable embodiment 1100.

A user performs the task to assemble 1100, optionally, and at least, in the following steps: exerting force upon the pieces in a manner to make contiguous 106C with 107B, and 107C with 108A, and 108B with 109A, and 109B with 111A, and 111B with 112A, and 109C with 110A, and 110B with 101C, and 101B with 102A, and 102C with 103A, and 103B with 104A, and 104C with 105A, and 104B with 113A, and 113B with 114A, whereby 1100, at least, now exists in an embodiment for use of an intellectual activity, and/or in the support of intellectual activities.

A user is able, at least, to physically place, and/or physically support an object(s), foreign to 1100, e.g. at least, an object that contains a means that may engage intellectual activity, such as a book, a writing paraphernalia, upon and/or within the structure of 1100, at least, potentially for use by employment of said user's intellectual activities related to such an object(s). These foreign objects include, at least of the group of objects having a means, currently known, or yet to be known, item(s) used in a particular activity, e.g. intellectual activity: viewing printed matter, and/or an electronic object, and/or making a mark with an instrument upon a surface, such group herein illustrated and described and named M100.

Foreign objects found within M100 may be comprised of categories of objects among which includes, but is not limited to E100 comprised in part of printed matter, and/or E200 comprised in part of electronic devices, and/or E300 comprised in part of objects that are capable of making a mark upon a surface, and/or E400 portable surfaces upon which a mark is capable of being made.

A user is further able to makes directional movement(s) upon 106, 107, 108, 109, 111, 112, 110, 101, 102, 103, 104, 105, 113, and/or 114 in an angular relation to each other thus, at least having conjoined pieces capable of a range of rotation of degrees as adjustment to accommodate a foreign object(s) contained in M100.

FIG. 11A is a perspective frontal view, with a foreign object E101, obtained from E100, obtained from M100, illustrated and described as M100 in FIG. 11, illustrating an embodiment of a multi-purpose apparatus according to an embodiment of the present invention. A user chooses a set of pieces from 100, as illustrated and described in FIG. 1, to form an embodiment that at least results in a main body as a single apparatus, hereinafter named 1101.

Providing as a means for enablement of the present invention, 1101, which is a duplicate of 1100 as illustrated and described in FIG. 11, here in 1101, whereby, at least, as an example of a sample of the means of M100, there exist multiple categories of foreign object(s) among which E100 exists, being comprised, in part, at least, of objects that include, but are not limited to, printed materials, such as, a printed book. Within E100 is found a foreign object hereinafter named E101. Although E101 is illustrated and described in the position of both covers being closed, as an imagery purpose, 1100, and thus 1101 allow a user to place E101 upon and/or within the borders of 1100, so that said user may thereat commence engagement of said user's intellectual activity in response to the matter based within E101 and as supported, as illustrated and described in 1101.

FIG. 11B is a perspective rearward view, with a foreign object E101, obtained from E100, obtained from M100, illustrated and described as M100 in FIG. 11, illustrating an embodiment of a multi-purpose apparatus according to an embodiment of the present invention. A user chooses a set of pieces from 100, as illustrated and described in FIG. 1, to form an embodiment that at least results in a main body as a single apparatus, hereinafter named 1102.

Fundamentally, 1102 is a duplicate of 1100 as illustrated and described in FIG. 11, and is a duplicate of 1101 as illustrated and described in FIG. 11A, however, viewed from a reverse position as viewing 1101, additionally, however, illustrating whereby the cover of E101 has been opened, and thus illustrating 1100 supporting E101 in a manner whereby said user may thereat commence engagement of said user's intellectual activity in response to the matter based within E101.

FIG. 12 is a perspective frontal view illustrating an embodiment of a multi-purpose apparatus according to an embodiment of the present invention. A user chooses a set of pieces from 100, as illustrated and described in FIG. 1, to form an embodiment that at least results in a main body as a single apparatus, hereinafter named 1200.

As a means to perform a physical exercise in conjunction with an intellectual activity, and/or separately to solely engage said embodiment of 1200 as means to perform a physical exercise, and/or separately as a means to solely utilize said embodiment of 1200 for use in an intellectual activity, a user employs said user's fingers along with associated bodily tissues and/or organs required for said user to assemble selected pieces from 100, as illustrated and described in FIG. 1, namely 106, 107, 108, 109, 111, 112, 110, 101, 102, 113, 114, 103, 104, and 105 that result in the formation of 1200. This process requires a joint effort between said user's intellectual functions to consciously assemble, and/or alternatively to disassemble, said pieces in an orderly fashion and said user's physical body parts to carryout such assembly/disassembly; particularly said user's fingers are employed to accomplish a task with a specific purpose i.e. to form a useable, and/or reusable embodiment 1200.

A user performs the task to assemble 1200, optionally, and at least, in the following steps: exerting force upon the pieces in a manner to make contiguous 106C with 107B, and 107C with 108A, and 108B with 109A, and 109B with 111A, and 111B with 112A, and 109C with 110A, and 110B with 101C, and 101B with 102A, and 102C with 113A, and 113B with 114A, and 114B with 103A, and 103B with 104A, and 104C with 105A, whereby 1200, at least, now exists in an embodiment for use of an intellectual activity, and/or in the support of intellectual activities.

A user is able, at least, to physically place, and/or physically support an object(s), foreign to 1200, e.g. at least, an object that contains a means that may engage intellectual activity, such as a book, a writing paraphernalia, upon and/or within the structure of 1200, at least, potentially for use by employment of said user's intellectual activities related to such an object(s). These foreign objects include, at least of the group of objects having a means, currently known, or yet to be known, item(s) used in a particular activity, e.g. intellectual activity: viewing printed matter, and/or an electronic object, and/or making a mark with an instrument upon a surface, such group herein illustrated and described and named M100.

Foreign objects found within M100 may be comprised of categories of objects among which includes, but is not limited to E100 comprised in part of printed matter, and/or E200 comprised in part of electronic devices, and/or E300 comprised in part of objects that are capable of making a mark upon a surface, and/or E400 portable surfaces upon which a mark is capable of being made.

A user is further able to makes directional movement(s) upon 106, 107, 108, 109, 111, 112, 110, 101, 102, 113, 114, 103, 104, and/or 105 in an angular relation to each other thus, at least having conjoined pieces capable of a range of rotation of degrees as adjustment to accommodate a foreign object(s) contained in M100.

FIG. 13 is a perspective frontal view illustrating an embodiment of a multi-purpose apparatus according to an embodiment of the present invention. A user chooses a set of pieces from 100, as illustrated and described in FIG. 1, to form an embodiment that at least results in a main body as a single apparatus, hereinafter named 1300.

As a means to perform a physical exercise in conjunction with an intellectual activity, and/or separately to solely engage said embodiment of 1300 as means to perform a physical exercise, and/or separately as a means to solely utilize said embodiment of 1300 for use in an intellectual activity, a user employs said user's fingers along with associated bodily tissues and/or organs required for said user to assemble selected pieces from 100, as illustrated and described in FIG. 1, namely 106, 107, 108, 109, 110, 101, 102, 111, 112, 113, 103, 104, and 105 that result in the formation of 1300. This process requires a joint effort between said user's intellectual functions to consciously assemble, and/or alternatively to disassemble, said pieces in an orderly fashion and said user's physical body parts to carryout such assembly/disassembly; particularly said user's fingers are employed to accomplish a task with a specific purpose i.e. to form a useable, and/or reusable embodiment 1300.

A user performs the task to assemble 1300, optionally, and at least, in the following steps: exerting force upon the following pieces in a manner to make contiguous: 106C with 107B, and 107C with 108A, and 108B with 109A, and 109C with 110A, and 110B with 101C, and 101B with 102A, and 102C with 111A, and 111B with 112A, and 112B with 113A, and 113B with 104B, and 104C with 105A, and 104A with 103B, whereby 1300, at least, now exists in an embodiment for use of an intellectual activity, and/or in the support of intellectual activities.

A user is able, at least, to physically place, and/or physically support an object(s), foreign to 1300, e.g. at least, an object that contains a means that may engage intellectual activity, such as a book, a writing paraphernalia, upon and/or within the structure of 1300, at least, potentially for use by employment of said user's intellectual activities related to such an object(s). These foreign objects include, at least of the group of objects having a means, currently known, or yet to be known, item(s) used in a particular activity, e.g. intellectual activity: viewing printed matter, and/or an electronic object, and/or making a mark with an instrument upon a surface, such group herein illustrated and described and named M100.

Foreign objects found within M100 may be comprised of categories of objects among which includes, but is not limited to E100 comprised in part of printed matter, and/or E200 comprised in part of electronic devices, and/or E300 comprised in part of objects that are capable of making a mark upon a surface, and/or E400 portable surfaces upon which a mark is capable of being made.

A user is further able to makes directional movement(s) upon 106, 107, 108, 109, 110, 101, 102, 111, 112, 113, 103, 104, and/or 105 in an angular relation to each other thus, at least having conjoined pieces capable of a range of rotation of degrees as adjustment to accommodate a foreign object(s) contained in M100.

FIG. 14 is a perspective frontal view illustrating an embodiment of a multi-purpose apparatus according to an embodiment of the present invention. A user chooses a set of pieces from 100, as illustrated and described in FIG. 1, to form an embodiment that at least results in a main body as a single apparatus, hereinafter named 1400.

As a means to perform a physical exercise in conjunction with an intellectual activity, and/or separately to solely engage said embodiment of 1400 as means to perform a physical exercise, and/or separately as a means to solely utilize said embodiment of 1400 for use in an intellectual activity, a user employs said user's fingers along with associated bodily tissues and/or organs required for said user to assemble selected pieces from 100, as illustrated and described in FIG. 1, namely 106, 107, 105, 104, 103, 112, 111, 109, 110, 108, 101, 102, 113, and 114 that result in the formation of 1400. This process requires a joint effort between said user's intellectual functions to consciously assemble, and/or alternatively to disassemble, said pieces in an orderly fashion and said user's physical body parts to carryout such assembly/disassembly; particularly said user's fingers are employed to accomplish a task with a specific purpose i.e. to form a useable, and/or reusable embodiment 1400.

A user performs the task to assemble 1400, optionally, and at least, in the following steps: exerting force upon the pieces in a manner to make contiguous: 106C with 107B, and 107C with 105B, and 105A with 104C, and 104A with 103B, and 103A with 112B, and 112A with 111B, and 111A with 109B, and 109C with 110A, and 109A with 108B, and 108A with 101C, and 101B with 102A, and 102C with 113B, and 113A with 114A, whereby 1400, at least, now exists in an embodiment for use of an intellectual activity, and/or in the support of intellectual activities.

A user is able, at least, to physically place, and/or physically support an object(s), foreign to 1400, e.g. at least, an object that contains a means that may engage intellectual activity, such as a book, a writing paraphernalia, upon and/or within the structure of 1400, at least, potentially for use by employment of said user's intellectual activities related to such an object(s). These foreign objects include, at least of the group of objects having a means, currently known, or yet to be known, item(s) used in a particular activity, e.g. intellectual activity: viewing printed matter, and/or an electronic object, and/or making a mark with an instrument upon a surface, such group herein illustrated and described and named M100.

Foreign objects found within M100 may be comprised of categories of objects among which includes, but is not limited to E100 comprised in part of printed matter, and/or E200 comprised in part of electronic devices, and/or E300 comprised in part of objects that are capable of making a mark upon a surface, and/or E400 portable surfaces upon which a mark is capable of being made.

A user is further able to makes directional movement(s) upon 106, 107, 105, 104, 103, 112, 111, 109, 110, 108, 101, 102, 113, and/or 114 in an angular relation to each other thus, at least having conjoined pieces capable of a range of rotation of degrees as adjustment to accommodate a foreign object(s) contained in M100.

FIG. 15 is a perspective right-side view illustrating an embodiment of a multi-purpose apparatus according to an embodiment of the present invention. A user chooses a set of pieces from 100, as illustrated and described in FIG. 1, to form an embodiment that at least results in a main body as a single apparatus, hereinafter named 1500.

As a means to perform a physical exercise in conjunction with an intellectual activity, and/or separately to solely engage said embodiment of 1500 as means to perform a physical exercise, and/or separately as a means to solely utilize said embodiment of 1500 for use in an intellectual activity, a user employs said user's fingers along with associated bodily tissues and/or organs required for said user to assemble selected pieces from 100, as illustrated and described in FIG. 1, namely 111, 102, 101, 103, 104, 105, 107, 106, and 113 that result in the formation of 1500. This process requires a joint effort between said user's intellectual functions to consciously assemble, and/or alternatively to disassemble, said pieces in an orderly fashion and said user's physical body parts to carryout such assembly/disassembly; particularly said user's fingers are employed to accomplish a task with a specific purpose i.e. to form a useable, and/or reusable embodiment 1500.

A user performs the task to assemble 1500, optionally, and at least, in the following steps: exerting force upon the pieces in a manner to make contiguous: 113A with 106A, and 106C with 107B, and 107C with 105B, and 105A with 104C, and 104A with 103B, and 103A with 101C, 101B with 102A, and 102C with 111A, whereby 1500, at least, now exists in an embodiment for use of an intellectual activity, and/or in the support of intellectual activities.

A user is able, at least, to physically place, and/or physically support an object(s), foreign to 1500, e.g. at least, an object that contains a means that may engage intellectual activity, such as a book, a writing paraphernalia, upon and/or within the structure of 1500, at least, potentially for use by employment of said user's intellectual activities related to such an object(s). These foreign objects include, at least of the group of objects having a means, currently known, or yet to be known, item(s) used in a particular activity, e.g. intellectual activity: viewing printed matter, and/or an electronic object, and/or making a mark with an instrument upon a surface, such group herein illustrated and described and named M100.

Foreign objects found within M100 may be comprised of categories of objects among which includes, but is not limited to E100 comprised in part of printed matter, and/or E200 comprised in part of electronic devices, and/or E300 comprised in part of objects that are capable of making a mark upon a surface, and/or E400 portable surfaces upon which a mark is capable of being made.

A user is further able to makes directional movement(s) upon 111, 102, 101, 103, 104, 105, 107, 106, and/or 113, in an angular relation to each other thus, at least having conjoined pieces capable of a range of rotation of degrees as adjustment to accommodate a foreign object(s) contained in M100.

FIG. 15A is a perspective right-side view with a foreign object E201, obtained from E200, obtained from M100, illustrated and described as M100 in FIG. 11, illustrating an embodiment of a multi-purpose apparatus according to an embodiment of the present invention. A user chooses a set of pieces from 100, as illustrated and described in FIG. 1, to form an embodiment that at least results in a main body as a single apparatus, hereinafter named 1501.

A user may use foreign objects found within M100 to be comprised of categories of objects among which includes, but is not limited to E100 comprised in part of printed matter, and/or E200 comprised in part of electronic devices, and/or E300 comprised in part of objects that are capable of making a mark upon a surface, and/or E400 portable surfaces upon which a mark is capable of being made.

Providing as a means for enablement of the present invention, 1501, which is a duplicate of 1500 as illustrated and described in FIG. 15, here in 1501, whereby, at least, as an example of a sample of the means of M100, there exist multiple categories of foreign object(s) among which E200 exists, being comprised, in part, at least, of objects that include, but are not limited to, electronic devices, known as an electronic reader; within E200 is found a foreign object hereinafter named E201. Although E201 is illustrated and described in the state of being deactivated, as an imagery purpose, 1500, and thus 1501 allow a user to place E201 upon and/or within the borders of 1500, so that said user may thereat commence engagement of said user's intellectual activity in response to the matter based within E201 and as supported, as illustrated and described in 1501.

FIG. 15B is a perspective right-side view with a foreign object E201, obtained from E200, obtained from M100, illustrated and described as M100 in FIG. 11, illustrating an embodiment of a multi-purpose apparatus according to an embodiment of the present invention. A user chooses a set of pieces from 100, as illustrated and described in FIG. 1, to form an embodiment that at least results in a main body as a single apparatus, hereinafter named 1502.

Fundamentally, 1502 is a duplicate of 1500 as illustrated and described in FIG. 15, and is a duplicate of 1501 as illustrated and described in FIG. 15A, viewed from a right-side position illustrating the position of E201 as it is primarily supported by 102. As well 1502 illustrates the measurable, relational distance between 102/111 and 113/106 whereby the angle of E201 exists at a position as determined by a user, to accommodate an angle desirable by said user during the use of 1500, during the support of E201 which is within a range of rotation to accommodate a foreign object.

FIG. 15C is a perspective right-side-adjusted view with a foreign object E201, obtained from E200, obtained from M100, illustrated and described as M100 in FIG. 11, illustrating an embodiment of a multi-purpose apparatus according to an embodiment of the present invention. A user chooses a set of pieces from 100, as illustrated and described in FIG. 1, to form an embodiment that at least results in a main body as a single apparatus, hereinafter named 1503.

Fundamentally, 1503 is a duplicate of 1500 as illustrated and described in FIG. 15, and is a duplicate of 1501 as illustrated and described in FIG. 15A, and is a duplicate of 1502 as illustrated and described in FIG. 15B viewed from a right-side position, however illustrating a difference to 1502 as a result of a directional movement, an angular adjustment, at least, having been performed upon 102, 101, 103, 104, 105, 107, and/or 106. Said adjustment effectively altered the measurable, relational distance between 102/111 and 113/106 whereby the angle of E201 now exists at a new position as determined by a user, to accommodate an angle desirable by said user during the use of 1500, during the support of E201 which is within a range of rotation to accommodate a foreign object.

FIG. 15D is a perspective left-side view with a foreign object E201, obtained from E200, obtained from M100, illustrated and described as M100 in FIG. 11, illustrating an embodiment of a multi-purpose apparatus according to an embodiment of the present invention. A user chooses a set of pieces from 100, as illustrated and described in FIG. 1, to form an embodiment that at least results in a main body as a single apparatus, hereinafter named 1504.

Fundamentally, 1504 is a duplicate of 1500 as illustrated and described in FIG. 15 and is a duplicate of 1502 as illustrated and described in FIG. 15B, viewed from a left-side position.

FIG. 15E is a perspective left-side-adjusted view with a foreign object E201, obtained from E200, obtained from M100, illustrated and described as M100 in FIG. 11, illustrating an embodiment of a multi-purpose apparatus according to an embodiment of the present invention. A user chooses a set of pieces from 100, as illustrated and described in FIG. 1, to form an embodiment that at least results in a main body as a single apparatus, hereinafter named 1505.

Fundamentally, 1505 is a duplicate of 1500 as illustrated and described in FIG. 15, and is a duplicate of 1503 as illustrated and described in FIG. 15C, viewed from a left-side position.

FIG. 16 is a perspective frontal view illustrating an embodiment of a multi-purpose apparatus according to an embodiment of the present invention. A user chooses a set of pieces from 100, as illustrated and described in FIG. 1, to form an embodiment that at least results in a main body as a single apparatus, hereinafter named 1600.

As a means to perform a physical exercise in conjunction with an intellectual activity, and/or separately to solely engage said embodiment of 1600 as means to perform a physical exercise, and/or separately as a means to solely utilize said embodiment of 1600 for use in an intellectual activity, a user employs said user's fingers along with associated bodily tissues and/or organs required for said user to assemble selected pieces from 100, as illustrated and described in FIG. 1, namely 112, 111, 106, 107, 105, 104, 103, 101, 102, 113, 109, 110, 114 and 108 that result in the formation of 1600. This process requires a joint effort between said user's intellectual functions to consciously assemble, and/or alternatively to disassemble, said pieces in an orderly fashion and said user's physical body parts to carryout such assembly/disassembly; particularly said user's fingers are employed to accomplish a task with a specific purpose i.e. to form a useable, and/or reusable embodiment 1600.

A user performs the task to assemble 1600, optionally, and at least, in the following steps: exerting force upon the pieces in a manner to make contiguous: 112A with 111A, and 111B with 106A, and 106C with 107B, and 107C with 105B, and 105A with 104C, and 104A with 103B, and 103A with 101C, and 101B with 102A, and 104B with 113B, and 113A with 109B, and 109C with 110A, and 110B with 114A, and 109A with 108B, whereby 1600, at least, now exists in an embodiment for use of an intellectual activity, and/or in the support of intellectual activities.

A user is able, at least, to physically place, and/or physically support an object(s), foreign to 1600, e.g. at least, an object that contains a means that may engage intellectual activity, such as a book, a writing paraphernalia, upon and/or within the structure of 1600, at least, potentially for use by employment of said user's intellectual activities related to such an object(s). These foreign objects include, at least of the group of objects having a means, currently known, or yet to be known, item(s) used in a particular activity, e.g. intellectual activity: viewing printed matter, and/or an electronic object, and/or making a mark with an instrument upon a surface, such group herein illustrated and described and named M100.

Foreign objects found within M100 may be comprised of categories of objects among which includes, but is not limited to E100 comprised in part of printed matter, and/or E200 comprised in part of electronic devices, and/or E300 comprised in part of objects that are capable of making a mark upon a surface, and/or E400 portable surfaces upon which a mark is capable of being made.

A user is further able to makes directional movement(s) upon 112, 111, 106, 107, 105, 104, 103, 101, 102, 113, 109, 110, 114, and/or 108, in an angular relation to each other thus, at least having conjoined pieces capable of a range of rotation of degrees as adjustment to accommodate a foreign object(s) contained in M100.

FIG. 16A is a perspective frontal view with a foreign objects E102, E301, E302, E303 and/or E304 obtained from E100 and E300 respectively, being obtained from M100, illustrated and described as M100 in FIG. 11, illustrating an embodiment of a multi-purpose apparatus according to an embodiment of the present invention. A user chooses a set of pieces from 100, as illustrated and described in FIG. 1, to form an embodiment that at least results in a main body as a single apparatus, hereinafter named 1601.

A user may use foreign objects found within M100 to be comprised of categories of objects among which includes, but is not limited to E100 comprised in part of printed matter, and/or E200 comprised in part of electronic devices, and/or E300 comprised in part of objects that are capable of making a mark upon a surface, and/or E400 portable surfaces upon which a mark is capable of being made.

Providing as a means for enablement of the present invention, 1601, which is a duplicate of 1600 as illustrated and described in FIG. 16, here in 1601, whereby, at least, as an example of a sample of the means of M100, there exist multiple categories of foreign object(s) among which E100 exists, being comprised, in part, at least, of objects that include, but are not limited to, printed materials, such as, a printed book. Within E100 is found a foreign object hereinafter named E102. Although E102 is illustrated and described in the position of being opened, as an imagery purpose, 1600, and thus 1601 allow a user to place E101 upon and/or within the borders of 1600, so that said user may thereat commence engagement of said user's intellectual activity in response to the matter based within E101 and as supported, as illustrated and described in 1601.

Providing as a means for enablement of the present invention, 1601, which is a duplicate of 1600 as illustrated and described in FIG. 16, here in 1601, whereby, at least, as an example of a sample of the means of M100, there exist multiple categories of foreign object(s) among which E300 exists, being comprised, in part, at least, of objects that include, but are not limited to, writing instrumentation, at least, a pen and/or a pencil. Within E300 is found a foreign object hereinafter named E301, and/or E302, and/or E303, and/or E304; being placed upon and/or within the borders of 1600, so that said user may thereat commence engagement of said user's intellectual activity in response to the means provided from E300 as illustrated and described in here in 1601.

FIG. 16B is a perspective frontal view with a foreign objects E202, E301, E302, E303, E304, and/or E401 obtained from E200, E300, E400 respectively, being obtained from M100, illustrated and described as M100 in FIG. 11, illustrating an embodiment of a multi-purpose apparatus according to an embodiment of the present invention. A user chooses a set of pieces from 100, as illustrated and described in FIG. 1, to form an embodiment that at least results in a main body as a single apparatus, hereinafter named 1602.

Fundamentally, 1602 is a duplicate of 1600 as illustrated and described in FIG. 16, and is a duplicate of 1601 as illustrated and described in FIG. 16A, however, viewed with alternative foreign objects, and thus illustrating 1600 supporting E202, E301, E302, E303, E304, and/or E401 in a manner whereby said user may thereat commence engagement of said user's intellectual activity in response to the matter based within E200, E300, and E400 respectively.

Providing as a means for enablement of the present invention, 1602, which is a duplicate of 1600 and 1601 as illustrated and described in FIG. 16, and in FIG. 16A, respectively, here in 1602, whereby, at least, as an example of a sample of the means of M100, there exist multiple categories of foreign object(s) among which E400 exists, being comprised, in part, at least, of objects that include, but are not limited to, a portable surfaces upon which a mark is capable of being made. Within E400 is found a foreign object hereinafter named E401, being placed upon and/or supported within the borders of 1600, so that said user may thereat commence engagement of said user's intellectual activity in response to the means provided from E400 as illustrated and described in here in 1602.

FIG. 17 is an exploded view illustrating pieces to a multi-purpose apparatus, at least for use in a potentiality of embodiments of the instant invention. A user chooses a set of pieces from 100, as illustrated and described in FIG. 1, to form an embodiment that at least results in a main body as a single apparatus, at least, for reference purposes, hereinafter named 1700.

As a means to perform an intellectual activity with said embodiment of 1700, a user employs said user's mind to identify and select pieces from 100, as illustrated and described in FIG. 1, namely 101, and 102, and 103, and 104, and 105, and 106, and 107, and 108, and 109, and 110 that result in the formation of 1700. This process requires a joint effort between said user's intellectual functions to consciously select said pieces from 100 in an orderly fashion and a specific purpose to form a useable, and/or reusable embodiment 1700.

After said user assembled the pieces now comprised within 1700, the user may further engage said user's intellectual activity, at least, in the following manner as a means, at least to learn, to teach, and/or to communicate whole digits, i.e. zero through nine respectively: said user identifies and associates a whole number with a specific piece in 1700, at least optionally as follows, whole numbers: 1 identified with 101; 2 identified with 102; 3 identified with 103; 4 identified with 104; 5 identified with 105; 6 identified with 106; 7 identified with 107; 8 identified with 108; 9 identified with 109; and 0 identified with 110.

Additionally, after said user assembled the pieces, now comprised within 1700, may further engage said user's intellectual activity, at least, in the following manner as a means, at least to learn, to teach, and/or to communicate letters of the English alphabet with a specific piece and reference point (hereinafter, “RP”) therein within 1700, at least optionally as follows, English alphabet letters: A identified with RP 101A; B identified with RP 101B; C identified with RP 101C; D identified with RP 102A; E identified with RP 102B; F identified with RP 102C; G identified with RP 103A; H identified with RP 103B; I identified with RP 104A; J identified with RP 104B; K identified with RP 104C; L identified with RP 105A; M identified with RP 105B; N identified with RP 106A; O identified with RP 106B; P identified with RP 106C; Q identified with RP 107A; R identified with RP 107B; S identified with RP 107C; T identified with RP 108A; U identified with RP 108B; V identified with RP 109A; W identified with RP 109B; X identified with RP 109C; Y identified with RP 110A; and Z identified with RP 110B.

Similarly, a task to learn and/or to teach numeric digits and/or alpha letters, a user is, at least able to employ such process to communicate numbers and/or words as a unique code, novel to the world and unobvious to those practiced in the said arts, whereby the art of learning and/or teaching the use of letters and/or digits are subsequently capable of being used, at least, by other individual(s) who are similarly learned and/or schooled in the coding of such a unique code. For example the phrase, “I have 23 apples” may be known and/or communicated, via this unique code, as follows: 104A 103B101A109A102B 102103 101A106C106C105A102B107C; alternatively a user may decode the same phrase, as written via this unique code as follows: I=RP 104A; have =RP 103B with 101A with 109A with 102B; 23=RP 102 with 103; apples=RP 101A with 106C with 106C with 105A with 102B with 107C.

Further employment of said unique code may, at least, be made known and/or communicated simply by having an image of 1700 whereby a reference, at least via highlighting, or otherwise making unique attention to a given RP within 1700. By way of example, a first user may have, at least, an image of 1700 that is also known by a second user, further whereby said first user may make unique attention to a given RP, or at least to a series of RP and thus, at least, communicate a message to said second user; e.g. when the second user may communicate a question, requiring an affirmative or a denial response, by the first user, thus the first user may via said unique code, respond in the affirmative by sequentially make unique attention to the following RP based in 1700: 110A and then 102B and then 107C, effectively communicating the word, “yes”; as 110A=Y; 102B=E; and 107C=S.

Obviously, many modifications and variations of the present invention are possible in light of the above teachings. It is, therefore, to be understood that within the scope of the claims, the invention may be practiced otherwise than as specifically described. Furthermore, although a particular embodiment of the invention has been described in detail for purposes of illustration, various modifications and enhancements may be made without departing from the spirit and scope of the invention. Accordingly, the invention is not to be limited except as by any appended claims. Moreover, the descriptions are given by way of example, and not limitation. Given the disclosures herein, one skilled in the art might devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments and/or descriptions thereof.

Claims of the invention, in which an exclusive property and/or privilege is also claimed, as follows:

1. A system for a multi-purpose apparatus, at least, for reference purposes, hereinafter named IC1, comprising:
a.) a main body comprised of a plurality of pieces;
b.) a plurality of pieces that are capable of being made contiguous resulting in a usable, and/or a reusable, embodiment that has a potentiality for other useable, and/or reusable, other multiple embodiments;
c.) a potentiality for said other multiple embodiments that have, at least, purposes in the fields of 1) physical exercise, and/or 2) method of assembly and/or disassembly process, and/or 3) intellectual activity, and/or 4) amusement;
d.) a main body that is portable, and lightweight, and a single-unit, and easily transportable, and compact, and durable, and readily available, and inexpensive; and
e.) a main body whereby said pieces of said main body are inherently comprised in a single apparatus, hereinafter named 100.

2. The system for a multi-purpose apparatus system of claim 1, IC1, further comprising:
a.) an inherent plurality of pieces used in a plurality of potential useable embodiments;
b.) at least one potential embodiment for use in the physical exercise field;
c.) at least one potential embodiment for the assembly/disassembly processes of an apparatus;
d.) at least one potential embodiment for use in the intellectual activity field;
e.) at least one potential embodiment for use in the amusement field; and
f.) a usable, and a reusable, method(s), at least, of use for each of the potential embodiments of a single apparatus; and
g.) a main body as an apparatus, named 100 comprised of:
h.) a first tee fitting rigid piece, hereinafter named 101, having a first end, hereinafter named 101A, and having a mid-section, hereinafter named 101B, and having a second end, hereinafter named 101C;
i.) a first arced rigid piece, hereinafter named 102, having a first end, hereinafter named 102A, having a mid-section maintaining an arc, hereinafter named 102B, and having a second end, hereinafter named 102C; collectively forming an arc wherein said arc includes an angular range of degrees within which approximation of ninety-degree, 90°, and including ninety-degree, 90°, is included, said angular range commencing at the first end at 102A, traversing through the mid-section at 102B and terminating at the second end at 102C;
j.) a first relatively straight elongated rigid piece, hereinafter named 103, having a first end, hereinafter named 103A, and having a second end, hereinafter named 103B;
k.) a second tee fitting rigid piece, or, alternatively an elongated rigid coupler, hereinafter named 104, having a first end, hereinafter named 104A, and having a mid-section, hereinafter named 104B, and having a second end, hereinafter named 104C;)
l.) a second relatively straight elongated rigid piece, hereinafter named 105, having a first end, hereinafter named 105A, and having a second end, hereinafter named 105B;
m.) a second arced rigid piece, hereinafter named 106, having a first end, hereinafter named 106A, having a mid-section maintaining an arc, hereinafter named 106B, and having a second end, hereinafter named 106C; collectively forming an arc wherein said arc includes an angular range of degrees within which approximation of ninety-degree, 90°, and including ninety-degree, 90°, is included, said angular range commencing at the first end at 106A, traversing through the mid-section at 106B and terminating at the second end at 106C;
n.) a third tee fitting rigid piece, hereinafter named 107, having a first end, hereinafter named 107A, and having a mid-section, hereinafter named 107B, and having a second end, hereinafter named 107C;
o.) a third relatively straight elongated rigid piece, hereinafter named 108, having a first end, hereinafter named 108A, and having a second end, hereinafter named 108B;
p.) a fourth tee fitting rigid piece, hereinafter named 109, having a first end, hereinafter named 109A, and having a mid-section, hereinafter named 109B, and having a second end, hereinafter named 109C;
q.) a fourth relatively straight elongated rigid piece, hereinafter named 110, having a first end, hereinafter named 110A and having a second end, hereinafter named 110B; whereat said 110 is proportionally fixed in length, within a range of tolerances, relationally predetermined by a relative overall combined, contiguous, length of the first relatively straight elongated rigid piece 103, with the second tee fitting rigid piece 104, and with the second relatively straight elongated rigid piece 105 respectively, maintaining contiguous functionality thus enabling formation of a variety of embodiments of the apparatus;
r.) a fifth relatively straight elongated rigid piece, hereinafter named 111, having a first end, hereinafter named 111A, and having a second end, hereinafter named 111B;
s.) a first approximately ninety-degree, 90°, rigid piece, hereinafter named 112, having a first end, hereinafter named 112A, and having a second end, hereinafter named 112B;
t.) a sixth relatively straight elongated rigid piece, hereinafter named 113, having a first end, hereinafter named 113A, and having a second end, hereinafter named 113B;
u.) a second approximately ninety-degree, 90°, rigid piece, hereinafter named 114, having a first end, hereinafter named 114A, and having a second end, hereinafter named 114B; and
v.) said 100 being comprised of the set of pieces so named: 101, and/or 102, and/or 103, and/or 104, and/or 105, and/or 106, and/or 107, and/or 108, and/or 109, and/or 110, and/or 111, and/or 112, and/or 113, and/or 114, whereby the forming of a main body is inherently comprised in a single apparatus, whereby the set of said pieces, individually and/or collectively, are selected by a user, in a process to form a particular embodiment desired by a user.

3. A method for a system of a multi-purpose apparatus, at least, for reference purposes, hereinafter named IC2, comprising:
a.) providing, and/or assembling, and/or using a main body comprised of a plurality of pieces;
b.) providing, and/or assembling, and/or using a plurality of pieces that are capable of being made contiguous resulting in a usable, and a reusable, embodiment that has a potentiality for other useable, and reusable, other multiple embodiments;
c.) providing, and/or assembling, and/or using a potentiality for said other multiple embodiments that have, at least, purposes in the fields of 1) physical exercise, and/or 2) method of assembly and/or disassembly process, and/or 3) intellectual activity, and/or 4) amusement;
d.) providing, and/or assembling, and/or using a main body that is portable, and lightweight, and a single-unit, and easily transportable, and compact, and durable, and readily available, and inexpensive; and
e.) providing, and/or assembling, and/or using a main body whereby said pieces of said main body are inherently comprised in a single apparatus, hereinafter named 100.

4. A method for a system of a multi-purpose apparatus of claim 3, IC2, further comprising:
a.) providing, and/or assembling, and/or using a main body as an apparatus, named 100, comprised of:
b.) providing, and/or assembling, and/or using a first tee fitting rigid piece, hereinafter named 101, having a first end, hereinafter named 101A, and having a mid-section, hereinafter named 101B, and having a second end, hereinafter named 101C;
c.) providing, and/or assembling, and/or using a first arced rigid piece, hereinafter named 102, having a first end, hereinafter named 102A, having a mid-section maintaining an arc, hereinafter named 102B, and having a second end, hereinafter named 102C; collectively forming an arc wherein said arc includes an angular range of degrees within which approximation of ninety-degree, 90°, and including ninety-degree, 90°, is included, said angular range commencing at the first end at 102A, traversing through the mid-section at 102B and terminating at the second end at 102C;
d.) providing, and/or assembling, and/or using a first relatively straight elongated rigid piece, hereinafter named 103, having a first end, hereinafter named 103A, and having a second end, hereinafter named 103B;
e.) providing, and/or assembling, and/or using a second tee fitting rigid piece, or, alternatively an elongated rigid coupler, hereinafter named 104, having a first end, hereinafter named 104A, and having a mid-section, hereinafter named 104B, and having a second end, hereinafter named 104C;
f.) providing, and/or assembling, and/or using a second relatively straight elongated rigid piece, hereinafter named 105, having a first end, hereinafter named 105A, and having a second end, hereinafter named 105B;
g.) providing, and/or assembling, and/or using a second arced rigid piece, hereinafter named 106, having a first end, hereinafter named 106A, having a mid-section maintaining an arc, hereinafter named 106B, and having a second end, hereinafter named 106C; collectively forming an arc wherein said arc includes an angular range of degrees within which approximation of ninety-degree, 90°, and including ninety-degree, 90°, is included, said angular range commencing at the first end at 106A, traversing through the mid-section at 106B and terminating at the second end at 106C;
h.) providing, and/or assembling, and/or using a third tee fitting rigid piece, hereinafter named 107, having a first end, hereinafter named 107A, and having a mid-section, hereinafter named 107B, and having a second end, hereinafter named 107C;
i.) providing, and/or assembling, and/or using a third relatively straight elongated rigid piece, hereinafter named 108, having a first end, hereinafter named 108A, and having a second end, hereinafter named 108B;
j.) providing, and/or assembling, and/or using a fourth tee fitting rigid piece, hereinafter named 109, having a first end, hereinafter named 109A, and having a mid-section, hereinafter named 109B, and having a second end, hereinafter named 109C;
k.) providing, and/or assembling, and/or using a fourth relatively straight elongated rigid piece, hereinafter named 110, having a first end, hereinafter named 110A and having a second end, hereinafter named 110B; whereat said 110 is proportionally fixed in length, within a range of tolerances, relationally predetermined by a relative overall combined, contiguous, length of the first relatively straight elongated rigid piece 103, with the second tee fitting rigid piece 104, and with the second relatively straight elongated rigid piece 105 respectively, maintaining contiguous functionality thus enabling formation of a variety of embodiments of the apparatus;
l.) providing, and/or assembling, and/or using a fifth relatively straight elongated rigid piece, hereinafter named 111, having a first end, hereinafter named 111A, and having a second end, hereinafter named 111B;
m.) providing, and/or assembling, and/or using a first approximately ninety-degree, 90°, rigid piece, hereinafter named 112, having a first end, hereinafter named 112A, and having a second end, hereinafter named 112B;
n.) providing, and/or assembling, and/or using a sixth relatively straight elongated rigid piece, hereinafter named 113, having a first end, hereinafter named 113A, and having a second end, hereinafter named 113B;
o.) providing, and/or assembling, and/or using a second approximately ninety-degree, 90°, rigid piece, hereinafter named 114, having a first end, hereinafter named 114A, and having a second end, hereinafter named 114B; and
p.) providing, and/or assembling, and/or using said 100 being comprised of the set of pieces so named: 101, and/or 102, and/or 103, and/or 104, and/or 105, and/or 106, and/or 107, and/or 108, and/or 109, and/or 110, and/or 111, and/or 112, and/or 113, and/or 114, whereby the forming of a main body is inherently comprised in a single apparatus, whereby the set of said pieces, individually and/or collectively, are selected by a user, in a process to form a particular embodiment desired by a user.

5. A system for a physical exercise apparatus, at least, for reference purposes, hereinafter named IC3, comprising:
a.) a main body as an apparatus, hereinafter named 100;
b.) a first tee fitting rigid piece, hereinafter named 101, having a first end, hereinafter named 101A, and having a mid-section, hereinafter named 101B, and having a second end, hereinafter named 101C;
c.) a first arced rigid piece, hereinafter named 102, having a first end, hereinafter named 102A, having a mid-section maintaining an arc, hereinafter named 102B, and having a second end, hereinafter named 102C; collectively forming an arc wherein said arc includes an angular range of degrees within which approximation of ninety-degree, 90°, and including ninety-degree, 90°, is included, said angular range commencing at the first end at 102A, traversing through the mid-section at 102B and terminating at the second end at 102C;
d.) a first relatively straight elongated rigid piece, hereinafter named 103, having a first end, hereinafter named 103A, and having a second end, hereinafter named 103B;
e.) a second tee fitting rigid piece, or, alternatively an elongated rigid coupler, hereinafter named 104, having a first end, hereinafter named 104A, and having a mid-section, hereinafter named 104B, and having a second end, hereinafter named 104C;
f.) a second relatively straight elongated rigid piece, hereinafter named 105, having a first end, hereinafter named 105A, and having a second end, hereinafter named 105B;
g.) a second arced rigid piece, hereinafter named 106, having a first end, hereinafter named 106A, having a mid-section maintaining an arc, hereinafter named 106B, and having a second end, hereinafter named 106C; collectively forming an arc wherein said arc includes an angular range of degrees within which approximation of ninety-degree, 90°, and including ninety-degree, 90°, is included, said angular range commencing at the first end at 106A, traversing through the mid-section at 106B and terminating at the second end at 106C;
h.) a third tee fitting rigid piece, hereinafter named 107, having a first end, hereinafter named 107A, and having a mid-section, hereinafter named 107B, and having a second end, hereinafter named 107C;
i.) a third relatively straight elongated rigid piece, hereinafter named 108, having a first end, hereinafter named 108A, and having a second end, hereinafter named 108B;
j.) a fourth tee fitting rigid piece, hereinafter named 109, having a first end, hereinafter named 109A, and having a mid-section, hereinafter named 109B, and having a second end, hereinafter named 109C;
k.) a fourth relatively straight elongated rigid piece, hereinafter named 110, having a first end, hereinafter named 110A and having a second end, hereinafter named 110B; whereat said 110 is proportionally fixed in length, within a range of tolerances, relationally predetermined by a relative overall combined, contiguous, length of the first relatively straight elongated rigid piece 103, with the second tee fitting rigid piece 104, and with the second relatively straight elongated rigid piece 105 respectively, maintaining contiguous functionality thus enabling formation of a variety of embodiments of the apparatus;)
l.) a fifth relatively straight elongated rigid piece, hereinafter named 111, having a first end, hereinafter named 111A, and having a second end, hereinafter named 111B;
m.) a first approximately ninety-degree, 90°, rigid piece, hereinafter named 112, having a first end, hereinafter named 112A, and having a second end, hereinafter named 112B;
n.) a sixth relatively straight elongated rigid piece, hereinafter named 113, having a first end, hereinafter named 113A, and having a second end, hereinafter named 113B;
o.) a second approximately ninety-degree, 90°, rigid piece, hereinafter named 114, having a first end, hereinafter named 114A, and having a second end, hereinafter named 114B; and
p.) said 100 being comprised of the set of pieces so named: 101, and/or 102, and/or 103, and/or 104, and/or 105, and/or 106, and/or 107, and/or 108, and/or 109, and/or 110, and/or 111, and/or 112, and/or 113, and/or 114, whereby the forming of a main body is inherently comprised in a single apparatus, whereby the set of said pieces, individually and/or collectively, are selected by a user, in a process to form a particular embodiment desired by a user.

6. The system for a physical exercise apparatus recited in claim 5, IC3, further comprising:
a.) a said main body that comprises a potentiality for multiple embodiments with a practical useable method(s) for use by human beings;
b.) each piece is made of a rigid material, solely or any combination of, or any form of any material related to fiber, wood, plastic, glass, fiberglass, metal, resins, or material(s) of similarly rigid properties, currently known, or yet to be known;
c.) each piece and/or any combination of pieces, is/are, at least, in the structural shape, or form of oval, rectangular, round, square, triangular, or tubular, a similarly potential of one piece being capable of being made contiguous to any other said piece; and
d.) a single piece, and/or a combination of any said piece(s), has/have an hollow core, or have a hollow within any portion of any piece thereof, allowing the piece(s) to be rigidly conjoined to form an embodiment, or embodiments, of the apparatus.

7. A method for use of a system for a physical exercise apparatus, at least, for reference purposes, hereinafter named IC4, comprising the steps of:
a.) providing, and/or assembling, and/or using a main body as an apparatus; hereinafter named 100;
b.) providing, and/or assembling, and/or using a first tee fitting rigid piece, hereinafter named 101, having a first end, hereinafter named 101A, and having a mid-section, hereinafter named 101B, and having a second end, hereinafter named 101C;
c.) providing, and/or assembling, and/or using a first arced rigid piece, hereinafter named 102, having a first end, hereinafter named 102A, having a mid-section maintaining an arc, hereinafter named 102B, and having a second end, hereinafter named 102C; collectively forming an arc wherein said arc includes an angular range of degrees within which approximation of ninety-degree, 90°, and including ninety-degree, 90°, is included, said angular range commencing at the first end at 102A, traversing through the mid-section at 102B and terminating at the second end at 102C;
d.) providing, and/or assembling, and/or using a first relatively straight elongated rigid piece, hereinafter named 103, having a first end, hereinafter named 103A, and having a second end, hereinafter named 103B;
e.) providing, and/or assembling, and/or using a second tee fitting rigid piece, or, alternatively an elongated rigid coupler, hereinafter named 104, having a first end, hereinafter named 104A, and having a mid-section, hereinafter named 104B, and having a second end, hereinafter named 104C;
f.) providing, and/or assembling, and/or using a second relatively straight elongated rigid piece, hereinafter named 105, having a first end, hereinafter named 105A, and having a second end, hereinafter named 105B;
g.) providing, and/or assembling, and/or using a second arced rigid piece, hereinafter named 106, having a first end, hereinafter named 106A, having a mid-section maintaining an arc, hereinafter named 106B, and having a second end, hereinafter named 106C; collectively forming an arc wherein said arc includes an angular range of degrees within which approximation of ninety-degree, 90°, and including ninety-degree, 90°, is included, said angular range commencing at the first end at 106A, traversing through the mid-section at 106B and terminating at the second end at 106C;
h.) providing, and/or assembling, and/or using a third tee fitting rigid piece, hereinafter named 107, having a first end, hereinafter named 107A, and having a mid-section, hereinafter named 107B, and having a second end, hereinafter named 107C;
i.) providing, and/or assembling, and/or using a third relatively straight elongated rigid piece, hereinafter named 108, having a first end, hereinafter named 108A, and having a second end, hereinafter named 108B;
j.) providing, and/or assembling, and/or using a fourth tee fitting rigid piece, hereinafter named 109, having a first end, hereinafter named 109A, and having a mid-section, hereinafter named 109B, and having a second end, hereinafter named 109C;
k.) providing, and/or assembling, and/or using a fourth relatively straight elongated rigid piece, hereinafter named 110, having a first end, hereinafter named 110A and having a second end, hereinafter named 110B; whereat said 110 is proportionally fixed in length, within a range of tolerances, relationally predetermined by a relative overall combined, contiguous, length of the first relatively straight elongated rigid piece 103, with the second tee fitting rigid piece 104, and with the second relatively straight elongated rigid piece 105 respectively, maintaining contiguous functionality thus enabling formation of a variety of embodiments of the apparatus;
l.) providing, and/or assembling, and/or using a fifth relatively straight elongated rigid piece, hereinafter named 111, having a first end, hereinafter named 111A, and having a second end, hereinafter named 111B;
m.) providing, and/or assembling, and/or using a first approximately ninety-degree, 90°, rigid piece, hereinafter named 112, having a first end, hereinafter named 112A, and having a second end, hereinafter named 112B;
n.) providing, and/or assembling, and/or using a sixth relatively straight elongated rigid piece, hereinafter named 113, having a first end, hereinafter named 113A, and having a second end, hereinafter named 113B;
o.) providing, and/or assembling, and/or using a second approximately ninety-degree, 90°, rigid piece, hereinafter named 114, having a first end, hereinafter named 114A, and having a second end, hereinafter named 114B; and
p.) providing, and/or assembling, and/or using a set of said pieces, individually and/or selectively and/or collectively, chosen by a user in a process to form a particular embodiment desired by a user, and said 100 being comprised of the set of following pieces: 101, and/or 102, and/or 103, and/or 104, and/or 105, and/or 106, and/or 107, and/or 108, and/or 109, and/or 110, and/or 111, and/or 112, and/or 113, and/or 114; forming a main body inherently comprised in a single apparatus, forenamed 100.

8. A method of using a method for use of a physical exercise apparatus recited in claim 7, IC4, the method comprising:
a.) providing, and/or assembling, and/or using pieces whereby a user exerting a means of human force upon, and making contiguous: 101B with 102A, and 102C with 103A, and 103B with 104A, and 104C with 105A, and 105B with 106A, and 106C with 107B, and 107C with 108A, and 108B with 109A, and 109C with 110A, and 110B with 101C, and 111A with 104B, and 111B with 112A, and 112B with 113A, and 113B with 114A, whereby said assembly, at least, now exists in an embodiment for storage and/or transportation, and/or physical exercise, hereinafter named 200;
b.) providing, and/or assembling, and/or using 200 whereby a user places a single finger, or said user places a first set of said user's fingers upon 106, and contiguous with 103, and with 104, and with 105, and simultaneously said user place a different single finger, or said user places a second set of said user's fingers upon 102, further applying human force to 106 and 102 in a static position, or alternatively said user similarly thus places said user's finger, or a first set of said user's fingers, at any point between 107 through 101, via 108 with 109 with 110, and simultaneously said user place a different single finger, or said user places a second set of said user's fingers upon 106, and/or 103, and/or 104, and/or 105, and/or 102, or, alternatively said user similarly places and exerts force via said user's finger, and/or fingers upon any point on, and/or between 111, and/or 112, and/or 113, and/or 114, further applying human force in a static position, allowing said user to perform isometric exercises;
c.) providing, and/or assembling, and/or using 200 whereby a user places a single finger, or said user places a first set of said user's fingers upon 106, and contiguous with 103, and with 104, and with 105, and simultaneously said user place a different single finger, or said user places a second set of said user's fingers upon 102, further applying human force to 106 and 102 in a directional movement, or alternatively a user similarly thus places said user's fingers, or fingers, at any point between 107 through 101, via 108 with 109 with 110, and simultaneously said user place a different single finger, or said user places a second set of said user's fingers upon 106, and/or 103, and/or 104, and/or 105, and/or 102, or, alternatively said user similarly places and exerts force via said user's finger, and/or fingers upon any point on, and/or between 111, and/or 112, and/or 113, and/or 114, further applying human force in a directional movement, allowing said user to perform isotonic exercises;
d.) providing, and/or assembling, and/or using, at least performing the aforementioned exertion of human force upon 200 whereby a user may conduct said methods in nearly any bodily position, or bodily motion, e.g. supine, standing, sitting, walking, swimming; and
e.) providing, and/or assembling, and/or using, at least equipping the user with the ability to repeat said motion by said user's body parts attachment to 200 for a length of time determined by the user.

9. A method of using a method for use of a physical exercise apparatus recited in claim 7, IC4, the method comprising:
a.) providing, and/or assembling, and/or using pieces whereby a user exerting a means of human force upon, and making contiguous: 112A with 111A, and 111B with 102C, and 102A with 101B, and 101A with 110B, and 110A with 109C, and 109A with 108B, and 108A with 107A, and 107B with 106C, and 106A with 113A, and 113B with 114A, thereby forming a single contiguous apparatus, whereat 102 and 106 are within an alignment range that minimally does not include an exact rotational counterbalance alignment to each other, being offset from a perfect counterbalance, whereby said assembly, at least, now exists in an embodiment conducive for physical exercise, hereinafter named 300;
b.) providing, and/or assembling, and/or using, at least engaging an alternative dimension of 300, a user is able to alternatively substitute 103, and 104, and 105 in place of 108, and 109, and 110 respectively, continuing to avail 300 for physical exercises;
c.) providing, and/or assembling, and/or using, at least having a user place a first set of said user's fingers on 300, at any point between, at and including 101A along the contiguous pieces 110 with 109 up to, and including, the 109C, and simultaneously place a second set of the user's fingers at any point between 109A contiguous with 108 up to and including 107A; alternatively allowing said user to substitute, 110 and 109 and 108 with 103 and 104 and 105 respectively; whereby 102 and 106 are contiguous via conjoined pieces;
d.) providing, and/or assembling, and/or using, at least placing said sets of a user's fingers within said recited ranges of the cited pieces, the user may apply human force through the user's set of fingers upon 300 in a directional movement, either forward and/or reverse, by utilizing the mass of 300 as a means to initiate, and/or to maintain a rotational movement of 300 in the performance of a variety of isokinetic physical exercises;
e.) providing, and/or assembling, and/or using, at least allowing a user to increase and/or decrease the rate of revolutions of the directional motion conducive to a multitude of physical exercises; causing an increase in the level of exertion put forth by the user resulting in a maintained, and/or an increase in the user's heart rate, and/or respiration, resulting from the performance of a potential aerobic physical exercise;
f.) providing, and/or assembling, and/or using, at least alternatively, allowing said user to engage in isolation, a single set of said user's fingers, and/or then alternatively to engage in isolation, a second set of said user's fingers, to perform the same, or similar, directional movement upon 300;
g.) providing, and/or assembling, and/or using, at least having a user utilize 300 whereby a user places a single finger, or said user places a first set of said user's fingers upon 106, and contiguous with 108, 109, 110, and simultaneously said user place a different single finger, or said user places a second set of said user's fingers upon 102, further applying human force to 106 and 102 in a static position that allows said user to perform isometric exercises;
h.) providing, and/or assembling, and/or using, at least having a user utilize 300 whereby said user places a single finger, or said user places a first set of said user's fingers upon 106, and contiguous with 108, 109, 110, and simultaneously said user place a different single finger, or said user places a second set of said user's fingers upon 102, further applying human force to 106 and 102 in a directional manner that allows said user to perform isotonic exercises;
i.) providing, and/or assembling, and/or using, at least allowing a user to perform the aforementioned exertion of human force upon 300 whereby said user may conduct said methods in nearly any bodily position, or bodily motion, e.g. supine, standing, sitting, walking, swimming;
j.) providing, and/or assembling, and/or using, at least equipping the user with the ability to repeat said motion by said user's body parts attachment to 300 for a length of time determined by the user.

10. A method of using a method for use of a physical exercise apparatus recited in claim 7, IC4, the method comprising:
a.) providing, and/or assembling, and/or using pieces whereby a user exerting a means of human force upon, and making contiguous: 101B with 102A, and 102C with 103A, and 103B with 104A, and 104C with 105A, and 105B with 106A, and 106C with 107B, thereby forming a single contiguous apparatus, whereat 102 and 106 are within an alignment range that minimally does not include an exact rotational counterbalance alignment to each other, being offset from a perfect counterbalance, whereby said assembly, at least, now exists in an embodiment conducive for physical exercise, hereinafter named 400;
b.) providing, and/or assembling, and/or using, at least having a user place a set of said user's fingers around 102B and simultaneously said user placing a second set of said user's fingers around 106B, whereby 102 and 106 are contiguous via the union of 103, and 104, and 105;
c.) providing, and/or assembling, and/or using, at least engaging an alternative dimension of 400, a user is able to substitute 103, and 104, and 105 by replacement with 108, and 109, and 110, respectively, continuing to avail 400 for physical exercises;
d.) providing, and/or assembling, and/or using, at least rotating said user's body parts, shoulders, arms, forearms, wrists, and hands, and tissues associated thereto, via means of said user's said sets of fingers, moving 400 in a directional motion, being capable of performing a multitude of physical exercises;
e.) providing, and/or assembling, and/or using, at least having a user place a first set of said user's fingers on 400, at any point between, at and including 102B along the contiguous pieces 103 with 104 up to, and including 104A, and simultaneously place a second set of the user's fingers at any point between 104C contiguous with 105 up to and including 106B; alternatively allowing said user to substitute, 110, and 109, and 108 to be in place of 103, and 104, and 105, respectively; whereby 102 and 106 are contiguous via conjoined pieces;
f.) providing, and/or assembling, and/or using, at least placing said sets of the user's fingers within said recited ranges of the cited pieces, the user may apply human force through the user's set of fingers upon 400 in a directional manner, by a means of utilizing the mass of 400 as a means to initiate and/or to maintain a rotational movement of 400 in the performance of a variety of isokinetic physical exercises;
g.) providing, and/or assembling, and/or using, at least alternatively, allowing said user to engage in isolation, a single set of said user's fingers, and/or then alternatively to engage in isolation, a second set of said user's fingers, to perform the same, or similar, directional movement upon 400;
h.) providing, and/or assembling, and/or using, at least having a user utilize 400 whereby a user places a single finger, or said user places a first set of said user's fingers upon 106, and contiguous with 103, 104, 105, and simultaneously said user place a different single finger, or said user places a second set of said user's fingers upon 102, further applying human force to 106 and 102 in a static position that allows said user to perform isometric exercises;
i.) providing, and/or assembling, and/or using, at least having a user utilize 400 whereby a user places a single finger, or said user places a first set of said user's fingers upon 106, and contiguous with 103, 104, 105, and simultaneously said user place a different single finger, or said user places a second set of said user's fingers upon 102, further applying human force to 106 and 102 in a directional manner that allows said user to perform isotonic exercises;
j.) providing, and/or assembling, and/or using, at least alternatively allowing the user to utilize 400 and grasp 102, or 106, with one and/or both set(s) of said user's fingers and the user simultaneously placing either a first foot of said user, or instead and separately placing a second foot of said user upon the opposite piece not grasped by either one and/or both sets of said user's fingers, i.e. either 102, or 106 held by said user's said set(s) of fingers and the remainder piece being contiguous to one of the user's feet;
k.) providing, and/or assembling, and/or using, at least allowing said user to simultaneously and contiguously exert human force upon 400 thus contiguous to said user's body parts, commencing motion upon 400 whereby a simulation of multiple bodily exercise movements may occur as determined by said user, e.g. cycling simulation, or swimming simulation;
l.) providing, and/or assembling, and/or using, at least alternatively, allowing a user to simultaneously and contiguously exert human powered force upon 400 thus contiguous to the user's body parts, commencing motion upon 400 whereby said user may cause a stretching of said user's muscles and/or associated bodily tissues;
m.) providing, and/or assembling, and/or using, at least allowing a user to perform the aforementioned exertion of human force upon 400 whereby said user may conduct said methods in nearly any bodily position, or bodily motion, e.g. supine, standing, sitting, walking, swimming;
n.) providing, and/or assembling, and/or using, at least equipping the user with the ability to repeat said motion by means of the user's body parts as attached to 400 for a length of time determined by the user.

11. A method of using a method for use of a physical exercise apparatus recited in claim 7, IC4, the method comprising:
a.) providing, and/or assembling, and/or using pieces whereby a user exerting means of human force upon and making contiguous: 101B with 102A, and 102C with 110B, and 110A with 109C, and 109A with 108B, and 108A with 106A, and 106C with 107B, whereby said assembly, at least, now exists in an embodiment, thereby forming a single contiguous apparatus, whereat 102 and 106 are contiguous via 110 with 109 with 108, within an alignment range that minimally includes a rotational counterbalance alignment between 102 and 106, hereinafter named 500;
b.) providing, and/or assembling, and/or using, at least alternatively allowing a user to substitute, 110 and 109 and 108 with 103 and 104 and 105, respectively; whereby 102 and 106 remain contiguous via conjoined pieces;
c.) providing, and/or assembling, and/or using, at least having a user place one set of said user's fingers around 102B and simultaneously placing the user's second set of fingers around 106B, whereby 102 and 106 are contiguous via the union of 108, with 109, with 110, or alternatively, are contiguous via the union of 103, with 104, with 105;
d.) providing, and/or assembling, and/or using, at least rotating said user's body parts, shoulders, arms, forearms, wrists, and hands, and tissues associated thereto, via means of said user's said sets of fingers, moving 500 in a directional motion, being capable of performing a multitude of physical exercises;
e.) providing, and/or assembling, and/or using, at least having a user utilize 500 whereby a user places a single finger, or said user places a first set of said user's fingers upon 106, and contiguous with 108, 109, 110, and simultaneously said user place a different single finger, or said user places a second set of said user's fingers upon 102, further applying human force to 106 and 102 in a static position that allows said user to perform isometric exercises;
f.) providing, and/or assembling, and/or using, at least having a user utilize 500 whereby a user places a single finger, or said user places a first set of said user's fingers upon 106, and contiguous with 108, 109, 110, and simultaneously said user place a different single finger, or said user places a second set of said user's fingers upon 102, further applying human force to 106 and 102 in a directional manner that allows said user to perform isotonic exercises;
g.) providing, and/or assembling, and/or using, at least alternatively allowing the user to utilize 500 and grasp 102, or 106, with one and/or both set(s) of said user's fingers and the user simultaneously placing either a first foot of said user, or instead and separately placing a second foot of said user upon the opposite piece not grasped by either one and/or both sets of said user's fingers, i.e. either 102, or 106 held by said user's said set(s) of fingers and the remainder piece being contiguous to one of the user's feet;
h.) providing, and/or assembling, and/or using, at least allowing said user to simultaneously and contiguously exert human force upon 500 thus contiguous to said user's body parts, commencing motion upon 500 whereby a simulation of multiple bodily exercise movements may occur as determined by said user, e.g. cycling simulation, or swimming simulation;
i.) providing, and/or assembling, and/or using, at least alternatively allowing a user to simultaneously and contiguously exert human powered force upon 500 thus contiguous to the user's body parts, commencing motion upon 500 whereby said user may cause a stretching of said user's muscles and/or associated bodily tissues;
j.) providing, and/or assembling, and/or using, at least allowing a user to perform the aforementioned exertion of human force upon 500 whereby said user may conduct said methods in nearly any bodily position, or bodily motion, e.g. supine, standing, sitting, walking, swimming;
k.) providing, and/or assembling, and/or using, at least equipping the user with the ability to repeat said motion by means of the user's body parts as attached to 500 for a length of time determined by the user.

12. A method of using a method for use of a physical exercise apparatus recited in claim 7, IC4, the method comprising:
a.) providing, and/or assembling, and/or using pieces whereby a user exerting means of human force upon and making contiguous: 102A with 101B, and 101C with 103A, and 103B with 104A, and 104C with 105A, and 105B with 107C, and 107B with 106C, whereby said assembly, at least, now exists in an embodiment, thereby forming a single contiguous apparatus, whereat 102 and 106 are capable of being positioned at any point in a three hundred sixty-degree, 360°, range contiguous via 103 with 104 with 105, hereinafter named 600;
b.) providing, and/or assembling, and/or using, at least alternatively allowing a user to substitute 103, and 104, and 105, with 110, and 109, and 108, respectively; whereby 102 and 106 remain contiguous via conjoined pieces;
c.) providing, and/or assembling, and/or using, at least having a user place one set of said user's fingers around 102B and simultaneously placing the user's second set of fingers around 106B, whereby 102 and 106 are contiguous via the union of 103, 104, and 105, or alternatively, are contiguous via the union of 108, and 109, and 110;
d.) providing, and/or assembling, and/or using, at least allowing said user to manipulate the degree of angle between 102 and 106 to a preferred angle by the user in the performance of physical exercise, being performed by said user placing a first set of said user's fingers at nearly any point between 102C to 101 and simultaneously said user placing a second set of said user's fingers at nearly any point between 106A to 107, thus positioned on 600 said user may exert said user's human force via said user's said first and said second set of said user's fingers upon 600 in a directional motion conducive to a multitude of physical exercises to be performed by said user, said manipulation of 600, by said user, is in itself a form of a physical exercise;
e.) providing, and/or assembling, and/or using, at least allowing a user to grasp 600 either at 101 and/or 102, and simultaneously said user grasps 600 either at 107 and/or 106, then altering the dimension between 102C with 104A, and/or, 106A with 104C by a directional movement of 101, 102, 106 and/or 107;
f.) providing, and/or assembling, and/or using, at least allowing a user to rotate said user's body parts, shoulders, arms, forearms, wrists, and hands, and tissues associated thereto, via means of said user's said sets of fingers, moving 600 in a directional motion, being capable of performing a multitude of physical exercises;
g.) providing, and/or assembling, and/or using, at least allowing a user to increase and/or decrease the rate of revolutions of the directional motion conducive to a multitude of physical exercises; causing to maintain, or to increase the level of exertion put forth by the user, resulting in a potential increase in the user's heart rate, and/or respiration resulting from the performance of potential aerobic physical exercise;
h.) providing, and/or assembling, and/or using, at least having a user utilize 600 whereby a user places a single finger, or said user places a first set of said user's fingers upon 106, and contiguous with 103, with 104, with 105, and simultaneously said user place a different single finger, or said user places a second set of said user's fingers upon 102, further applying human force to 106 and 102 in a static position that allows said user to perform isometric exercises;
i.) providing, and/or assembling, and/or using, at least having a user utilize 600 whereby a user places a single finger, or said user places a first set of said user's fingers upon 106, and contiguous with 103, with 104, with 105, and simultaneously said user place a different single finger, or said user places a second set of said user's fingers upon 102, further applying human force to 106 and 102 in a directional movement that allows said user to perform isotonic exercises;
j.) providing, and/or assembling, and/or using, at least alternatively allowing the user to utilize 600 and grasp 102, or 106, with one and/or both set(s) of said user's fingers and the user simultaneously placing either a first foot of said user, or instead and separately placing a second foot of said user upon the opposite piece not grasped by either one and/or both sets of said user's fingers, i.e. either 102, or 106 held by said user's said set(s) of fingers and the remainder piece being contiguous to one of the user's feet;
k.) providing, and/or assembling, and/or using, at least allowing said user to simultaneously and contiguously exert human force upon 600 thus contiguous to said user's body parts, commencing motion upon 600 whereby a simulation of multiple bodily exercise movements may occur as determined by said user, e.g. cycling simulation, or swimming simulation;
l.) providing, and/or assembling, and/or using, at least alternatively allowing the user to utilize 600 and grasp 102 with a first set of said user's fingers, and the user simultaneously grasp 106 with a second set of said user's fingers whereby said user is thus able to cause a directional movement upon either 102, and/or 106 in relation to each other being contiguous via 103 with 104 with 105, or alternatively being contiguous via 108 with 109 with 110; e.g. a rotational motion in a circular type manner either 102 rotating around a stationary position of 106, or visa versa, or, jointly 102 and 106 rotating around each other within any given three-hundred-sixty degree, 360°, angle as determined by said user;
m.) providing, and/or assembling, and/or using, at least allowing said user to simultaneously and contiguously exert human force upon 600 thus contiguous to said user's body parts, commencing motion upon 600 whereby, at least, a simulation of multiple bodily exercise movements may occur as determined by said user, e.g. boxing simulation;
n.) providing, and/or assembling, and/or using, at least alternatively allowing a user to simultaneously and contiguously exert human powered force upon 600 thus contiguous to the user's body parts, commencing motion upon 600 whereby said user may cause a stretching of said user's muscles and/or associated bodily tissues;
o.) providing, and/or assembling, and/or using, at least allowing a user to perform the aforementioned exertion of human force upon 600 whereby said user may conduct said methods in nearly any bodily position, or bodily motion, e.g. supine, standing, sitting, walking, swimming; and
p.) providing, and/or assembling, and/or using, at least equipping the user with the ability to repeat said motion by means of the user's body parts as attached to 600 for a length of time determined by the user.

13. A method of using a method for use of a physical exercise apparatus recited in claim 7, IC4, the method comprising:
a.) providing, and/or assembling, and/or using pieces whereby a user exerting means of human force upon and making contiguous: 101B with 102A, and 102C with 111A, and 111B with 107C, and 107B with 106C, and 106A with 113B, and 113A with 101C, whereby said assembly, at least, now exists in an embodiment, thereby forming a single contiguous apparatus, whereat 102 and 106 are part of a contiguous rigid formation, hereinafter named 700;
b.) providing, and/or assembling, and/or using, at least having a user utilize 700 whereby a user places a single finger, or said user places a first set of said user's fingers upon 106, and simultaneously said user place a different single finger, or said user places a second set of said user's fingers upon 102, or alternatively said user placing a single finger, or said user places a first set of said user's fingers upon 101, and said user placing a single finger, or said user places a second set of said user's fingers upon 107, respectively, further applying human force to 106 and 102, or in the said alternative, further applying force to 101 and 107, respectively, so placing 700 in a static position that allows said user to perform isometric exercises;
c.) providing, and/or assembling, and/or using, at least having a user utilize 700 whereby a user places a single finger, or said user places a first set of said user's fingers upon 106, and simultaneously said user place a different single finger, or said user places a second set of said user's fingers upon 102, or alternatively said user placing a single finger, or said user places a first set of said user's fingers upon 101, and said user placing a single finger, or said user places a second set of said user's fingers upon 107, respectively, further applying human force to 106 and 102, or in the said alternative, said user placing such finger(s) upon 101 and 107, respectively, so placing 700 in a directional movement that allows said user to perform isotonic exercises;
d.) providing, and/or assembling, and/or using, at least allowing a user to perform the aforementioned exertion of human force upon 700 whereby said user may conduct said methods in nearly any bodily position, or bodily motion, e.g. supine, standing, sitting, walking, swimming;
e.) providing, and/or assembling, and/or using, at least equipping the user with the ability to repeat said exercises by means of the user's body parts as attached to 700 for a length of time determined by the user.

14. A method of using a method for use of a physical exercise apparatus recited in claim 7, IC4, the method comprising:
a.) providing, and/or assembling, and/or using pieces whereby a user exerting means of human force upon and making contiguous: 101B with 102A, and 102C with 111A, and 111B with 107C, and 107B with 106C, and 106A with 113B, and 113A with 101C, thereby forming a single contiguous apparatus, whereat 102 and 106 are part of a contiguous rigid formation, subsequently, a user exerting means of human force upon and making contiguous: 101A with 108A, and 108B with 109A, and 109B with 110A, and 110B with 112A, and 112B with 103A, and 103B with 104A, and 104C with 105A, and 105B with 114A, whereby said assembly, at least, now exists in an embodiment, thereby forming a single contiguous apparatus hereinafter named 800;
b.) providing, and/or assembling, and/or using, at least having a user utilize 800 whereby a user places a single finger, or said user places a first set of said user's fingers upon 106, and simultaneously said user place a different single finger, or said user places a second set of said user's fingers upon 102, or alternatively said user placing a single finger, or said user places a first set of said user's fingers upon 101, and said user placing a single finger, or said user places a second set of said user's fingers upon 107, respectively, further applying human force to 106 and 102, or in the said alternative, further applying human force to 101 and 107, respectively, so placing 800 in a static position that allows said user to perform isometric exercises;
c.) providing, and/or assembling, and/or using, at least having a user utilize 800 whereby a user places a single finger, or said user places a first set of said user's fingers upon 106, and simultaneously said user place a different single finger, or said user places a second set of said user's fingers upon 102, or alternatively said user placing a single finger, or said user places a first set of said user's fingers upon 101, and said user placing a single finger, or said user places a second set of said user's fingers upon 107, respectively, further applying human force to 106 and 102, or in the said alternative, further applying human force to 101 and 107, respectively, so placing 800 in a directional movement that allows said user to perform isotonic exercises;
d.) providing, and/or assembling, and/or using, at least alternatively, allowing the user to utilize 800 and place either a first foot of said user, or instead, and separately, said user placing a second foot of said user upon and/or within either 102, and/or 106, and said user simultaneously placing a set and/or sets of said user's said fingers at any point upon and/or around contiguous pieces: 108, 109, 110, 112, 103, 104, 105, 114, thus grasping solely, and/or any combination of said contiguous pieces;
e.) providing, and/or assembling, and/or using, at least allowing said user to having thus placed said user's first foot, or said user's second foot, in conjunction with said user having thus placed said user's set, and/or sets of fingers upon 800, said user is able to perform physical exercises engaging bodily systems from said user's foot up through and including said user's fingers in a rotational, and/or aerobic, and/or isometric and/or isotonic manner;
f.) providing, and/or assembling, and/or using, at least allowing said user to simultaneously and contiguously exert human force upon 800 thus contiguous to said user's body parts, commencing motion upon 800 whereby a simulation of multiple bodily exercise movements may occur as determined by said user, e.g. cycling simulation, or swimming simulation;
g.) providing, and/or assembling, and/or using, at least alternatively allowing said user to simultaneously and contiguously exert human powered force upon 800 thus contiguous to the described said user's body parts, commencing motion upon 800 whereby said user may cause a stretching of said user's muscles and/or associated bodily tissues;
h.) providing, and/or assembling, and/or using, at least allowing a user to perform the aforementioned exertion of human force upon 800 whereby said user may conduct said methods in nearly any bodily position, or bodily motion, e.g. supine, standing, sitting, swimming;
i.) providing, and/or assembling, and/or using, at least equipping the user with the ability to repeat said exercises by means of the user's body parts as attached to 800 for a length of time determined by the user.

15. A method of using a method for use of a physical exercise apparatus recited in claim 7, IC4, the method comprising:
a.) providing, and/or assembling, and/or using pieces whereby a user exerting a means of human force upon, and making contiguous: 101B with 102A, and 102C with 111A, and 111B with 106A, and 106C with 107B, and 107C with 105B, and 105A with 104C, and 104A with 103B, and 103A with 101C, whereby said assembly, at least, now exists in an embodiment, thereby forming a single contiguous apparatus, hereinafter named 900;
b.) providing, and/or assembling, and/or using, at least having a user utilize 900 whereby a user places a single finger, or said user places a first set of said user's fingers upon 106, and contiguous with 103, and with 104, and with 105, and simultaneously said user place a different single finger, or said user places a second set of said user's fingers upon 102, further applying human force to 106 and 102 in a static position, or alternatively said user similarly thus places said user's fingers, or fingers, at any point between 107 through 101, via 103 with 104 with 105, and simultaneously said user place a different single finger, or said user places a second set of said user's fingers upon 106, and/or 111, and/or 102, further applying human force in a static position, allowing said user to perform isometric exercises;
c.) providing, and/or assembling, and/or using, at least having a user utilize 900 whereby a user places a single finger, or said user places a first set of said user's fingers upon 106, and contiguous with 103, and with 104, and with 105, and simultaneously said user place a different single finger, or said user places a second set of said user's fingers upon 102, further applying human force to 106 and 102 in a directional movement, or alternatively said user similarly thus places said user's fingers, or fingers, at any point between 107 through 101, via 103 with 104 with 105, and simultaneously said user place a different single finger, or said user places a second set of said user's fingers upon 106, and/or 111, and/or 102, further applying human force in a directional movement, allowing said user to perform isotonic exercises;
d.) providing, and/or assembling, and/or using, at least allowing a user to perform the aforementioned exertion of human force upon 900 whereby said user may conduct said methods in nearly any bodily position, or bodily motion, e.g. supine, standing, sitting, walking, swimming;
e.) providing, and/or assembling, and/or using, at least equipping the user with the ability to repeat said motion by said user's body parts attachment to 900 for a length of time determined by the user.

16. A method of assembly of an apparatus, at least, for reference purposes, hereinafter named IC5, the method comprising:
a.) providing, and/or assembling, and/or using a main body as an apparatus; hereinafter named 100;
b.) providing, and/or assembling, and/or using a first tee fitting rigid piece, hereinafter named 101, having a first end, hereinafter named 101A, and having a mid-section, hereinafter named 101B, and having a second end, hereinafter named 101C;
c.) providing, and/or assembling, and/or using a first arced rigid piece, hereinafter named 102, having a first end, hereinafter named 102A, having a mid-section maintaining an arc, hereinafter named 102B, and having a second end, hereinafter named 102C; collectively forming an arc wherein said arc includes an angular range of degrees within which approximation of ninety-degree, 90°, and including ninety-degree, 90°, is included, said angular range commencing at the first end at 102A, traversing through the mid-section at 102B and terminating at the second end at 102C;
d.) providing, and/or assembling, and/or using a first relatively straight elongated rigid piece, hereinafter named 103, having a first end, hereinafter named 103A, and having a second end, hereinafter named 103B;
e.) providing, and/or assembling, and/or using a second tee fitting rigid piece, or, alternatively an elongated rigid coupler, hereinafter named 104, having a first end, hereinafter named 104A, and having a mid-section, hereinafter named 104B, and having a second end, hereinafter named 104C;
f.) providing, and/or assembling, and/or using a second relatively straight elongated rigid piece, hereinafter named 105, having a first end, hereinafter named 105A, and having a second end, hereinafter named 105B;
g.) providing, and/or assembling, and/or using a second arced rigid piece, hereinafter named 106, having a first end, hereinafter named 106A, having a mid-section maintaining an arc, hereinafter named 106B, and having a second end, hereinafter named 106C; collectively forming an arc wherein said arc includes an angular range of degrees within which approximation of ninety-degree, 90°, and including ninety-degree, 90°, is included, said angular range commencing at the first end at 106A, traversing through the mid-section at 106B and terminating at the second end at 106C;
h.) providing, and/or assembling, and/or using a third tee fitting rigid piece, hereinafter named 107, having a first end, hereinafter named 107A, and having a mid-section, hereinafter named 107B, and having a second end, hereinafter named 107C;
i.) providing, and/or assembling, and/or using a third relatively straight elongated rigid piece, hereinafter named 108, having a first end, hereinafter named 108A, and having a second end, hereinafter named 108B;
j.) providing, and/or assembling, and/or using a fourth tee fitting rigid piece, hereinafter named 109, having a first end, hereinafter named 109A, and having a mid-section, hereinafter named 109B, and having a second end, hereinafter named 109C;
k.) providing, and/or assembling, and/or using a fourth relatively straight elongated rigid piece, hereinafter named 110, having a first end, hereinafter named 110A and having a second end, hereinafter named 110B; whereat said 110 is proportionally fixed in length, within a range of tolerances, relationally predetermined by a relative overall combined, contiguous, length of the first relatively straight elongated rigid piece 103, with the second tee fitting rigid piece 104, and with the second relatively straight elongated rigid piece 105 respectively, maintaining contiguous functionality thus enabling formation of a variety of embodiments of the apparatus;
l.) providing, and/or assembling, and/or using a fifth relatively straight elongated rigid piece, hereinafter named 111, having a first end, hereinafter named 111A, and having a second end, hereinafter named 111B;
m.) providing, and/or assembling, and/or using a first approximately ninety-degree, 90°, rigid piece, hereinafter named 112, having a first end, hereinafter named 112A, and having a second end, hereinafter named 112B;
n.) providing, and/or assembling, and/or using a sixth relatively straight elongated rigid piece, hereinafter named 113, having a first end, hereinafter named 113A, and having a second end, hereinafter named 113B;
o.) providing, and/or assembling, and/or using a second approximately ninety-degree, 90°, rigid piece, hereinafter named 114, having a first end, hereinafter named 114A, and having a second end, hereinafter named 114B; and
p.) providing, and/or assembling, and/or using said 100 being comprised of the set of pieces so named: 101, and/or 102, and/or 103, and/or 104, and/or 105, and/or 106, and/or 107, and/or 108, and/or 109, and/or 110, and/or 111, and/or 112, and/or 113, and/or 114, whereby the forming of a main body is inherently comprised in a single apparatus, whereby the set of said pieces, individually and/or collectively, are selected by a user, in a process to form a particular embodiment desired by a user; and
q.) providing, and/or assembling, and/or using a plurality of pieces in an embodiment of an apparatus whereby a user is exerting a means of human force upon a first piece and making said first piece, e.g. 101, and/or alternatively, 104, and/or 107, and/or 109 contiguous to a second piece, e.g. 110, and/or 108, and/or 102, and/or 103, and/or 105, and/or 106;
r.) providing, and/or assembling, and/or using pieces by a user whereby a user exerting a means of human force upon, and making contiguous, at least: 108B with 109A, and 109C with 110A, and 110B with 101C, and 101B with 102A, and 102C with 103A, and 103B with 104A, and 104C with 105A, and 105B with 106A, and 106C with 107B, and thus making 107C, at least proximately attachable to 108A, whereby said assembly, at least, now exists in an embodiment, thereby forming a single contiguous apparatus, hereinafter named 1001;
s.) providing, and/or assembling, and/or using an embodiment via means of human force whereby said user exerts sufficient amount of force upon a said first piece resulting in a directional movement, e.g. a horizontal motion of a said first piece, so as to be contiguous to a second piece as selected by a user;
t.) providing, and/or assembling, and/or using an embodiment via means of human force whereby a user simultaneously exerts sufficient amount of force upon said first piece in a second directional movement, e.g. a rotational motion of a said first piece, to be contiguous to said second piece;
u.) providing, and/or assembling, and/or using an embodiment via means of human force whereby a user exerts sufficient amount of force upon a first piece and/or a second piece in a first directional movement, e.g. a horizontal motion, and simultaneously said user exerts a sufficient amount of force upon said first piece and/or said second piece in a second directional movement, e.g. a rotational motion, upon said second piece; and
v.) providing, and/or assembling, and/or using, at least alternatively, a user having conjoined pieces assembled in said manner, whereby within a plane the pieces exist, there is a differing axial centerline between the pieces whereby said user may apply force upon said pieces, whereby said differing axial centerlines are altered to a degree, at least, to include a parallel distance between said differing axial centerlines, whereby said pieces are then able to be made contiguous that results in a locking-process effect between said pieces; and/or
i.) providing, and/or assembling, and/or using said embodiment via means of human force as recited in s.), and t.), and u.), and v.), respectively, and immediately above, sufficiently to a point whereby said first piece and said second piece, and/or, any subsequent piece(s) are so contiguously engaged to each other that there results a locking-process effect between said pieces.

17. A method of disassembly of an apparatus, at least, for reference purposes, hereinafter named IC6, the method comprising:
a.) providing, and/or disassembling, and/or using a plurality of pieces in an embodiment of an apparatus whereby a user is exerting a means of human force upon a first piece and making said first piece incontiguous to a second piece;
b.) providing, and/or disassembling, and/or using an embodiment via means of human force whereby a user exerts sufficient amount of force upon said first piece in a first directional movement, e.g. a rotational motion of a said first piece, to be incontiguous to said second piece;
c.) providing, and/or disassembling, and/or using an embodiment via means of human force whereby a user exerts sufficient amount of force upon a first piece resulting in a second directional movement of said first piece, e.g. a horizontal movement of a said first piece, to be incontiguous to a second piece as selected by said user;
d.) providing, and/or disassembling, and/or using an embodiment via means of human force whereby a user exerts sufficient amount of force upon a first piece and/or a second piece in a first directional movement, e.g. a rotational motion, and simultaneously said user exerts a sufficient amount of force upon said first piece and/or said second piece in a second directional movement, e.g. a horizontal movement, upon said second piece; and
i.) providing, and/or disassembling, and/or using said embodiment via means of human force as recited in a.), and b.), and c.), and d.), respectively and immediately above, sufficiently to a point whereby said first piece and said second piece are so incontiguously disengaged from each other that there results an unlocking-process effect between said pieces.

18. A system for an intellectual activities apparatus, at least, for reference purposes, hereinafter named IC7, comprising:
a.) a main body as an apparatus, hereinafter named 100 comprised of:
b.) a first tee fitting rigid piece, hereinafter named 101, having a first end, hereinafter named 101A, and having a mid-section, hereinafter named 101B, and having a second end, hereinafter named 101C;
c.) a first arced rigid piece, hereinafter named 102, having a first end, hereinafter named 102A, having a mid-section maintaining an arc, hereinafter named 102B, and having a second end, hereinafter named 102C; collectively forming an arc wherein said arc includes an angular range of degrees within which approximation of ninety-degree, 90°, and including ninety-degree, 90°, is included, said angular range commencing at the first end at 102A, traversing through the mid-section at 102B and terminating at the second end at 102C;
d.) a first relatively straight elongated rigid piece, hereinafter named 103, having a first end, hereinafter named 103A, and having a second end, hereinafter named 103B;
e.) a second tee fitting rigid piece, or, alternatively an elongated rigid coupler, hereinafter named 104, having a first end, hereinafter named 104A, and having a mid-section, hereinafter named 104B, and having a second end, hereinafter named 104C;
f.) a second relatively straight elongated rigid piece, hereinafter named 105, having a first end, hereinafter named 105A, and having a second end, hereinafter named 105B;
g.) a second arced rigid piece, hereinafter named 106, having a first end, hereinafter named 106A, having a mid-section maintaining an arc, hereinafter named 106B, and having a second end, hereinafter named 106C; collectively forming an arc wherein said arc includes an angular range of degrees within which approximation of ninety-degree, 90°, and including ninety-degree, 90°, is included, said angular range commencing at the first end at 106A, traversing through the mid-section at 106B and terminating at the second end at 106C;
h.) a third tee fitting rigid piece, hereinafter named 107, having a first end, hereinafter named 107A, and having a mid-section, hereinafter named 107B, and having a second end, hereinafter named 107C;
i.) a third relatively straight elongated rigid piece, hereinafter named 108, having a first end, hereinafter named 108A, and having a second end, hereinafter named 108B;
j.) a fourth tee fitting rigid piece, hereinafter named 109, having a first end, hereinafter named 109A, and having a mid-section, hereinafter named 109B, and having a second end, hereinafter named 109C;
k.) a fourth relatively straight elongated rigid piece, hereinafter named 110, having a first end, hereinafter named 110A and having a second end, hereinafter named 110B; whereat said 110 is proportionally fixed in length, within a range of tolerances, relationally predetermined by a relative overall combined, contiguous, length of the first relatively straight elongated rigid piece 103, with the second tee fitting rigid piece 104, and with the second relatively straight elongated rigid piece 105 respectively, maintaining contiguous functionality thus enabling formation of a variety of embodiments of the apparatus;
l.) a fifth relatively straight elongated rigid piece, hereinafter named 111, having a first end, hereinafter named 111A, and having a second end, hereinafter named 111B;
m.) a first approximately ninety-degree, 90°, rigid piece, hereinafter named 112, having a first end, hereinafter named 112A, and having a second end, hereinafter named 112B;
n.) a sixth relatively straight elongated rigid piece, hereinafter named 113, having a first end, hereinafter named 113A, and having a second end, hereinafter named 113B;
o.) a second approximately ninety-degree, 90°, rigid piece, hereinafter named 114, having a first end, hereinafter named 114A, and having a second end, hereinafter named 114B; and
p.) said 100 being comprised of the set of pieces so named: 101, and/or 102, and/or 103, and/or 104, and/or 105, and/or 106, and/or 107, and/or 108, and/or 109, and/or 110, and/or 111, and/or 112, and/or 113, and/or 114, whereby the forming of a main body is inherently comprised in a single apparatus, whereby the set of said pieces, individually and/or collectively, are selected by a user, in a process to form a particular embodiment desired by a user.

19. The system for an intellectual activities apparatus of claim 18, named IC7, further comprising:
a.) a said main body that comprises a potentiality for multiple embodiments with a practical useable method(s) for use by human beings;
b.) each piece is made of a rigid material, solely or any combination of, or any form of any material related to fiber, wood, plastic, glass, fiberglass, metal, resins, or material(s) of similarly rigid properties, currently known, or yet to be known;
c.) each piece and/or any combination of pieces, is/are, at least, in the structural shape, or form of oval, rectangular, round, square, triangular, or tubular, a similarly potential of one piece being capable of being made contiguous to any other said piece; and
d.) a single piece, and/or a combination of any said piece(s), has/have an hollow core, or have a hollow within any portion of any piece thereof, allowing the piece(s) to be rigidly conjoined to form an embodiment, or embodiments, of the apparatus.

20. A method for use of a system for an intellectual activity apparatus, at least, for reference purposes, hereinafter named IC8, comprising the steps of:
a.) providing, and/or assembling, and/or using a main body as an apparatus; hereinafter named 100;
b.) providing, and/or assembling, and/or using a first tee fitting rigid piece, hereinafter named 101, having a first end, hereinafter named 101A, and having a mid-section, hereinafter named 101B, and having a second end, hereinafter named 101C;
c.) providing, and/or assembling, and/or using a first arced rigid piece, hereinafter named 102, having a first end, hereinafter named 102A, having a mid-section maintaining an arc, hereinafter named 102B, and having a second end, hereinafter named 102C; collectively forming an arc wherein said arc includes an angular range of degrees within which approximation of ninety-degree, 90°, and including ninety-degree, 90°, is included, said angular range commencing at the first end at 102A, traversing through the mid-section at 102B and terminating at the second end at 102C;
d.) providing, and/or assembling, and/or using a first relatively straight elongated rigid piece, hereinafter named 103, having a first end, hereinafter named 103A, and having a second end, hereinafter named 103B;
e.) providing, and/or assembling, and/or using a second tee fitting rigid piece, or, alternatively an elongated rigid coupler, hereinafter named 104, having a first end, hereinafter named 104A, and having a mid-section, hereinafter named 104B, and having a second end, hereinafter named 104C;
f.) providing, and/or assembling, and/or using a second relatively straight elongated rigid piece, hereinafter named 105, having a first end, hereinafter named 105A, and having a second end, hereinafter named 105B;
g.) providing, and/or assembling, and/or using a second arced rigid piece, hereinafter named 106, having a first end, hereinafter named 106A, having a mid-section maintaining an arc, hereinafter named 106B, and having a second end, hereinafter named 106C; collectively forming an arc wherein said arc includes an angular range of degrees within which approximation of ninety-degree, 90°, and including ninety-degree, 90°, is included, said angular range commencing at the first end at 106A, traversing through the mid-section at 106B and terminating at the second end at 106C;
h.) providing, and/or assembling, and/or using a third tee fitting rigid piece, hereinafter named 107, having a first end, hereinafter named 107A, and having a mid-section, hereinafter named 107B, and having a second end, hereinafter named 107C;
i.) providing, and/or assembling, and/or using a third relatively straight elongated rigid piece, hereinafter named 108, having a first end, hereinafter named 108A, and having a second end, hereinafter named 108B;
j.) providing, and/or assembling, and/or using a fourth tee fitting rigid piece, hereinafter named 109, having a first end, hereinafter named 109A, and having a mid-section, hereinafter named 109B, and having a second end, hereinafter named 109C;
k.) providing, and/or assembling, and/or using a fourth relatively straight elongated rigid piece, hereinafter named 110, having a first end, hereinafter named 110A and having a second end, hereinafter named 110B; whereat said 110 is proportionally fixed in length, within a range of tolerances, relationally predetermined by a relative overall combined, contiguous, length of the first relatively straight elongated rigid piece 103, with the second tee fitting rigid piece 104, and with the second relatively straight elongated rigid piece 105 respectively, maintaining contiguous functionality thus enabling formation of a variety of embodiments of the apparatus;
l.) providing, and/or assembling, and/or using a fifth relatively straight elongated rigid piece, hereinafter named 111, having a first end, hereinafter named 111A, and having a second end, hereinafter named 111B;
m.) providing, and/or assembling, and/or using a first approximately ninety-degree, 90°, rigid piece, hereinafter named 112, having a first end, hereinafter named 112A, and having a second end, hereinafter named 112B;
n.) providing, and/or assembling, and/or using a sixth relatively straight elongated rigid piece, hereinafter named 113, having a first end, hereinafter named 113A, and having a second end, hereinafter named 113B;
o.) providing, and/or assembling, and/or using a second approximately ninety-degree, 90°, rigid piece, hereinafter named 114, having a first end, hereinafter named 114A, and having a second end, hereinafter named 114B; and
p.) providing, and/or assembling, and/or using said 100 being comprised of the set of pieces so named: 101, and/or 102, and/or 103, and/or 104, and/or 105, and/or 106, and/or 107, and/or 108, and/or 109, and/or 110, and/or 111, and/or 112, and/or 113, and/or 114, whereby the forming of a main body is inherently comprised in a single apparatus, whereby the set of said pieces, individually and/or collectively, are selected by a user, in a process to form a particular embodiment desired by a user.

21. A method of using a method for use of an intellectual activity apparatus recited in claim 20, IC8, the method comprising:
a.) providing, and/or assembling, and/or using pieces by a user whereby a user exerting a means of human force upon, and making contiguous: 106C with 107B, and 107C with 108A, and 108B with 109A, and 109B with 111A, and 111B with 112A, and 109C with 110A, and 110B with 101C, and 101B with 102A, and 102C with 103A, and 103B with 104A, and 104C with 105A, and 104B with 113A, and 113B with 114A, whereby said assembly, at least, now exists in an embodiment, thereby forming a single contiguous apparatus, hereinafter named 1100;
b.) providing, and/or assembling, and/or using, at least having a user utilize 1100 whereby said user is able to physically place, and/or physically support an object(s), foreign to 1100, e.g. an object that contains a means that may engage intellectual activity, such as a book, upon and/or within the structure of 1100, at least, potentially for use by employment of said user's intellectual activities related to such an object(s);
c.) providing, and/or assembling, and/or using, at least having a user utilize 1100 whereby a user is able to physically insert and/or physically support an object(s), foreign to 1100, e.g. an object that contains a means that may engage intellectual activity, such as a writing paraphernalia, upon and/or within the structure of 1100, at least, potentially for use by employment of said user's intellectual activities related to such an object(s);
d.) providing, and/or assembling, and/or using, at least having a means of an object(s); currently known, or yet to be known, foreign to said embodiment, at least, comprised of an item(s) used in a particular activity, e.g. intellectual activity: viewing printed matter, and/or an electronic object, and/or making a mark with an instrument upon a surface, herein named M100;
e.) providing, and/or assembling, and/or using, at least having foreign objects found within M100 to be comprised of categories of objects among which includes, but is not limited to E100 comprised in part of printed matter, and/or E200 comprised in part of electronic devices, and/or E300 comprised in part of objects that are capable of making a mark upon a surface, and/or E400 portable surfaces upon which a mark is capable of being made;
f.) providing, and/or assembling, and/or using, at least having conjoined pieces capable of a range of rotation of degrees for adjustment to accommodate a foreign object.

22. A method of using a method for use of an intellectual activity apparatus recited in claim 20, IC8, the method comprising:
a.) providing, and/or assembling, and/or using pieces by a user whereby a user exerting a means of human force upon, and making contiguous: 106C with 107B, and 107C with 108A, and 108B with 109A, and 109B with 111A, and 111B with 112A, and 109C with 110A, and 110B with 101C, and 101B with 102A, and 102C with 113A, and 113B with 114A, and 114B with 103A, and 103B with 104A, and 104C with 105A, whereby said assembly, at least, now exists in an embodiment, thereby forming a single contiguous apparatus, hereinafter named 1200;
b.) providing, and/or assembling, and/or using, at least having a user utilize 1200 whereby said user is able to physically place, and/or physically support an object(s), foreign to 1200, e.g. an object that contains a means that may engage intellectual activity, such as a book, upon and/or within the structure of 1200, at least, potentially for use by employment of said user's intellectual activities related to such an object(s);
c.) providing, and/or assembling, and/or using, at least having a user utilize 1200 whereby a user is able to physically insert and/or physically support an object(s), foreign to 1200, e.g. an object that contains a means that may engage intellectual activity, such as a writing paraphernalia, upon and/or within the structure of 1200, at least, potentially for use by employment of said user's intellectual activities related to such an object(s);
d.) providing, and/or assembling, and/or using, at least having a means of an object(s), currently known, or yet to be known, foreign to said embodiment, at least, comprised of an item(s) used in a particular activity, e.g. intellectual activity: viewing printed matter, and/or an electronic object, and/or making a mark with an instrument upon a surface, herein named M100;
e.) providing, and/or assembling, and/or using, at least having foreign objects found within M100 to be comprised of categories of objects among which includes, but is not limited to E100 comprised in part of printed matter, and/or E200 comprised in part of electronic devices, and/or E300 comprised in part of objects that are capable of making a mark upon a surface, and/or E400 portable surfaces upon which a mark is capable of being made;
f.) providing, and/or assembling, and/or using, at least having conjoined pieces capable of a range of rotation of degrees for adjustment to accommodate a foreign object.

23. A method of using a method for use of an intellectual activity apparatus recited in claim 20, IC8, the method comprising:
a.) providing, and/or assembling, and/or using pieces by a user whereby a user exerting a means of human force upon, and making contiguous: 106C with 107B, and 107C with 108A, and 108B with 109A, and 109C with 110A, and 110B with 101C, and 101B with 102A, and 102C with 111A, and 111B with 112A, and 112B with 113A, and 113B with 104B, and 104C with 105A, and 104A with 103B, whereby said assembly, at least, now exists in an embodiment, thereby forming a single contiguous apparatus, hereinafter named 1300;
b.) providing, and/or assembling, and/or using, at least having a user utilize 1300 whereby said user is able to physically place, and/or physically support an object(s), foreign to 1300, e.g. an object that contains a means that may engage intellectual activity, such as a book, upon and/or within the structure of 1300, at least, potentially for use by employment of said user's intellectual activities related to such an object(s);
c.) providing, and/or assembling, and/or using, at least having a user utilize 1300 whereby a user is able to physically insert and/or physically support an object(s), foreign to 1300, e.g. an object that contains a means that may engage intellectual activity, such as a writing paraphernalia, upon and/or within the structure of 1300, at least, potentially for use by employment of said user's intellectual activities related to such an object(s);
d.) providing, and/or assembling, and/or using, at least having a means of an object(s), currently known, or yet to be known, foreign to said embodiment, at least, comprised of an item(s) used in a particular activity, e.g. intellectual activity: viewing printed matter, and/or an electronic object, and/or making a mark with an instrument upon a surface, herein named M100;
e.) providing, and/or assembling, and/or using, at least having foreign objects found within M100 to be comprised of categories of objects among which includes, but is not limited to E100 comprised in part of printed matter, and/or E200 comprised in part of electronic devices, and/or E300 comprised in part of objects that are capable of making a mark upon a surface, and/or E400 portable surfaces upon which a mark is capable of being made;
f.) providing, and/or assembling, and/or using, at least having conjoined pieces capable of a range of rotation of degrees for adjustment to accommodate a foreign object.

24. A method of using a method for use of an intellectual activity apparatus recited in claim 20, IC8, the method comprising:
a.) providing, and/or assembling, and/or using pieces by a user whereby a user exerting a means of human force upon, and making contiguous: 106C with 107B, and 107C with 105B, and 105A with 104C, and 104A with 103B, and 103A with 112B, and 112A with 111B, and 111A with 109B, and 109C with 110A, and 109A with 108B, and 108A with 101C, and 101B with 102A, and 102C with 113B, and 113A with 114A, whereby said assembly, at least, now exists in an embodiment, thereby forming a single contiguous apparatus, hereinafter named 1400;
b.) providing, and/or assembling, and/or using, at least having a user utilize 1400 whereby said user is able to physically place, and/or physically support an object(s), foreign to 1400, e.g. an object that contains a means that may engage intellectual activity, such as a book, upon and/or within the structure of 1400, at least, potentially for use by employment of said user's intellectual activities related to such an object(s);
c.) providing, and/or assembling, and/or using, at least having a user utilize 1400 whereby a user is able to physically insert and/or physically support an object(s), foreign to 1400, e.g. an object that contains a means that may engage intellectual activity, such as a writing paraphernalia, upon and/or within the structure of 1400, at least, potentially for use by employment of said user's intellectual activities related to such an object(s);
d.) providing, and/or assembling, and/or using, at least having a means of an object(s), currently known, or yet to be known, foreign to said embodiment, at least, comprised of an item(s) used in a particular activity, e.g. intellectual activity: viewing printed matter, and/or an electronic object, and/or making a mark with an instrument upon a surface, herein named M100;
e.) providing, and/or assembling, and/or using, at least having foreign objects found within M100 to be comprised of categories of objects among which includes, but is not limited to E100 comprised in part of printed matter, and/or E200 comprised in part of electronic devices, and/or E300 comprised in part of objects that are capable of making a mark upon a surface, and/or E400 portable surfaces upon which a mark is capable of being made;
f.) providing, and/or assembling, and/or using, at least having conjoined pieces capable of a range of rotation of degrees for adjustment to accommodate a foreign object.

25. A method of using a method for use of an intellectual activity apparatus recited in claim 20, IC8, the method comprising:
a.) providing, and/or assembling, and/or using pieces by a user whereby a user exerting a means of human force upon, and making contiguous: 113A with 106A, and 106C with 107B, and 107C with 105B, and 105A with 104C, and 104A with 103B, and 103A with 101C, and 101B with 102A, and 102C with 111A, whereby said assembly, at least, now exists in an embodiment, thereby forming a single contiguous apparatus, hereinafter named 1500;
b.) providing, and/or assembling, and/or using, at least having a user utilize 1500 whereby said user is able to physically place, and/or physically support an object(s), foreign to 1500, e.g. an object that contains a means that may engage intellectual activity, such as a book, upon and/or within the structure of 1500, at least, potentially for use by employment of said user's intellectual activities related to such an object(s);
c.) providing, and/or assembling, and/or using, at least having a user utilize 1500 whereby a user is able to physically insert and/or physically support an object(s), foreign to 1500, e.g. an object that contains a means that may engage intellectual activity, such as a writing paraphernalia, upon and/or within the structure of 1500, at least, potentially for use by employment of said user's intellectual activities related to such an object(s);
d.) providing, and/or assembling, and/or using, at least having a means of an object(s), currently known, or yet to be known, foreign to said embodiment, at least, comprised of an item(s) used in a particular activity, e.g. intellectual activity: viewing printed matter, and/or an electronic object, and/or making a mark with an instrument upon a surface, herein named M100;
e.) providing, and/or assembling, and/or using, at least having foreign objects found within M100 to be comprised of categories of objects among which includes, but is not limited to E100 comprised in part of printed matter, and/or E200 comprised in part of electronic devices, and/or E300 comprised in part of objects that are capable of making a mark upon a surface, and/or E400 portable surfaces upon which a mark is capable of being made;
f.) providing, and/or assembling, and/or using, at least having conjoined pieces capable of a range of rotation of degrees for adjustment to accommodate a foreign object.

26. A method of using a method for use of an intellectual activity apparatus recited in claim 20, IC8, the method comprising:
a.) providing, and/or assembling, and/or using pieces by a user whereby a user exerting a means of human force upon, and making contiguous: 112A with 111A, and 111B with 106A, and 106C with 107B, and 107C with 105B, and 105A with 104C, and 104A with 103B, and 103A with 101C, and 101B with 102A, and 104B with 113B, and 113A with 109B, and 109C with 110A, and 110B with 114A, and 109A with 108B, whereby said assembly, at least, now exists in an embodiment, thereby forming a single contiguous apparatus, hereinafter named 1600;
b.) providing, and/or assembling, and/or using, at least having a user utilize 1600 whereby said user is able to physically place, and/or physically support an object(s), foreign to 1600, e.g. an object that contains a means that may engage intellectual activity, such as a book, upon and/or within the structure of 1600, at least, potentially for use by employment of said user's intellectual activities related to such an object(s);
c.) providing, and/or assembling, and/or using, at least having a user utilize 1600 whereby a user is able to physically insert and/or physically support an object(s), foreign to 1600, e.g. an object that contains a means that may engage intellectual activity, such as a writing paraphernalia, upon and/or within the structure of 1600, at least, potentially for use by employment of said user's intellectual activities related to such an object(s);
d.) providing, and/or assembling, and/or using, at least having a means of an object(s), currently known, or yet to be known, foreign to said embodiment, at least, comprised of an item(s) used in a particular activity, e.g. intellectual activity: viewing printed matter, and/or an electronic object, and/or making a mark with an instrument upon a surface, herein named M100;
e.) providing, and/or assembling, and/or using, at least having foreign objects found within M100 to be comprised of categories of objects among which includes, but is not limited to E100 comprised in part of printed matter, and/or E200 comprised in part of electronic devices, and/or E300 comprised in part of objects that are capable of making a mark upon a surface, and/or E400 portable surfaces upon which a mark is capable of being made;
f.) providing, and/or assembling, and/or using, at least having conjoined pieces capable of a range of rotation of degrees for adjustment to accommodate a foreign object.

27. A method of using a method for use of an intellectual activity apparatus recited in claim 20, IC8, the method comprising:
a.) providing, and/or assembling, and/or using, at least having a user identify pieces in an apparatus comprised of the set of following pieces: 101, and 102, and 103, and 104, and 105, and 106, and 107, and 108, and 109, and 110, hereinafter named 1700;
b.) providing, at least, a means, at least to learn, and/or to teach, and/or to communicate whole numbers and/or letters of the English alphabet; whereby said 1700, at least, now exists in an embodiment, thereby forming a single apparatus;
c.) providing, and/or assembling, and/or using, at least having a user employ the user's intellect in the process of learning to visually count the single digits of which all whole numbers are made, zero through nine, by association of a single digit with a specific piece, or images thereof, comprised in a single apparatus 1700;
d.) providing, and/or assembling, and/or using, at least having a user identify each said piece within 1700 whereby each identified piece, at least, is identified as an unique whole numbers, comprised of zero through nine, in the following schema:
1.) Whole Number: 1 identified with piece 101;
2.) Whole Number: 2 identified with piece 102;
3.) Whole Number: 3 identified with piece 103;
4.) Whole Number: 4 identified with piece 104;
5.) Whole Number: 5 identified with piece 105;
6.) Whole Number: 6 identified with piece 106;
7.) Whole Number: 7 identified with piece 107:
8.) Whole Number: 8 identified with piece 108;
9.) Whole Number: 9 identified with piece 109;
10.) Whole Number: 0 identified with piece 110;
e.) providing, and/or assembling, and/or using, at least having a series of reference points identified with pieces named: 101, 102, 103, 104, 105, 106, 107, 108, 109, 110, as found within said 1700, whereby each reference point is identified as an unique letter of the English alphabet comprised of and in an exemplary following schema:
1.) English alphabet letter: A identified with reference point 101A;
2.) English alphabet letter: B identified with reference point 101B;
3.) English alphabet letter: C identified with reference point 101C;
4.) English alphabet letter: D identified with reference point 102A;
5.) English alphabet letter: E identified with reference point 102B;
6.) English alphabet letter: F identified with reference point 102C;
7.) English alphabet letter: G identified with reference point 103A;
8.) English alphabet letter: H identified with reference point 103B;
9.) English alphabet letter: I identified with reference point 104A;
10.) English alphabet letter: J identified with reference point 104B;
11.) English alphabet letter: K identified with reference point 104C;
12.) English alphabet letter: L identified with reference point 105A;
13.) English alphabet letter: M identified with reference point 105B;
14.) English alphabet letter: N identified with reference point 106A;
15.) English alphabet letter: O identified with reference point 106B;
16.) English alphabet letter: P identified with reference point 106C;
17.) English alphabet letter: Q identified with reference point 107A;
18.) English alphabet letter: R identified with reference point 107B;
19.) English alphabet letter: S identified with reference point 107C;
20.) English alphabet letter: T identified with reference point 108A;
21.) English alphabet letter: U identified with reference point 108B;
22.) English alphabet letter: V identified with reference point 109A;
23.) English alphabet letter: W identified with reference point 109B;
24.) English alphabet letter: X identified with reference point 109C;
25.) English alphabet letter: Y identified with reference point 110A;
26.) English alphabet letter: Z identified with reference point 110B;
f.) providing, and/or assembling, and/or using, at least having a unique code, at least for potential communication, via having a reference point in each said piece of said 1700 identified as an unique letter of the English alphabet;
i.) e.g. a word apple would be represented via this unique code method as follows:
1.) English alphabet letter: A identified with reference point 101A;)
2.) English alphabet letter: P identified with reference point 106C;)
3.) English alphabet letter: P identified with reference point 106C;)
4.) English alphabet letter: L identified with reference point 105A;)
5.) English alphabet letter: E identified with reference point 102B;
ii.) thus the series of reference points: 101A, with 106C, with 106C, with 105A, with 102B spell the word apple via said unique code method for English alphabet letters;
g.) providing, and/or assembling, and/or using, at least further allowing, under said unique code method for English alphabet letters, a user is able to spell a word, e.g. apple, with a single strand of numeric digits conjoined to an English alphabet letter suffix, e.g. either, A, or B, or C, effectively separating the numeric digits, and said unique code method for English alphabet letters in a word, whereby each additional English alphabet letter via said unique code method for English alphabet letters occurs where there exists an actual written letter from the English alphabet, as follows for the word apple: 101A106C106C105A102B, being interpreted as follows: 101A=A, and 106C=P, and 106C=P, and 105A=L, and 102B=E; essentially capable of being decoded as the English word, apple; 101A106C106C105A102B=apple.

28. A system for an amusement apparatus, at least, for reference purposes, hereinafter named IC9, comprising:
a.) a main body as an apparatus, hereinafter named 100;
b.) a first tee fitting rigid piece, hereinafter named 101, having a first end, hereinafter named 101A, and having a mid-section, hereinafter named 101B, and having a second end, hereinafter named 101C;
c.) a first arced rigid piece, hereinafter named 102, having a first end, hereinafter named 102A, having a mid-section maintaining an arc, hereinafter named 102B, and having a second end, hereinafter named 102C; collectively forming an arc wherein said arc includes an angular range of degrees within which approximation of ninety-degree, 90°, and including ninety-degree, 90°, is included, said angular range commencing at the first end at 102A, traversing through the mid-section at 102B and terminating at the second end at 102C;
d.) a first relatively straight elongated rigid piece, hereinafter named 103, having a first end, hereinafter named 103A, and having a second end, hereinafter named 103B;
e.) a second tee fitting rigid piece, or, alternatively an elongated rigid coupler, hereinafter named 104, having a first end, hereinafter named 104A, and having a mid-section, hereinafter named 104B, and having a second end, hereinafter named 104C;
f.) a second relatively straight elongated rigid piece, hereinafter named 105, having a first end, hereinafter named 105A, and having a second end, hereinafter named 105B;
g.) a second arced rigid piece, hereinafter named 106, having a first end, hereinafter named 106A, having a mid-section maintaining an arc, hereinafter named 106B, and having a second end, hereinafter named 106C; collectively forming an arc wherein said arc includes an angular range of degrees within which approximation of ninety-degree, 90°, and including ninety-degree, 90°, is included, said angular range commencing at the first end at 106A, traversing through the mid-section at 106B and terminating at the second end at 106C;
h.) a third tee fitting rigid piece, hereinafter named 107, having a first end, hereinafter named 107A, and having a mid-section, hereinafter named 107B, and having a second end, hereinafter named 107C;
i.) a third relatively straight elongated rigid piece, hereinafter named 108, having a first end, hereinafter named 108A, and having a second end, hereinafter named 108B;
j.) a fourth tee fitting rigid piece, hereinafter named 109, having a first end, hereinafter named 109A, and having a mid-section, hereinafter named 109B, and having a second end, hereinafter named 109C;
k.) a fourth relatively straight elongated rigid piece, hereinafter named 110, having a first end, hereinafter named 110A and having a second end, hereinafter named 110B; whereat said 110 is proportionally fixed in length, within a range of tolerances, relationally predetermined by a relative overall combined, contiguous, length of the first relatively straight elongated rigid piece 103, with the second tee fitting rigid piece 104, and with the second relatively straight elongated rigid piece 105 respectively, maintaining contiguous functionality thus enabling formation of a variety of embodiments of the apparatus;
l.) a fifth relatively straight elongated rigid piece, hereinafter named 111, having a first end, hereinafter named 111A, and having a second end, hereinafter named 111B;
m.) a first approximately ninety-degree, 90°, rigid piece, hereinafter named 112, having a first end, hereinafter named 112A, and having a second end, hereinafter named 112B;
n.) a sixth relatively straight elongated rigid piece, hereinafter named 113, having a first end, hereinafter named 113A, and having a second end, hereinafter named 113B;
o.) a second approximately ninety-degree, 90°, rigid piece, hereinafter named 114, having a first end, hereinafter named 114A, and having a second end, hereinafter named 114B; and
p.) said 100 being comprised of the set of pieces so named: 101, and/or 102, and/or 103, and/or 104, and/or 105, and/or 106, and/or 107, and/or 108, and/or 109, and/or 110, and/or 111, and/or 112, and/or 113, and/or 114, whereby the forming of a main body is inherently comprised in a single apparatus, whereby the set of said pieces, individually and/or collectively, are selected by a user, in a process to form a particular embodiment desired by a user.

29. The system for an amusement apparatus recited in claim 28, IC9, further comprising:
a.) a said main body that comprises a potentiality for multiple embodiments with a practical useable method(s) for use by human beings;
b.) each piece is made of a rigid material, solely or any combination of, or any form of any material related to fiber, wood, plastic, glass, fiberglass, metal, resins, or material(s) of similarly rigid properties, currently known, or yet to be known;
c.) each piece and/or any combination of pieces, is/are, at least, in the structural shape, or form of oval, rectangular, round, square, triangular, or tubular, a similarly potential of one piece being capable of being made contiguous to any other said piece; and
d.) a single piece, and/or a combination of any said piece(s), has/have an hollow core, or have a hollow within any portion of any piece thereof, allowing the piece(s) to be rigidly conjoined to form an embodiment, or embodiments, of the apparatus.

30. A method for use of an amusement apparatus, at least, for reference purposes, hereinafter named IC10, the method comprised of:
a.) providing, and/or assembling, and/or using a main body as an apparatus; hereinafter named 100;
b.) providing, and/or assembling, and/or using a first tee fitting rigid piece, hereinafter named 101, having a first end, hereinafter named 101A, and having a mid-section, hereinafter named 101B, and having a second end, hereinafter named 101C;
c.) providing, and/or assembling, and/or using a first arced rigid piece, hereinafter named 102, having a first end, hereinafter named 102A, having a mid-section maintaining an arc, hereinafter named 102B, and having a second end, hereinafter named 102C; collectively forming an arc wherein said arc includes an angular range of degrees within which approximation of ninety-degree, 90°, and including ninety-degree, 90°, is included, said angular range commencing at the first end at 102A, traversing through the mid-section at 102B and terminating at the second end at 102C;
d.) providing, and/or assembling, and/or using a first relatively straight elongated rigid piece, hereinafter named 103, having a first end, hereinafter named 103A, and having a second end, hereinafter named 103B;
e.) providing, and/or assembling, and/or using a second tee fitting rigid piece, or, alternatively an elongated rigid coupler, hereinafter named 104, having a first end, hereinafter named 104A, and having a mid-section, hereinafter named 104B, and having a second end, hereinafter named 104C;
f.) providing, and/or assembling, and/or using a second relatively straight elongated rigid piece, hereinafter named 105, having a first end, hereinafter named 105A, and having a second end, hereinafter named 105B;
g.) providing, and/or assembling, and/or using a second arced rigid piece, hereinafter named 106, having a first end, hereinafter named 106A, having a mid-section maintaining an arc, hereinafter named 106B, and having a second end, hereinafter named 106C; collectively forming an arc wherein said arc includes an angular range of degrees within which approximation of ninety-degree, 90°, and including ninety-degree, 90°, is included, said angular range commencing at the first end at 106A, traversing through the mid-section at 106B and terminating at the second end at 106C;
h.) providing, and/or assembling, and/or using a third tee fitting rigid piece, hereinafter named 107, having a first end, hereinafter named 107A, and having a mid-section, hereinafter named 107B, and having a second end, hereinafter named 107C;
i.) providing, and/or assembling, and/or using a third relatively straight elongated rigid piece, hereinafter named 108, having a first end, hereinafter named 108A, and having a second end, hereinafter named 108B;
j.) providing, and/or assembling, and/or using a fourth tee fitting rigid piece, hereinafter named 109, having a first end, hereinafter named 109A, and having a mid-section, hereinafter named 109B, and having a second end, hereinafter named 109C;
k.) providing, and/or assembling, and/or using a fourth relatively straight elongated rigid piece, hereinafter named 110, having a first end, hereinafter named 110A and having a second end, hereinafter named 110B; whereat said 110 is proportionally fixed in length, within a range of tolerances, relationally predetermined by a relative overall combined, contiguous, length of the first relatively straight elongated rigid piece 103, with the second tee fitting rigid piece 104, and with the second relatively straight elongated rigid piece 105 respectively, maintaining contiguous functionality thus enabling formation of a variety of embodiments of the apparatus;
l.) providing, and/or assembling, and/or using a fifth relatively straight elongated rigid piece, hereinafter named 111, having a first end, hereinafter named 111A, and having a second end, hereinafter named 111B;
m.) providing, and/or assembling, and/or using a first approximately ninety-degree, 90°, rigid piece, hereinafter named 112, having a first end, hereinafter named 112A, and having a second end, hereinafter named 112B;
n.) providing, and/or assembling, and/or using a sixth relatively straight elongated rigid piece, hereinafter named 113, having a first end, hereinafter named 113A, and having a second end, hereinafter named 113B;
o.) providing, and/or assembling, and/or using a second approximately ninety-degree, 90°, rigid piece, hereinafter named 114, having a first end, hereinafter named 114A, and having a second end, hereinafter named 114B; and
p.) providing, and/or assembling, and/or using said 100 being comprised of the set of pieces so named: 101, and/or 102, and/or 103, and/or 104, and/or 105, and/or 106, and/or 107, and/or 108, and/or 109, and/or 110, and/or 111, and/or 112, and/or 113, and/or 114, whereby the forming of a main body is inherently comprised in a single apparatus, whereby the set of said pieces, individually and/or collectively, are selected by a user, in a process to form a particular embodiment desired by a user.

31. A method of using a method for use of an amusement apparatus recited in claim 30, IC10, the method comprising:
a.) providing, and/or assembling, and/or using pieces by a user whereby a user exerting a means of human force upon, and making contiguous: at least, any single use and/or contiguous combination of pieces named 101, and/or 102, and/or 103, and/or 104, and/or 105, and/or 106, and/or 107, and/or 108, and/or 109, and/or 110, and/or 111, and/or 112, and/or 113, and/or 114; forming a main body inherently comprised in a single apparatus;
b.) providing, and/or assembling, and/or using pieces whereby a user exerting a means of human force upon, and making contiguous: 101B with 102A, and 102C with 103A, and 103B with 104A, and 104C with 105A, and 105B with 106A, and 106C with 107B, and 107C with 108A, and 108B with 109A, and 109C with 110A, and 110B with 101C, and 111A with 104B, and 111B with 112A, and 112B with 113A, and 113B with 114A, whereby said assembly, at least, now exists in an embodiment for amusement, hereinafter named 200;
c.) providing, and/or assembling, and/or using pieces wherein there exists, at least, an open hallow(s) that allows airflow into and airflow out of said embodiment(s) of the apparatus;
d.) providing, and/or assembling, and/or using a user to input airflow through the apparatus in such manner that an audible noise emits from the apparatus which may fall within the range of tones audible to the human ear; and
e.) providing, and/or assembling, and/or using as a means of amusement to a user.

32. A method of using a method for use of an amusement apparatus recited in claim 30, IC10, the method comprising:
a.) providing, and/or assembling, and/or using pieces by a user whereby a user exerting a means of human force upon, and making contiguous: at least, any single use and/or contiguous combination of pieces named 101, and/or 102, and/or 103, and/or 104, and/or 105, and/or 106, and/or 107, and/or 108, and/or 109, and/or 110, and/or 111, and/or 112, and/or 113, and/or 114; forming a main body inherently comprised in a single apparatus, wherein there exists, at least, one portion of the apparatus whereby a user may place and store, at least, one article upon the apparatus;
b.) providing, and/or assembling, and/or using as a means of amusement to a user.

33. A method of using a method for use of an amusement apparatus recited in claim 30, IC10, the method comprising:
a.) providing, and/or assembling, and/or using pieces by a user whereby a user exerting a means of human force upon, and making contiguous: at least, any single use and/or contiguous combination of pieces named 101, and/or 102, and/or 103, and/or 104, and/or 105, and/or 106, and/or 107, and/or 108, and/or 109, and/or 110, and/or 111, and/or 112, and/or 113, and/or 114; forming a main body inherently comprised in a single apparatus, wherein there exists, at least, one portion of the apparatus whereby a user may employ the apparatus to be contiguous, at least, to a user's body part(s) that are otherwise difficult to reach;
b.) providing, and/or assembling, and/or using as a means of amusement to a user.

34. A method of using a method for use of an amusement apparatus recited in claim 30, IC10, the method comprising:
a.) providing, and/or assembling, and/or using pieces by a user whereby a user exerting a means of human force upon, and making contiguous: at least, any single use and/or contiguous combination of pieces named 101, and/or 102, and/or 103, and/or 104, and/or 105, and/or 106, and/or 107, and/or 108, and/or 109, and/or 110, and/or 111, and/or 112, and/or 113, and/or 114; forming a main body inherently comprised in a single apparatus, wherein there exists, at least, one portion of the apparatus whereby a user may use said apparatus to reach objects that are, at least, beyond the reachable extension of said user's body part, e.g. reaching an item on a shelf;
b.) providing, and/or assembling, and/or using as a means of amusement to a user.

35. A method of using a method for use of an amusement apparatus recited in claim 30, IC10, the method comprising:
a.) providing, and/or assembling, and/or using pieces by a user whereby a user exerting a means of human force upon, and making contiguous: at least, any single use and/or contiguous combination of pieces named 101, and/or 102, and/or 103, and/or 104, and/or 105, and/or 106, and/or 107, and/or 108, and/or 109, and/or 110, and/or 111, and/or 112, and/or 113, and/or 114; forming a main body inherently comprised in a single apparatus, wherein there exists, at least, two open ports that allows airflow into and airflow out of said embodiment(s) of the apparatus;
b.) providing, and/or assembling, and/or using a user to input airflow through the apparatus in such manner that allows a user to breathe through the apparatus, e.g. when swimming under water, or when suffering a breathing disruption, or when experiencing a breathing abnormality;
c.) providing, and/or assembling, and/or using as a means of amusement to a user.
